(19) United States
(12) Patent Application Publication
(10) Pub. No.: US 2021/0017303 A1
(43) Pub. Date: Jan. 21, 2021

(54) Silyl-Bridged Pyridylamide Catalysts and Methods Thereof

(71) Applicant: ExxonMobil Chemical Patents Inc., Baytown, TX (US)

(72) Inventors: John R. Hagadorn, Houston, TX (US); Jo Ann M. Canich, Houston, TX (US); Pavel S. Kulyabin, Moscow (RU); Dmitry V. Uborsky, Moscow (RU); Alexander Z. Voskoboynikov, Moscow (RU)

(21) Appl. No.: 16/910,032

(22) Filed: Jun. 23, 2020

Related U.S. Application Data
(60) Provisional application No. 62/875,749, filed on Jul. 18, 2019.

(51) Int. Cl. C08F 4/64; C08F 10/06; C08F 10/02; C08F 4/659

(52) U.S. Cl. CPC C08F 4/64013; C08F 4/65916; C08F 10/02; C08F 10/06

(57) ABSTRACT

The present disclosure relates to silyl-bridged pyridylamide transition metal complexes and catalyst systems including silyl-bridged pyridylamide transition metal complexes and their use in polymerization processes to produce polyolefin polymers, such as polyethylene polymers and polypropylene polymers, from catalyst systems including one or more olefin polymerization catalysts, at least one activator, and an optional support.

### PRIORITY CLAIM

This application claims priority to and the benefit of U.S. Ser. No. 62/875,749, filed Jul. 18, 2019 is incorporated herein by reference in its entirety.

### FIELD

The present disclosure relates to the use of silyl-bridged pyridylamide transition metal complexes, catalyst systems including silyl-bridged pyridylamide transition metal complexes, and polymerization processes to produce polyolefin polymers such as polyethylene polymers and polypropylene polymers.

### BACKGROUND

Polyolefins are widely used commercially because of their robust physical properties. For example, various types of polyethylenes, including high density, low density, and linear low density polyethylenes, are some of the most commercially useful. Polyolefins are typically prepared with a catalyst that polymerizes olefin monomers. Therefore, there is interest in finding new catalysts and catalyst systems that provide polymers having improved properties.

Low density polyethylene is generally prepared at high pressure using free radical initiators, or in gas phase processes using Ziegler-Natta or vanadium catalysts. Low density polyethylene typically has a density in the range of 0.916 g/cm³ to 0.940 g/cm³. Typical low density polyethylene produced using free radical initiators is referred to in the industry as “LDPE”. LDPE is also referred to as “branched” or “heterogeneously branched” polyethylene because of the relatively large number of long chain branches extending from the main polymer backbone. Polyethylene in the same density range, e.g., 0.916 g/cm³ to 0.940 g/cm³, which is linear and does not contain long chain branching, is referred to as “linear low density polyethylene” (“LLDPE”) and is typically produced by conventional Ziegler-Natta catalysts or with metallocene catalysts. “Linear” means that the polyethylene has few, if any, long chain branches, typically referred to as a g′ᵥᵢₛ value of 0.97 or above, such as 0.98 or above. Polyethylenes having still greater density are the high density polyethylenes (“HDPEs”), e.g., polyethylenes having densities greater than 0.940 g/cm³, and are generally prepared with Ziegler-Natta catalysts or chrome catalysts. Very low density polyethylenes (“VLDPEs”) can be produced by a number of different processes yielding polyethylenes having a density less than 0.916 g/cm³, typically 0.890 g/cm³ to 0.915 g/cm³ or 0.900 g/cm³ to 0.915 g/cm³.

Polyolefins, such as polyethylene, which have high molecular weight, generally have desirable mechanical properties over their lower molecular weight counterparts. However, high molecular weight polyolefins can be difficult to process and can be costly to produce. Polyolefin compositions having a bimodal molecular weight distribution are desirable because they can combine the advantageous mechanical properties of a high molecular weight fraction of the composition with the improved processing properties of a low molecular weight fraction of the composition. Unless otherwise indicated, as used herein, “high molecular weight” is defined as a number average molecular weight (Mn) value of 50,000 g/mol or more. “Low molecular weight” is defined as an Mn value of less than 50,000 g/mol.

Polyolefins, such as polyethylene, typically have a comonomer, such as hexene, incorporated into the polyethylene backbone. These copolymers provide varying physical properties compared to polyethylene alone and are typically produced in a low pressure reactor, utilizing, for example, solution, slurry, or gas phase polymerization processes. Polymerization may take place in the presence of catalyst systems such as those using a Ziegler-Natta catalyst, a chromium based catalyst, or a metallocene catalyst. The comonomer content of a polyolefin (e.g., wt % of comonomer incorporated into a polyolefin backbone) influences the properties of the polyolefin (and composition of the copolymers) and is influenced by the polymerization catalyst. Unless otherwise indicated, as used herein, “low comonomer content” is defined as a polyolefin having less than 6 wt % of comonomer based upon the total weight of the polyolefin. As used herein, “high comonomer content” is defined as a polyolefin having greater than or equal to 6 wt % of comonomer based upon the total weight of the polyolefin.

A copolymer composition, such as a resin, has a composition distribution, which refers to the distribution of comonomer that forms short chain branches along the copolymer backbone. When the amount of short chain branches varies among the copolymer molecules, the composition is said to have a “broad” composition distribution. When the amount of comonomer per 1,000 carbons is similar among the copolymer molecules of different chain lengths, the composition distribution is said to be “narrow”. Like comonomer content, the composition distribution influences the properties of a copolymer composition, for example, stiffness, toughness, environmental stress crack resistance, and heat sealing, among other properties. The composition distribution of a polyolefin composition may be readily measured by, for example, Temperature Rising Elution Fractionation (TREF) or Crystallization Analysis Fractionation (CRYSTAF).

For some purposes, polyolefin compositions would have broad composition distributions that include a first polyolefin component having low molecular weight and low comonomer content while a second polyolefin component has a high molecular weight and high comonomer content. Compositions having this broad orthogonal composition distribution (BOCD) in which the comonomer is incorporated predominantly in the high molecular weight chains can provide improved physical properties, for example toughness properties and environmental stress crack resistance (ESCR).

Also, like comonomer content, a composition distribution of a copolymer composition is influenced by the identity of the catalyst used to form the polyolefins of the composition. Ziegler-Natta catalysts and chromium based catalysts generally produce compositions with broad composition distributions, whereas metallocene catalysts typically produce compositions with narrow composition distributions. Nonetheless, polyolefin compositions formed by catalysts capable of forming high molecular weight polyolefins typically also have a broad molecular weight distribution (MWD), as indicated by high polydispersity indices, and/or the polyolefins are of such high molecular weight (e.g., Mw of 1,500,000) as to have processing difficulties due to hardness. Furthermore, metallocenes, such as group 4 metallocenes, can be susceptible to beta-hydride elimination or beta-hydride transfer to monomer processes under typical polymerization conditions.

There is a need for catalysts capable of forming polyolefins, for example, with high molecular weight (but with an Mw of less than 1,500,000), high comonomer content, narrow polydispersity indices, and broad orthogonal composition distribution.

References for citing in an Information Disclosure Statement (37 CFR 1.97(h): U.S. Pat. Nos. 7,087,690; 8,519,070; 6,953,764; U.S. Publication No. 2009/0227747; JP 2000/239313; EP 2630172; Boussie et al. (2006) “Nonconventional Catalysts for Isotactic Propene Polymerization in Solution Developed by Using High-Throughput-Screening Technologies,” Angew. Chem. Int. Ed., v. 45(20), pp. 3278-3283; Wang et al. (2015) “Group 4 Metal Complexes Bearing the Aminoborane Motif: Origin of Tandem Ring-Opening Metathesis/Vinyl-Insertion Polymerization,” Polymer Chemistry, v. 6, pp. 3290-3304; Narayana, G. V. et al. (2014) “Access to Ultra-High-Molecular Weight Poly(ethylene) and Activity Boost in the Presence of Cyclopentene with Group 4 Bis-Amido Complexes,” ChemPlusChem, v. 79(1), pp. 151-162; Zou, Y. et al. (2011) “Group 4 Dimethylsilylenebisamido Complexes Bearing the 6-[2-(Diethylboryl)phenyl]pyrid-2-yl Motif: Synthesis and Use in Tandem Ring-Opening Metathesis/Vinyl-Insertion Copolymerization of Cyclic Olefins with Ethylene,” Chemistry—A European Journal, v. 17(49), pp. 13832-13846. Camadanli, et al. (2011) Polymer Preprints (American Chemical Society, Division of Polymer Chemistry), v. 52(1); Kirillov, E. et al. (2009) “Group 4 Post-metallocene Complexes Incorporating Tridentate Silyl-Substituted Bis(naphthoxy)pyridine and Bis(naphthoxy)thiophene Ligands: Probing Systems for “Oscillating” Olefin Polymerization Catalysis,” Organometallics, v. 28(17), pp. 5036-5051.

### SUMMARY

The present disclosure relates to catalyst compounds represented by Formula (I):

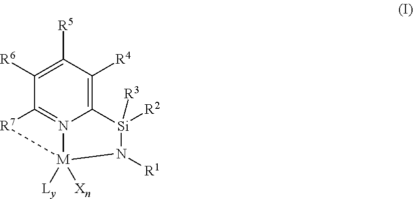

wherein:

M is a group 3, 4, 5, 6, 7, 8, 9, or 10 metal; (such as M is Zr or Hf, such as M is Hf);

L is a neutral Lewis base, or two L groups may be joined to form a bidentate Lewis base;

y is 0, 1, or 2;

each of X is independently a univalent anionic ligand, a diene ligand, an alkylidene ligand, or two Xs are joined to form a metallocyclic ring;

X may be joined to L to form a monoanionic bidentate group;

n is 1 or 2;

n+y is not greater than 4;

R¹ is selected from substituted or unsubstituted hydrocarbyl or silyl groups;

R² and R³ are independently hydrogen, hydrocarbyl, alkoxy, silyl, amino, aryloxy, substituted hydrocarbyl, halogen, or phosphino, or R² and R³ are joined to form substituted hydrocarbyl ring, unsubstituted hydrocarbyl ring, substituted heterocyclic ring, or unsubstituted heterocyclic ring having 5, 6, 7, or 8 ring atoms;

each of R⁴, R⁵, and R⁶ is independently hydrogen, hydrocarbyl, alkoxy, silyl, amino, aryloxy, substituted hydrocarbyl, halogen, phosphino, or R⁴ and R⁵ or R⁵ and R⁶ are joined to form a substituted hydrocarbyl ring, unsubstituted hydrocarbyl ring, substituted heterocyclic ring, or unsubstituted heterocyclic ring having 5, 6, 7, or 8 ring atoms; and R⁷ is a group containing two or more carbons and is optionally bonded to M.

In yet another embodiment, the present disclosure provides a catalyst system comprising an activator and a catalyst of the present disclosure.

In yet another embodiment, the present disclosure provides a catalyst system comprising an activator, a catalyst support, and a catalyst of the present disclosure.

In still another embodiment, the present disclosure provides a polymerization process comprising a) contacting one or more olefin monomers with a catalyst system comprising: i) an activator and ii) a catalyst of the present disclosure.

In still another embodiment, the present disclosure provides a polyolefin formed by a catalyst system and or method of the present disclosure.

In another class of embodiments, the present disclosure provides for a process for the production of an ethylene alpha-olefin copolymer comprising polymerizing ethylene and at least one C₃-C₂₀ alpha-olefin by contacting the ethylene and the at least one C₃-C₂₀ alpha-olefin with a catalyst system in at least one gas phase reactor, optionally in the presence of a chain transfer agent, such as diethyl zinc.

### BRIEF DESCRIPTION OF THE DRAWINGS

FIG. 1 shows the molecular structure (determined by X-ray diffraction) of complex 7 drawn with 50% thermal ellipsoids.

### DETAILED DESCRIPTION

A catalyst family with a new structural motif has been demonstrated to be capable of polymerizing alkenes. The catalyst family includes group 4 pyridylamides that feature a bridging silyl group between the pyridine and the amido nitrogen.

The present disclosure is further directed to catalyst systems and their use in polymerization processes to produce polyolefin polymers such as polyethylene polymers and polypropylene polymers. In another class of embodiments, the present disclosure is directed to polymerization processes to produce polyolefin polymers from catalyst systems comprising the product of the combination of one or more olefin polymerization catalysts, at least one activator, and at least one support.

In at least one embodiment, a polymerization process produces a polyethylene polymer, the process comprising contacting a catalyst system comprising the product of the combination of one or more transition metal catalysts, at least one activator, at least one support, and an optional chain transfer agent, with ethylene and one or more C₃-C₁₀ alpha-olefin comonomers under polymerization conditions.

Catalysts, catalyst systems, and processes of the present disclosure can provide polyolefins at activity values of, for example, 1,000 g/mmol/hour/bar or greater, high Mw (e.g., 100,000 or greater), Mn values of 10,000 or greater, narrow PDI (e.g., about 3 or less). Catalysts, catalyst systems, and processes of the present disclosure can provide polymers having a high comonomer content (e.g., 7 wt % or greater), a melting temperature (Tm) value of 100° C. or greater. Polymer properties such as comonomer content, Tm, and/or Mw can be controllable by the use of a chain transfer agent in a catalyst system including a catalyst of the present disclosure.

For purposes of the present disclosure, the numbering scheme for the Periodic Table Groups is used as described in Chemical and Engineering News, 63(5), pg. 27 (1985). Therefore, a “group 4 metal” is an element from group 4 of the Periodic Table, e.g., Hf, Ti, or Zr.

The specification describes transition metal complexes. The term complex is used to describe molecules in which an ancillary ligand is coordinated to a central transition metal atom. The ligand is bulky and stably bonded to the transition metal so as to maintain its influence during use of the catalyst, such as polymerization. The ligand may be coordinated to the transition metal by covalent bond and/or electron donation coordination or intermediate bonds. The transition metal complexes are generally subjected to activation to perform their polymerization or oligomerization function using an activator which, without being bound by theory, is believed to create a cation as a result of the removal of an anionic group, often referred to as a leaving group, from the transition metal.

As used herein, “olefin polymerization catalyst(s)” refers to any catalyst, typically an organometallic complex or compound that is capable of coordination polymerization addition where successive monomers are added in a monomer chain at the organometallic active center.

The terms “substituent,” “radical,” “group,” and “moiety” may be used interchangeably.

As used herein, and unless otherwise specified, the term “Ce” means hydrocarbon(s) having n carbon atom(s) per molecule, where n is a positive integer.

As used herein, and unless otherwise specified, the term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different values of n.

“Catalyst productivity” is a measure of how many grams of polymer (P) are produced using a polymerization catalyst comprising W g of catalyst (cat), over a period of time of T hours; and may be expressed by the following formula: P/(T×W) and expressed in units of gPgcat⁻¹ hr⁻¹. Conversion is the amount of monomer that is converted to polymer product, and is reported as mol % and is calculated based on the polymer yield and the amount of monomer fed into the reactor. Catalyst activity is a measure of how active the catalyst is and is reported as the grams of product polymer (P) produced per millimole of catalyst (cat) used per hour per bar of ethylene pressure (g polymer/mmol catalyst/h/bar).

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. “Different” is used to refer to mer units indicates that the mer units differ from each other by at least one atom or are different isomerically. Accordingly, the definition of copolymer, as used herein, includes terpolymers and the like. An “ethylene polymer” or “ethylene copolymer” is a polymer or copolymer comprising at least 50 mol % ethylene derived units, a “propylene polymer” or “propylene copolymer” is a polymer or copolymer comprising at least 50 mol % propylene derived units, and so on. An “ethylene polymer” or “ethylene copolymer” is a polymer or copolymer comprising at least 50 mol % ethylene derived units, a “propylene polymer” or “propylene copolymer” is a polymer or copolymer comprising at least 50 mol % propylene derived units, and so on.

For purposes of the present disclosure, ethylene and octene shall be considered an α-olefin.

For purposes of the present disclosure, the term “substituted” means that a hydrogen group has been replaced with a heteroatom, or a heteroatom containing group. For example, a “substituted hydrocarbyl” is a radical made of carbon and hydrogen where at least one hydrogen is replaced by a heteroatom or heteroatom containing group.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol.

Unless otherwise noted all melting points/melting temperatures (Tm) are DSC second melt.

The following abbreviations may be used herein: dme is 1,2-dimethoxyethane, Me is methyl, Ph is phenyl, Et is ethyl, Pr is propyl, iPr is isopropyl, n-Pr is normal propyl, Bu is butyl, cPR is cyclopropyl, iBu is isobutyl, tBu is tertiary butyl, p-tBu is para-tertiary butyl, nBu is normal butyl, sBu is sec-butyl, TMS is trimethylsilyl, MAO is methylalumoxane, p-Me is para-methyl, Ph is phenyl, Bn is benzyl (i.e., CH₂Ph), THF (also referred to as thf) is tetrahydrofuran, RT is room temperature (and is 23° C. unless otherwise indicated), tol is toluene, EtOAc is ethyl acetate, and Cy is cyclohexyl.

A “catalyst system” comprises at least one catalyst compound and at least one activator. When “catalyst system” is used to describe such the catalyst compound/activator combination before activation, it means the unactivated catalyst complex (precatalyst) together with an activator and, optionally, a co-activator. When it is used to describe the combination after activation, it means the activated complex and the activator or other charge-balancing moiety. The transition metal compound may be neutral as in a precatalyst, or a charged species with a counter ion as in an activated catalyst system. For purposes of the present disclosure, when catalyst systems are described as comprising neutral stable forms of the components, it is well understood by one of ordinary skill in the art, that the ionic form of the component is the form that reacts with the monomers to produce polymers.

In the description herein, the transition metal catalyst may be described as a catalyst precursor, a pre-catalyst compound, transition metal catalyst compound or a transition metal compound, and these terms are used interchangeably. A polymerization catalyst system is a catalyst system that can polymerize monomers to polymer. An “anionic ligand” is a negatively charged ligand which donates one or more pairs of electrons to a metal ion. A “neutral donor ligand” is a neutrally charged ligand which donates one or more pairs of electrons to a metal ion. Activator and cocatalyst are also used interchangeably.

A scavenger is a compound that is typically added to facilitate polymerization by scavenging impurities. Some scavengers may also act as activators and may be referred to as co-activators. A co-activator, that is not a scavenger, may also be used in conjunction with an activator in order to form an active catalyst. In some embodiments a co-activator can be pre-mixed with the transition metal compound to form an alkylated transition metal compound.

Non-coordinating anion (NCA) is an anion either that does not coordinate to the catalyst metal cation or that does coordinate to the metal cation, but only weakly. The term NCA is also defined to include multicomponent NCA-containing activators, such as N,N-dimethylanilinium tetrakis(pentafluorophenyl)borate, that contain an acidic cationic group and the non-coordinating anion. The term NCA is also defined to include neutral Lewis acids, such as tris(pentafluorophenyl)boron, that can react with a catalyst to form an activated species by abstraction of an anionic group. An NCA coordinates weakly enough that a neutral Lewis base, such as an olefinically or acetylenically unsaturated monomer can displace it from the catalyst center. Any metal or metalloid that can form a compatible, weakly coordinating complex may be used or contained in the non-coordinating anion. Suitable metals include, but are not limited to, aluminum, gold, and platinum. Suitable metalloids include, but are not limited to, boron, aluminum, phosphorus, and silicon.

For purposes of the present disclosure, in relation to the transition metal catalyst compounds, the term “substituted” means that a hydrogen group has been replaced with a hydrocarbyl group, a heteroatom, or a heteroatom containing group. For example, phenylpyridine is a pyridine group substituted with a phenyl group.

For purposes of the present disclosure, “alkoxides” include those where the alkyl group is a C₁ to C₁₀ hydrocarbyl. The alkyl group may be straight chain, branched, or cyclic. The alkyl group may be saturated or unsaturated. In some embodiments, the alkyl group may comprise at least one aromatic group.

As used herein the term “aromatic” also refers to pseudoaromatic heterocycles which are heterocyclic substituents that have similar properties and structures (nearly planar) to aromatic heterocyclic ligands, but are not by definition aromatic; likewise, the term aromatic also refers to substituted aromatics.

The terms “hydrocarbyl radical,” “hydrocarbyl,” “hydrocarbyl group,” “alkyl radical,” and “alkyl” are used interchangeably throughout this document. Likewise, the terms “group,” “radical,” and “substituent” are also used interchangeably in this document. For purposes of this disclosure, “hydrocarbyl radical” is defined to be C₁-C₁₀₀ radicals, that may be linear, branched, or cyclic, and when cyclic, aromatic or non-aromatic. Examples of such radicals can include methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like including their substituted analogues. Substituted hydrocarbyl radicals are radicals in which at least one hydrogen atom of the hydrocarbyl radical has been substituted with at least one halogen (such as Br, Cl, F or I) or at least one functional group, such as NR*₂, OR*, SeR*, TeR*, PR*₂, AsR*₂, SbR*₂, SR*, BR*₂, SiR*₃, GeR*₃, SnR*₃, PbR*₃, and the like, or where at least one heteroatom has been inserted within a hydrocarbyl ring.

Certain abbreviations may be used to for the sake of brevity and include but are not limited to Me=methyl, Et=ethyl, Pr=propyl, Bu=butyl, Ph=phenyl, Cp=cyclopentadienyl, Cp*=pentamethyl cydopentadienyl, Ind=indenyl, etc.

The term “alkenyl” means a straight-chain, branched-chain, or cyclic hydrocarbon radical having one or more double bonds. These alkenyl radicals may be optionally substituted. Examples of suitable alkenyl radicals can include ethenyl, propenyl, allyl, 1,4-butadienyl cyclopropenyl, cyclobutenyl, cyclopentenyl, cyclohexenyl, cycloctenyl, and the like, including their substituted analogues.

The term “alkoxy” or “alkoxide” means an alkyl ether or aryl ether radical wherein the term alkyl is as defined above. Examples of suitable alkyl ether radicals can include methoxy, ethoxy, n-propoxy, iso-propoxy, n-butoxy, iso-butoxy, sec-butoxy, tert-butoxy, phenoxyl, and the like.

The term “aryl” or “aryl group” means a six carbon aromatic ring and the substituted variants thereof, such as phenyl, 2-methyl-phenyl, xylyl, 4-bromo-xylyl. Likewise, heteroaryl means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

Where isomers of a named alkyl, alkenyl, alkoxide, or aryl group exist (e.g., n-butyl, iso-butyl, sec-butyl, and tert-butyl) reference to one member of the group (e.g., n-butyl) shall expressly disclose the remaining isomers (e.g., iso-butyl, sec-butyl, and tert-butyl) in the family. Likewise, reference to an alkyl, alkenyl, alkoxide, or aryl group without specifying a particular isomer (e.g., butyl) expressly discloses all isomers (e.g., n-butyl, iso-butyl, sec-butyl, and tert-butyl).

The term “ring atom” means an atom that is part of a cyclic ring structure. By this definition, a benzyl group has six ring atoms and tetrahydrofuran has 5 ring atoms.

A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom-substituted ring.

The term “continuous” means a system that operates without interruption or cessation. For example, a continuous process to produce a polymer would be one where the reactants are continually introduced into one or more reactors and polymer product is continually withdrawn until the polymerization is stopped, e.g. at 300 minutes.

A solution polymerization means a polymerization process in which the polymer is dissolved in a liquid polymerization medium, such as an inert solvent or monomer(s) or their blends. A solution polymerization is typically homogeneous. A homogeneous polymerization is one where the polymer product is dissolved in the polymerization medium. Such systems are preferably not turbid as described in Oliveira, J. V. et al. (2000) “High-Pressure Phase Equilibria for Polypropylene-Hydrocarbon Systems,” Ind. Eng. Chem. Res., v. 39(12), pp. 4627-4633.

A bulk polymerization means a polymerization process in which the monomers and/or comonomers being polymerized are used as a solvent or diluent using little or no inert solvent as a solvent or diluent. A small fraction of inert solvent might be used as a carrier for catalyst and scavenger. A bulk polymerization system contains less than 25 wt % of inert solvent or diluent, such as less than 10 wt %, such as less than 1 wt %, such as 0 wt %.

### Transition Metal Complexes

In some embodiments, the present disclosure provides bridged pyridylamide transition metal complexes, where the complexes include at least one pyridylamine ligand with particular combinations of substituents and bridged with, for example, an —Si— group. In at least one embodiment, the bridge is characterized in that it has at least one functionality, either included in the bridge or bonded to it, this being a Si—(R²)(R³), Ge—(R²)(R³), or Sn—(R²)(R³) type unity, such as Si—(R²)(R³), R² and R³ being hydrocarbyl; such as R² and R³ are C₁-C₁₀ hydrocarbyl.

The catalyst can be a non-metallocene catalyst. In an embodiment, a catalyst is selected from pyridyldiamido, quinolinyldiamido, phenoxyimine, bis(phenolate), cyclopentadienyl-amidinate, pyridylamido, and pyridine bis(imine) complexes. A catalyst can be selected from group 4 pyridyldiamido, quinolinyldiamido, phenoxyimine, and pyridylamido complexes. A catalyst can be selected from group 4 pyridylamido and quinolinyldiamido complexes, such as from group 4 pyridylamido complexes.

In at least one embodiment, a catalyst compound, and catalyst systems comprising such compounds, is a pyridyldiamido or quinolinyldiamido transition metal complex, such as a pyridyldiamido transition metal complex represented by formula (I):

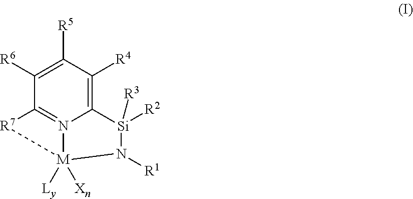

wherein:

M is a group 3, 4, 5, 6, 7, 8, 9, or 10 metal. (such as M is Zr or Hf, such as M is Hf). In at least one embodiment, M is hafnium.

L is a neutral Lewis base, or two L groups may be joined to form a bidentate Lewis base. In one embodiment, each instance of L is selected from ether, amine, phosphine, or thioether). y is 0, 1, or 2.

Each instance of X is independently a univalent anionic ligand, a diene ligand, an alkylidene ligand, or two Xs are joined to form a metallocyclic ring. In one embodiment, each instance of X is selected from methyl, chloride, or dialkylamido. X may be joined to L to form a monoanionic bidentate group. n is 1 or 2. n+y is not greater than 4. In at least one embodiment, n is 2 and each X is independently chloro or hydrocarbyl, such as X is independently chloro or methyl or benzyl, such as n is 2 and each X is methyl, such as n is 2 and each X is benzyl.

R¹ is selected from substituted or unsubstituted hydrocarbyl or silyl groups (such as R¹ is aryl, such as R¹ is 2,6-disubstituted aryl, such as R¹ is 2,6-diisopropylphenyl, such as R¹ is 2-substituted aryl, such as R¹ is phenyl). R¹ can be aryl, such as R¹ is 2,6-disubstituted aryl, such as R¹ is 2,6-dimethylphenyl, such as 2,6-diethylphenyl, such as 2,6-dipropylphenyl, such as 2,6-diisopropylphenyl, such as 2,6-dibutylphenyl, such as 2,6-diisobutylphenyl, such as 2,6-di-tert-butylphenyl, such as 2,6-dipentylphenyl, such as 2,6-dihexylphenyl, such as 2,6-diheptylphenyl, such as 2,6-dioctylphenyl, such as 2,6-dinonylphenyl, such as 2,6-didecylphenyl, and isomers thereof.

R² and R³ are independently hydrogen, hydrocarbyl, alkoxy, silyl, amino, aryloxy, substituted hydrocarbyl, halogen, or phosphino, or R² and R³ are joined to form a substituted hydrocarbyl ring, unsubstituted hydrocarbyl ring, substituted heterocyclic ring, or unsubstituted heterocyclic ring having 5, 6, 7, or 8 ring atoms. In at least one embodiment, R² and R³ are independently hydrogen, hydrocarbyl, or R² and R³ are joined to form substituted or unsubstituted hydrocarbyl containing ring having 4, 5, 6 or 7 ring atoms including Si, such as a substituted or unsubstituted hydrocarbyl containing ring having 5 ring atoms including Si.

In at least one embodiment, R² and R³ are phenyl. In another embodiment, where R² and R³ are independently methyl or ethyl. In yet another embodiment, R² and R³ are joined to form an unsubstituted hydrocarbyl ring having 5 ring atoms.

Each of R⁴, R⁵, and R⁶ is independently hydrogen, hydrocarbyl, alkoxy, silyl, amino, aryloxy, substituted hydrocarbyl, halogen, phosphino, or R⁴ and R⁵ or R⁵ and R⁶ are joined to form a substituted hydrocarbyl ring, unsubstituted hydrocarbyl ring, substituted heterocyclic ring, or unsubstituted heterocyclic ring having 5, 6, 7, or 8 ring atoms. In at least one embodiment, each of R⁴, R⁵, and R⁶ is hydrogen.

R⁷ is a group containing two or more carbon atoms and is optionally bonded to M.

In at least one embodiment, R⁷ is represented by the formula:

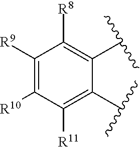

wherein:

each of R⁸, R⁹, R¹⁰, and R¹¹ is independently hydrogen, hydrocarbyl, alkoxy, silyl, amino, aryloxy, substituted hydrocarbyl, halogen, phosphino, or one or more R⁸ and R⁹, R⁹ and R¹⁰, or R¹⁰ and R¹¹ are joined to form one or more substituted hydrocarbyl rings, unsubstituted hydrocarbyl rings, substituted heterocyclic rings, or unsubstituted heterocyclic rings each having 5, 6, 7, or 8 ring atoms.

In at least one embodiment, R⁷ is represented by the formula:

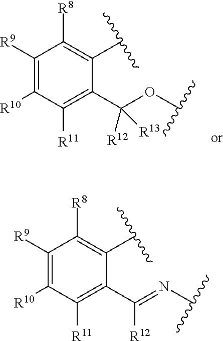

wherein:

each of R⁸, R⁹, R¹⁰, R¹¹, R¹², and R¹³ is independently hydrogen, hydrocarbyl, alkoxy, silyl, amino, aryloxy, substituted hydrocarbyl, halogen, phosphino, or one or more R⁸ and R⁹, R⁹ and R¹⁰, R¹⁰ and R¹¹, or R¹² and R¹³ are joined to form one or more substituted hydrocarbyl ring, unsubstituted hydrocarbyl rings, substituted heterocyclic rings, or unsubstituted heterocyclic rings, each having 5, 6, 7, or 8 ring atoms. In at least one embodiment, R⁸, R⁹, R¹⁰, R¹¹, R¹² and R¹³ are independently hydrogen or C₁-C₁₀ alkyl. In at least one embodiment, R⁸, R⁹, R¹⁰, R¹¹, R¹² and R¹³ are hydrogen. R⁸ and R⁹ can be joined to form substituted phenyl or unsubstituted phenyl.

In at least one embodiment, the catalyst compound represented by formula (I) is selected from:

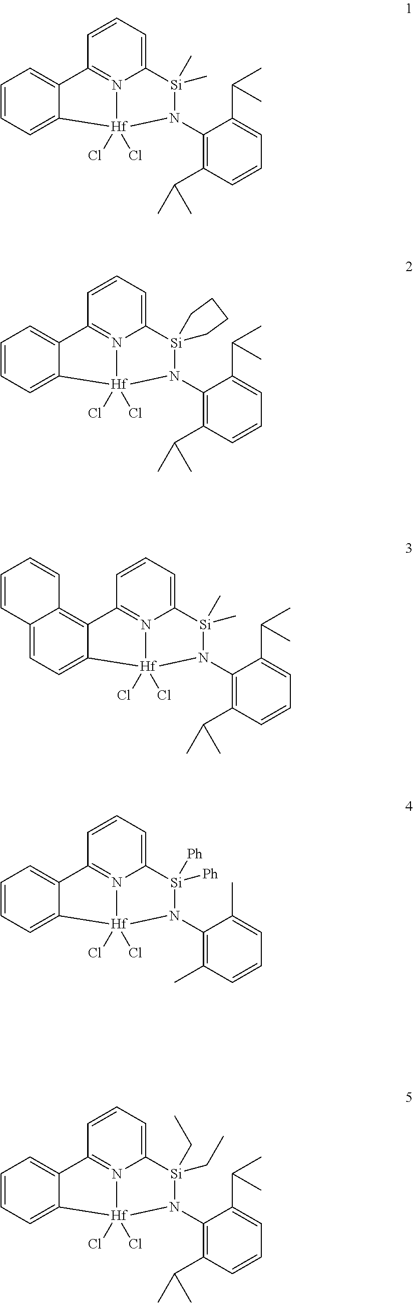

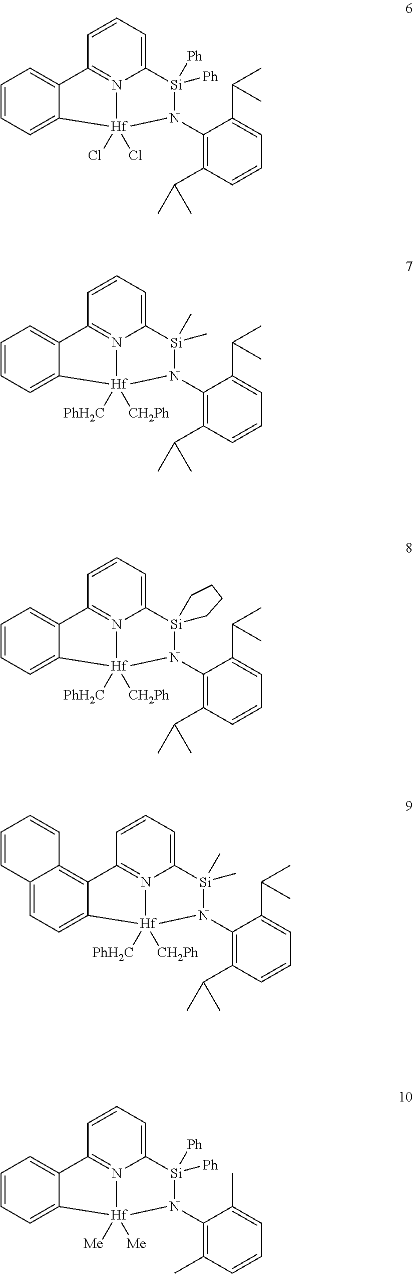

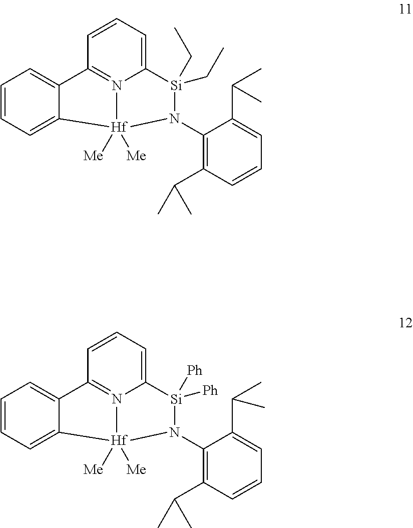

In at least one embodiment, the catalyst compound represented by formula (I) is selected from:

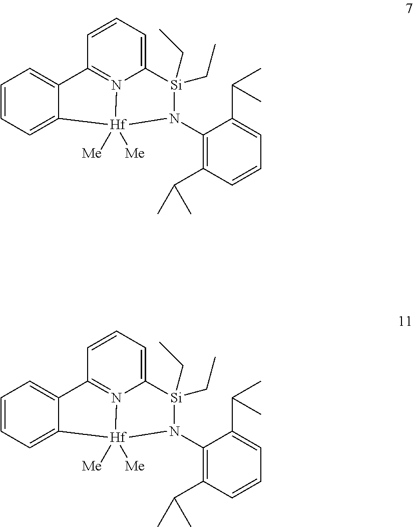

In another embodiment, the catalyst compound represented by formula (I) is selected from:

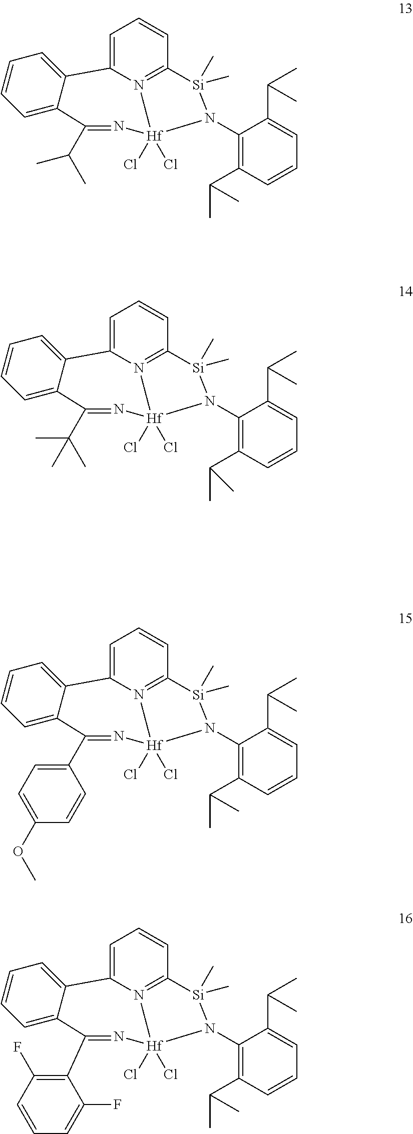

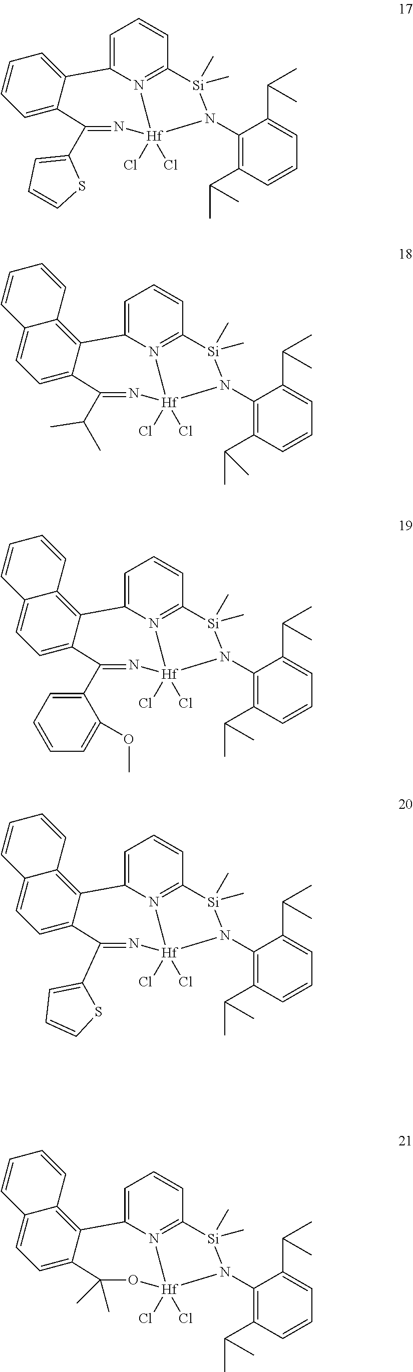

### Ligand Synthesis

The pyridylamine ligands described herein are generally prepared in multiple steps. The general route is outlined in Scheme 1. The 2-arylpyridine (A) is converted to the 2-bromo-6-arylpyridine (B) by the lithiation of the pyridine ring followed by reaction with 1,2-dibromoethane or another source of electrophilic bromine. The 2-bromo-6-arylpyridine is then reacted with butyllithium to generate 2-lithio-6-arylpyridine (C), which is then reacted with an excess of a dialkyldichlorosilane to form the chlorosilane-pyridine species (D). This product is then converted into the final pyridylamine ligand (E) by reaction with a lithium aryl amide. This general sequence allows for the production of highly pure (>95%) silyl-bridged pyridylamines without the need for purification by column chromatography.

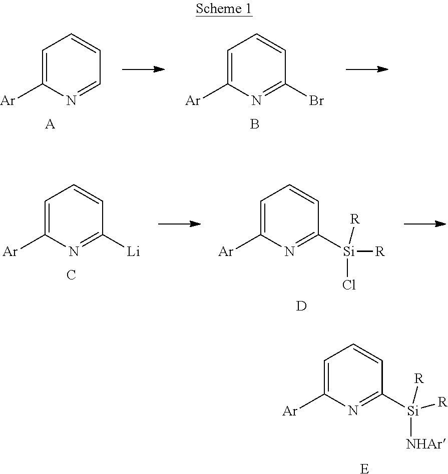

One method for the preparation of transition metal pyridylamine complexes is by reaction of the pyridylamine ligand (Scheme 2, structure F) with a metal reactant containing anionic basic leaving groups. Typical anionic basic leaving groups include dialkylamido, benzyl, phenyl, hydrido, and methyl. In this reaction, the role of the basic leaving group is to deprotonate the pyridylamine ligand. Suitable metal reactants for this type of reaction include, but are not limited to, HfBn₄ (Bn=CH₂Ph), ZrBn₄, TiBn₄, ZrBn₂Cl₂(OEt₂), HfBn₂Cl₂(OEt₂)₂, Zr(NMe₂)₂Cl₂(dimethoxyethane), Hf(NMe₂)₂Cl₂(dimethoxyethane), Hf(NMe₂)₄, Zr(NMe₂)₄, and Hf(NEt₂)₄. In the specific examples presented herein HfBn₄ is reacted with a pyridylamine ligand at elevated temperatures to form the pyridylamide complex. The complexes isolated typically feature a metalated aryl group (structure H), such that the metalated pyridylamido ligand is formally a dianionic, tridentate ligand. The metalated aryl group generally proceeds via an intermediate complex (G) that does not have a metalated aryl group.

A second method for the preparation of transition metal pyridylamide complexes is by reaction of the pyridylamine ligand with an alkali metal or alkaline earth metal base (e.g., BuLi, MeMgBr) to deprotonate the ligand, followed by reaction with a metal halide (e.g., HfCl₄, ZrCl₄).

Pyridylamide metal complexes that contain metal-halide, alkoxide, or amido leaving groups may be alkylated by reaction with organolithium, Grignard, and organoaluminum reagents as shown in Scheme 2. In the alkylation reaction the alkyl groups are transferred to the pyridylamide metal center and the leaving groups are removed. In Scheme 2, R¹ through R¹³ are as described above, L and X can be a halide, alkoxide, or dialkylamido leaving group. Reagents typically used for the alkylation reaction include, but are not limited to, MeLi, MeMgBr, AlMe₃, AliBu₃, AlOct₃, and PhCH₂MgCl. Typically 2 to 20 molar equivalents of the alkylating reagent are added to the pyridylamide complex. The alkylations are generally performed in etherial or hydrocarbon solvents or solvent mixtures at temperatures typically ranging from −80° C. to 70° C.

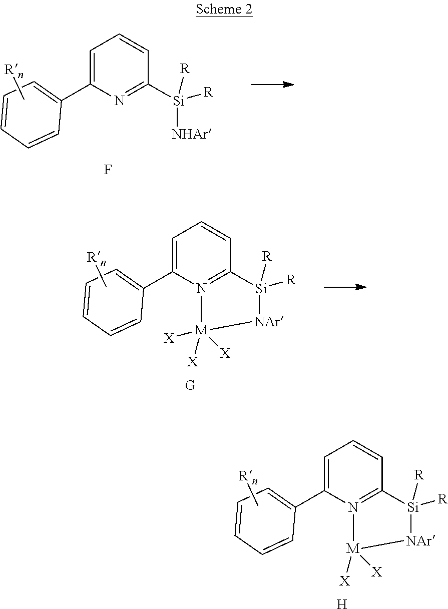

### Activators

The terms “cocatalyst” and “activator” are used herein interchangeably and are defined to be any compound which can activate any one of the catalyst compounds described above by converting the neutral catalyst compound to a catalytically active catalyst compound cation.

After the complexes described above have been synthesized, catalyst systems may be formed by combining them with activators in any suitable manner including by supporting them for use in slurry or gas phase polymerization. The catalyst systems may also be added to or generated in solution polymerization or bulk polymerization (in the monomer). The catalyst system typically comprises a complex as described above and an activator such as alumoxane or a non-coordinating anion.

Non-limiting activators, for example, include alumoxanes, aluminum alkyls, ionizing activators, which may be neutral or ionic, and conventional-type cocatalysts. Activators can include alumoxane compounds, modified alumoxane compounds, and ionizing anion precursor compounds that abstract a reactive, σ-bound, metal ligand making the metal complex cationic and providing a charge-balancing non-coordinating or weakly coordinating anion.

### Alumoxane Activators

In one embodiment, alumoxane activators are utilized as an activator in the catalyst system. Alumoxanes are generally oligomeric compounds containing—Al(R¹)—O— sub-units, where R¹ is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, particularly when the abstractable ligand is an alkyl, halide, alkoxide or amide. Mixtures of different alumoxanes and modified alumoxanes may also be used. It may be preferable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under U.S. Pat. No. 5,041,584). Another useful alumoxane is solid polymethylaluminoxane as described in U.S. Pat. Nos. 9,340,630; 8,404,880; and 8,975,209. Aluminum alkyls are available as hydrocarbon solutions from commercial sources. Methylalumoxane (“MAO”) is available from Albemarle as a 30 wt % solution in toluene.

When the activator is an alumoxane (modified or unmodified), some embodiments select the maximum amount of activator typically at up to a 5,000-fold molar excess Al/M over the catalyst compound (per metal catalytic site). The minimum activator-to-catalyst-compound is a 1:1 molar ratio. Alternate ranges include from 1:1 to 500:1, alternately from 1:1 to 200:1, alternately from 1:1 to 100:1, or alternately from 1:1 to 50:1.

In an alternate embodiment, little or no alumoxane is used in the polymerization processes described herein. For example, alumoxane is present at zero mole %, alternately the alumoxane is present at a molar ratio of aluminum to catalyst compound transition metal less than 500:1, such as less than 300:1, such as less than 100:1, such as less than 1:1.

### Non-Coordinating Anion Activators

A non-coordinating anion (NCA) is defined to mean an anion either that does not coordinate to the catalyst metal cation or that does coordinate to the metal cation, but only weakly. The term NCA is also defined to include multicomponent NCA-containing activators, such as N,N-dimethylanilinium tetrakis(pentafluorophenyl)borate, that contain an acidic cationic group and the non-coordinating anion. The term NCA is also defined to include neutral Lewis acids, such as tris(pentafluorophenyl)boron, that can react with a catalyst to form an activated species by abstraction of an anionic group. An NCA coordinates weakly enough that a neutral Lewis base, such as an olefinically or acetylenically unsaturated monomer can displace it from the catalyst center. Any metal or metalloid that can form a compatible, weakly coordinating complex may be used or contained in the non-coordinating anion. Suitable metals include, but are not limited to, aluminum, gold, and platinum. Suitable metalloids include, but are not limited to, boron, aluminum, phosphorus, and silicon.

“Compatible” non-coordinating anions can be those which are not degraded to neutrality when the initially formed complex decomposes. Further, the anion might not transfer an anionic substituent or fragment to the cation so as to cause it to form a neutral transition metal compound and a neutral by-product from the anion. Non-coordinating anions can be those that are compatible, stabilize the transition metal cation in the sense of balancing its ionic charge at +1, and yet retain sufficient lability to permit displacement during polymerization.

It is within the scope of the present disclosure to use an ionizing or stoichiometric activator, neutral or ionic, such as tri (n-butyl) ammonium tetrakis (pentafluorophenyl) borate, a tris perfluorophenyl boron metalloid precursor or a tris perfluoronaphthyl boron metalloid precursor, polyhalogenated heteroborane anions (WO 1998/043983), boric acid (U.S. Pat. No. 5,942,459), or combination thereof. It is also within the scope of the present disclosure to use neutral or ionic activators alone or in combination with alumoxane or modified alumoxane activators.

The catalyst systems of the present disclosure can include at least one non-coordinating anion (NCA) activator. In at least one embodiment, boron containing NCA activators represented by the formula below can be used:

Z_{d}⁺(A^{d-})

where: Z is (L-H) or a reducible Lewis acid; L is a neutral Lewis base; H is hydrogen; (L-H) is a Bronsted acid; A^{d-} is a boron containing non-coordinating anion having the charge d−; d is 1, 2, or 3.

The cation component, Z_{d}⁺ may include Bronsted acids such as protons or protonated Lewis bases or reducible Lewis acids capable of protonating or abstracting a moiety, such as an alkyl or aryl, from the bulky ligand catalyst containing transition metal catalyst precursor, resulting in a cationic transition metal species.

The activating cation Z_{d}⁺ may also be a moiety such as silver, tropylium, carboniums, ferroceniums and mixtures, such as carboniums and ferroceniums. Z_{d}⁺ can be triphenyl carbonium. Reducible Lewis acids can be any triaryl carbonium (where the aryl can be substituted or unsubstituted, such as those represented by the formula: (Ar₃C⁺), where Ar is aryl or aryl substituted with a heteroatom, a C₁ to C₄₀ hydrocarbyl, or a substituted C₁ to C₄₀ hydrocarbyl), such as the reducible Lewis acids in formula (14) above as “Z” include those represented by the formula: (Ph₃C), where Ph is a substituted or unsubstituted phenyl, such as substituted with C₁ to C₄₀ hydrocarbyls or substituted a C₁ to C₄₀ hydrocarbyls, such as C₁ to C₂₀ alkyls or aromatics or substituted C₁ to C₂₀ alkyls or aromatics, such as Z is a triphenylcarbonium.

When Z_{d}⁺ is the activating cation (L-H)_{d}⁺, it can be a Bronsted acid, capable of donating a proton to the transition metal catalytic precursor resulting in a transition metal cation, including ammoniums, oxoniums, phosphoniums, silyliums, and mixtures thereof, such as ammoniums of methylamine, aniline, dimethylamine, diethylamine, N-methylaniline, diphenylamine, trimethylamine, triethylamine, N,N-dimethylaniline, methyldiphenylamine, pyridine, p-bromo N,N-dimethylaniline, p-nitro-N,N-dimethylaniline, phosphoniums from triethylphosphine, triphenylphosphine, and diphenylphosphine, oxomiuns from ethers such as dimethyl ether diethyl ether, tetrahydrofuran and dioxane, sulfoniums from thioethers, such as diethyl thioethers, tetrahydrothiophene, and mixtures thereof.

The anion component A^{d-} includes those having the formula [M^{k}+Qₙ]^{d-} wherein k is 1, 2, or 3; n is 1, 2, 3, 4, 5, or 6 (such as 1, 2, 3, or 4); n−k=d; M is an element selected from group 13 of the Periodic Table of the Elements, such as boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 20 carbon atoms with the proviso that in not more than 1 occurrence is Q a halide. Each Q can be a fluorinated hydrocarbyl group having 1 to 20 carbon atoms, such as each Q is a fluorinated aryl group, and such as each Q is a pentafluoryl aryl group. Examples of suitable A^{d-} also include diboron compounds as disclosed in U.S. Pat. No. 5,447,895, which is fully incorporated herein by reference.

Illustrative, but not limiting, examples of boron compounds which may be used as an activating cocatalyst are the compounds described as (and particularly those specifically listed as) activators in U.S. Pat. No. 8,658,556, which is incorporated by reference herein.

The ionic stoichiometric activator Z_{d}⁺ (A^{d-}) can be one or more of N,N-dimethylanilinium tetra(perfluorophenyl)borate, N,N-dimethylanilinium tetrakis(perfluoronaphthyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, or triphenylcarbenium tetra(perfluorophenyl)borate.

Bulky activators are also useful herein as NCAs. “Bulky activator” as used herein refers to anionic activators represented by the formula:

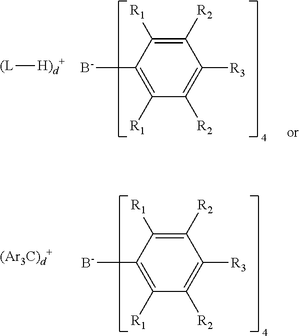

where:

each R₁ is independently a halide, such as a fluoride;

Ar is substituted or unsubstituted aryl group (such as a substituted or unsubstituted phenyl), such as substituted with C₁ to C₄₀ hydrocarbyls, such as C₁ to C₂₀ alkyls or aromatics;

each R₂ is independently a halide, a C₆ to C₂₀ substituted aromatic hydrocarbyl group or a siloxy group of the formula —O—Si—Rₐ, where Rₐ is a C₁ to C₂₀ hydrocarbyl or hydrocarbylsilyl group (such as R₂ is a fluoride or a perfluorinated phenyl group);

each R₃ is a halide, C₆ to C₂₀ substituted aromatic hydrocarbyl group or a siloxy group of the formula —O—Si—Rₐ, where Rₐ is a C₁ to C₂₀ hydrocarbyl or hydrocarbylsilyl group (such as R₃ is a fluoride or a C₆ perfluorinated aromatic hydrocarbyl group); wherein R₂ and R₃ can form one or more saturated or unsaturated, substituted or unsubstituted rings (such as R₂ and R₃ form a perfluorinated phenyl ring); and

L is a neutral Lewis base; (L-H)⁺ is a Bronsted acid; d is 1, 2, or 3;

wherein the anion has a molecular weight of greater than 1020 g/mol; and

wherein at least three of the substituents on the B atom each have a molecular volume of greater than 250 cubic Å, alternately greater than 300 cubic Å, or alternately greater than 500 cubic Å.

For example, (Ar₃C)_{d}⁺ can be (Ph₃C)_{d}⁺, where Ph is a substituted or unsubstituted phenyl, such as substituted with C₁ to C₄₀ hydrocarbyls or substituted C₁ to C₄₀ hydrocarbyls, such as C₁ to C₂₀ alkyls or aromatics or substituted C₁ to C₂₀ alkyls or aromatics.

“Molecular volume” is used herein as an approximation of spatial steric bulk of an activator molecule in solution. Comparison of substituents with differing molecular volumes allows the substituent with the smaller molecular volume to be considered “less bulky” in comparison to the substituent with the larger molecular volume. Conversely, a substituent with a larger molecular volume may be considered “more bulky” than a substituent with a smaller molecular volume.

Molecular volume may be calculated as reported in Girolami, G. S. (1994) “A Simple “Back of the Envelope” Method for Estimating the Densities and Molecular Volumes of Liquids and Solids,” Journal of Chemical Education, v. 71(11), pp. 962-964. Molecular volume (MV), in units of cubic Å, is calculated using the formula: MV=8.3Vₛ, where Vₛ is the scaled volume. Vₛ is the sum of the relative volumes of the constituent atoms, and is calculated from the molecular formula of the substituent using the following table of relative volumes. For fused rings, the Vₛ is decreased by 7.5% per fused ring.

| Element | Relative Volume |
|---|---|
| H | 1 |
| 1^{st} short period, Li to F | 2 |
| 2^{nd} short period, Na to Cl | 4 |
| 1^{st} long period, K to Br | 5 |
| 2^{nd} long period, Rb to I | 7.5 |
| 3^{rd} long period, Cs to Bi | 9 |

For a list of particularly useful Bulky activators please see U.S. Pat. No. 8,658,556, which is incorporated by reference herein.

In another embodiment, one or more of the NCA activators is chosen from the activators described in U.S. Pat. No. 6,211,105.

Exemplary activators include N,N-dimethylanilinium tetrakis(perfluoronaphthyl)borate, N,N-dimethylanilinium tetrakis(perfluorobiphenyl)borate, N,N-dimethylanilinium tetrakis(perfluorophenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, triphenylcarbenium tetrakis(perfluorophenyl)borate, [Ph₃C⁺][B(C₆F₅)₄⁻], [Me₃NH⁺][B(C₆F₅)₄⁻], 1-(4-(tris(pentafluorophenyl)borate)-2,3,5,6-tetrafluorophenyl)pyrrolidinium, and tetrakis(pentafluorophenyl)borate, 4-(tris(pentafluorophenyl)borate)-2,3,5,6-tetrafluoropyridine.

In at least one embodiment, the activator comprises a triaryl carbonium (such as triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthyl)borate, triphenylcarbenium tetrakis(perfluorobiphenyl)borate, and triphenylcarbenium tetrakis(3,5-bis(trifluoromethyl)phenyl)borate).

In another embodiment, the activator comprises one or more of trialkylammonium tetrakis(pentafluorophenyl)borate, N,N-dialkylanilinium tetrakis(pentafluorophenyl)borate, N,N-dimethyl-(2,4,6-trimethylanilinium) tetrakis(pentafluorophenyl)borate, trialkylammonium tetrakis-(2,3,4,6-tetrafluorophenyl) borate, N,N-dialkylanilinium tetrakis-(2,3,4,6-tetrafluorophenyl)borate, trialkylammonium tetrakis(perfluoronaphthyl)borate, N,N-dialkylanilinium tetrakis(perfluoronaphthyl)borate, trialkylammonium tetrakis(perfluorobiphenyl)borate, N,N-dialkylanilinium tetrakis(perfluorobiphenyl)borate, trialkylammonium tetrakis(3,5-bis(trifluoromethyl)phenyl)borate, N,N-dialkylanilinium tetrakis(3,5-bis(trifluoromethyl)phenyl)borate, N,N-dialkyl-(2,4,6-trimethylanilinium) tetrakis(3,5-bis(trifluoromethyl)phenyl)borate, and di-(i-propyl)ammonium tetrakis(pentafluorophenyl)borate (where alkyl is methyl, ethyl, propyl, n-butyl, sec-butyl, or t-butyl).

The typical activator-to-catalyst ratio, e.g., all NCA activators-to-catalyst ratio is about a 1:1 molar ratio. Alternate ranges include from 0.1:1 to 100:1, alternately from 0.5:1 to 200:1, alternately from 1:1 to 500:1, alternately from 1:1 to 1000:1. A particularly useful range is from 0.5:1 to 10:1, such as 1:1 to 5:1.

It is also within the scope of the present disclosure that the catalyst compounds can be combined with combinations of alumoxanes and NCA's (see for example, U.S. Pat. Nos. 5,153,157; 5,453,410; EP 0573120; WO 1994/007928; and WO 1995/014044 which discuss the use of an alumoxane in combination with an ionizing activator).

### Supports

Useful chain transfer agents can be alkylalumoxanes, a compound represented by the formula AlR3, ZnR2 (where each R is, independently, a C1-C8 aliphatic radical, such as methyl, ethyl, propyl, butyl, pentyl, hexyl octyl or an isomer thereof) or a combination thereof, such as diethyl zinc, methylalumoxane, trimethylaluminum, triisobutylaluminum, trioctylaluminum, or a combination thereof.

In at least one embodiment, the complexes described herein may be supported (with or without an activator) by any method effective to support other coordination catalyst systems, effective meaning that the catalyst so prepared can be used for oligomerizing or polymerizing olefin in a heterogeneous process. The catalyst precursor, activator, co-activator if needed, suitable solvent, and support may be added in any order or simultaneously. Typically, the complex and activator may be combined in solvent to form a solution. Then the support is added, and the mixture is stirred for 1 minute to 10 hours. The total solution volume may be greater than the pore volume of the support, but some embodiments limit the total solution volume below that needed to form a gel or slurry (about 90% to 400%, such as about 100-200% of the pore volume). After stirring, the residual solvent is removed under vacuum, typically at ambient temperature and over 10-16 hours. But greater or lesser times and temperatures are possible.

The complex may also be supported absent the activator; in that case, the activator (and co-activator if needed) is added to a polymerization process's liquid phase. Additionally, two or more different complexes may be placed on the same support. Likewise, two or more activators or an activator and co-activator may be placed on the same support.

Suitable solid particle supports are typically comprised of polymeric or refractory oxide materials, each being preferably porous. Any support material that has an average particle size greater than 10 μm can be suitable for use in the present disclosure. Various embodiments select a porous support material, such as for example, talc, inorganic oxides, inorganic chlorides, for example, magnesium chloride and resinous support materials such as polystyrene polyolefin or polymeric compounds or any other organic support material and the like. Some embodiments select inorganic oxide materials as the support material including Group-2, -3, -4, -5, -13, or -14 metal or metalloid oxides. Some embodiments select the catalyst support materials to include silica, alumina, silica-alumina, and their mixtures. Other inorganic oxides may serve either alone or in combination with the silica, alumina, or silica-alumina. These are magnesia, titania, zirconia, and the like. Lewis acidic materials such as montmorillonite and similar clays may also serve as a support. In this case, the support can optionally double as the activator component; however, an additional activator may also be used.

The support material may be pretreated by any number of methods. For example, inorganic oxides may be calcined, chemically treated with dehydroxylating agents, such as, aluminum alkyls and the like, or both.

As stated above, polymeric carriers will also be suitable in accordance with the present disclosure, see, for example, the descriptions in WO 1995/015815 and U.S. Pat. No. 5,427,991. The methods disclosed may be used with the catalyst complexes, activators, or catalyst systems of the present disclosure to adsorb or absorb them on the polymeric supports, particularly if made up of porous particles, or may be chemically bound through functional groups bound to or in the polymer chains.

Useful supports typically have a surface area of from 10-700 m²/g, a pore volume of 0.1-4.0 cc/g and an average particle size of 10-500 μm. Some embodiments select a surface area of 50-500 m²/g, a pore volume of 0.5-3.5 cc/g, or an average particle size of 20-200 μm. Other embodiments select a surface area of 100-400 m²/g, a pore volume of 0.8-3.0 cc/g, and an average particle size of 30-100 μm. Useful supports typically have a pore size of 10-1,000 Angstroms, alternatively 50-500 Angstroms, or 75-350 Angstroms.

The catalyst complexes described herein are generally deposited on the support at a loading level of 10-100 micromoles of complex per gram of solid support; alternately 20-80 micromoles of complex per gram of solid support; or 40-60 micromoles of complex per gram of support. But greater or lesser values may be used provided that the total amount of solid complex does not exceed the support's pore volume.

### Polymerization

The present disclosure relates to polymerization processes where monomer (such as ethylene), and optionally comonomer, are contacted with a catalyst system comprising an activator and at least one transition metal compound, as described above. The catalyst compound and activator may be combined in any order, and are combined typically prior to contacting with the monomer.

Monomers include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the monomer comprises propylene and an optional comonomer comprising one or more ethylene or C₄ to C₄₀ olefins, such as C₄ to C₂₀ olefins, such as C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and/or one or more functional groups. In at least one embodiment, the monomer comprises ethylene and an optional comonomer comprising one or more C₃ to C₄₀ olefins, such as C₄ to C₂₀ olefins, such as C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and/or one or more functional groups.

Exemplary C₂ to C₄₀ olefin monomers and optional comonomers include ethylene, propylene, butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, such as norbornene, norbornadiene, and dicyclopentadiene.

In at least one embodiment, one or more dienes are present in the polymer produced herein at up to 10 wt %, such as at 0.00001 wt % to 1.0 wt %, such as 0.002 wt % to 0.5 wt %, such as 0.003 wt % to 0.2 wt %, based upon the total weight of the composition. In some embodiments, 500 ppm or less of diene is added to the polymerization, such as 400 ppm or less, such as 300 ppm or less. In other embodiments, at least 50 ppm of diene is added to the polymerization, or 100 ppm or more, or 150 ppm or more.

Diolefin monomers include any suitable hydrocarbon structure, such as C₄ to C₃₀, having at least two unsaturated bonds, wherein at least two of the unsaturated bonds are readily incorporated into a polymer by either a stereospecific or a non-stereospecific catalyst(s). The diolefin monomers can be selected from alpha, omega-diene monomers (i.e., di-vinyl monomers). The diolefin monomers can be linear di-vinyl monomers, such as those containing from 4 to 30 carbon atoms. Dienes can include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, for example dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Cyclic dienes can include cyclopentadiene, vinylnorbornene, norbornadiene, ethylidene norbornene, divinylbenzene, dicyclopentadiene or higher ring containing diolefins with or without substituents at various ring positions.

Polymerization processes of the present disclosure can be carried out in any suitable manner. Any suitable suspension, homogeneous, bulk, solution, slurry, or gas phase polymerization process can be used. Such processes can be run in a batch, semi-batch, or continuous mode. Homogeneous polymerization processes and slurry processes can be used. (A homogeneous polymerization process is a process where at least 90 wt % of the product is soluble in the reaction media.) A bulk homogeneous process can be used. (A bulk process is a process where monomer concentration in all feeds to the reactor is 70 volume % or more). Alternately, no solvent or diluent is present or added in the reaction medium, (except for the small amounts used as the carrier for the catalyst system or other additives, or amounts typically found with the monomer; e.g., propane in propylene). In another embodiment, the process is a slurry process. As used herein, the term “slurry polymerization process” means a polymerization process where a supported catalyst is employed and monomers are polymerized on the supported catalyst particles. At least 95 wt % of polymer products derived from the supported catalyst are in granular form as solid particles (not dissolved in the diluent).

Suitable diluents/solvents for polymerization include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorinated C₄₋₁₀ alkanes, chlorobenzene, and aromatic and alkylsubstituted aromatic compounds, such as benzene, toluene, mesitylene, and xylene. Suitable solvents also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In at least one embodiment, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is not aromatic, such as aromatics are present in the solvent at less than 1 wt %, such as less than 0.5 wt %, such as less than 0 wt % based upon the weight of the solvents.

In at least one embodiment, the feed concentration of the monomers and comonomers for the polymerization is 60 vol % solvent or less, such as 40 vol % or less, such as 20 vol % or less, based on the total volume of the feedstream. In at least one embodiment, the polymerization is run in a bulk process.

Polymerizations can be run at any temperature and/or pressure suitable to obtain the desired ethylene polymers. Typical temperatures and/or pressures include a temperature in the range of from about 0° C. to about 300° C., such as about 20° C. to about 200° C., such as about 35° C. to about 150° C., such as from about 40° C. to about 120° C., such as from about 45° C. to about 80° C.; and at a pressure in the range of from about 0.35 MPa to about 10 MPa, such as from about 0.45 MPa to about 6 MPa, such as from about 0.5 MPa to about 4 MPa.

In a typical polymerization, the run time of the reaction is up to 300 minutes, such as from about 5 minutes to 250 minutes, such as from about 10 minutes to 120 minutes.

In some embodiments, hydrogen is present in the polymerization reactor at a partial pressure of from 0.001 psig to 50 psig (0.007 to 345 kPa), such as from 0.01 psig to 25 psig (0.07 kPa to 172 kPa), such as 0.1 psig to 10 psig (0.7 kPa to 70 kPa).

In at least one embodiment, the activity of the catalyst is at least 50 g/mmol/hour, such as 500 or more g/mmol/hour, such as 5,000 or more g/mmol/hr, such as 50,000 or more g/mmol/hr. In at least one embodiment, the conversion of olefin monomer is at least 10%, based upon polymer yield and the weight of the monomer entering the reaction zone, such as 20% or more, such as 30% or more, such as 50% or more, such as 80% or more.

In at least one embodiment, little or no alumoxane is used in the process to produce the polymers. For example, alumoxane is present at zero mol %, alternately the alumoxane is present at a molar ratio of aluminum to transition metal less than 500:1, such as less than 300:1, such as less than 100:1, such as less than 1:1.

In at least one embodiment, little or no scavenger is used in the process to produce the ethylene polymer. For example, scavenger (such as tri alkyl aluminum) is present at zero mol %, alternately the scavenger is present at a molar ratio of scavenger metal to transition metal of less than 100:1, such as less than 50:1, such as less than 15:1, such as less than 10:1.

In at least one embodiment, the catalyst system used in the polymerization comprises no more than one catalyst compound. A “reaction zone” also referred to as a “polymerization zone” is a vessel where polymerization takes place, for example, a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In at least one embodiment, the polymerization occurs in one reaction zone. Room temperature is 23° C. unless otherwise noted.

Other additives may also be used in the polymerization, such as one or more scavengers, promoters, modifiers, chain transfer agents (such as diethyl zinc), reducing agents, oxidizing agents, hydrogen, aluminum alkyls, or silanes.

Chain transfer agents include alkylalumoxanes, a compound represented by the formula AlR₃ or ZnR₂ (where each R is, independently, a C₁-C₈ aliphatic radical, such as methyl, ethyl, propyl, butyl, pentyl, hexyl, octyl or an isomer thereof), or a combination thereof, such as diethyl zinc, methylalumoxane, trimethylaluminum, triisobutylaluminum, trioctylaluminum, or a combination thereof.

In at least one embodiment, the present disclosure provides a process for the production of an ethylene alpha-olefin copolymer including: polymerizing ethylene and at least one C₃-C₂₀ alpha-olefin by contacting the ethylene and the at least one C₃-C₂₀ alpha-olefin with a catalyst system in at least one gas phase reactor at a reactor pressure of from 0.7 to 70 bar and a reactor temperature of from 20° C. to 150° C. to form an ethylene alpha-olefin copolymer.

In at least one embodiment, the present disclosure provides in an 18.5 foot tall gas-phase fluidized bed reactor a process where a catalyst has an activity from 20 gP/mmolCat/h/bar to 4,000 gP/mmolCat/h/bar, such as from 100 gP/mmolCat/h/bar to 3,500 gP/mmolCat/h/bar, such as from 500 gP/mmolCat/h/bar to 3,000 gP/mmolCat/h/bar.

In at least one embodiment, the present disclosure provides a process for the production of an ethylene alpha-olefin copolymer including: polymerizing ethylene and at least one C₃-C₂₀ alpha-olefin by contacting the ethylene and the at least one C₃-C₂₀ alpha-olefin with a catalyst system in at least one slurry phase reactor at a reactor pressure of from 0.7 to 70 bar and a reactor temperature of from 20° C. to 150° C. to form an ethylene alpha-olefin copolymer.

### Solution Polymerization

A solution polymerization is a polymerization process in which the polymer is dissolved in a liquid polymerization medium, such as an inert solvent or monomer(s) or their blends. A solution polymerization is typically homogeneous. A homogeneous polymerization is one where the polymer product is dissolved in the polymerization medium. Such systems are typically not turbid as described in Oliveira, J. V. et al. (2000) “High-Pressure Phase Equilibria for Polypropylene-Hydrocarbon Systems,” Ind. Eng, Chem. Res., v. 39(12), pp. 4627-4633. Generally solution polymerization involves polymerization in a continuous reactor in which the polymer formed and the starting monomer and catalyst materials supplied, are agitated to reduce or avoid concentration gradients and in which the monomer acts as a diluent or solvent or in which a hydrocarbon is used as a diluent or solvent. Suitable processes typically operate at temperatures from about 0° C. to about 250° C., such as about 10° C. to about 150° C., such as about 40° C. to about 140° C., such as about 50° C. to about 120° C., and at pressures of about 0.1 MPa or more, such as 2 MPa or more. The upper pressure limit is not critically constrained but typically can be about 200 MPa or less, such as 120 MPa or less. Temperature control in the reactor can generally be obtained by balancing the heat of polymerization and with reactor cooling by reactor jackets or cooling coils to cool the contents of the reactor, auto refrigeration, pre-chilled feeds, vaporization of liquid medium (diluent, monomers or solvent) or combinations of all three. Adiabatic reactors with pre-chilled feeds can also be used. The purity, type, and amount of solvent can be optimized for the maximum catalyst productivity for a particular type of polymerization. The solvent can be also introduced as a catalyst carrier. The solvent can be introduced as a gas phase or as a liquid phase depending on the pressure and temperature. Advantageously, the solvent can be kept in the liquid phase and introduced as a liquid. Solvent can be introduced in the feed to the polymerization reactors.

### Monomers

Monomers useful herein include olefins having from 2 to 20 carbon atoms, alternately 2 to 12 carbon atoms (such as ethylene, propylene, butylene, pentene, hexene, heptene, octene, nonene, decene, and dodecene) and optionally also polyenes (such as dienes). For example, monomers can be ethylene, and mixtures of C₂ to C₁₀ alpha olefins, such as ethylene-propylene, ethylene-hexene, ethylene-octene, propylene-hexene, and the like. In at least one embodiment of the present disclosure, monomers can be ethylene-octene mixture.

The complexes described herein are also particularly effective for the polymerization of ethylene, either alone or in combination with at least one other olefinically unsaturated monomer, such as a C₃ to C₂₀ α-olefin, and particularly a C₃ to Cu α-olefin. Likewise, the present complexes are also particularly effective for the polymerization of propylene, either alone or in combination with at least one other olefinically unsaturated monomer, such as ethylene or a C₄ to C₂₀ α-olefin, and particularly a C₄ to C₂₀ α-olefin. Examples of α-olefins can be ethylene, propylene, butene-1, pentene-1, hexene-1, heptene-1, octene-1, nonene-1, decene-1, dodecene-1, 4-methylpentene-1, 3-methylpentene-1,3,5,5-trimethylhexene-1, and 5-ethylnonene-1.

In at least one embodiment, the monomer mixture may also include one or more dienes at up to 10 wt %, such as from 0.00001 to 1.0 wt %, for example, from 0.002 to 0.5 wt %, such as from 0.003 to 0.2 wt %, based upon the monomer mixture. Non-limiting examples of useful dienes include, cyclopentadiene, norbornadiene, dicyclopentadiene, 5-ethylidene-2-norbornene, 5-vinyl-2-norbornene, 1,4-hexadiene, 1,5-hexadiene, 1,5-heptadiene, 1,6-heptadiene, 6-methyl-1,6-heptadiene, 1,7-octadiene, 7-methyl-1,7-octadiene, 1,9-decadiene, 1,9-dimethyl-1,9-decadiene.

The polymerization of ethylene or ethylene-rich copolymers with ethylene is expected to produce polymer with crystalline isotactic polypropylene runs. This is expected because the catalyst family has a seven-membered chelate ring, which effectively makes the catalyst C₁ symmetric (i.e., no symmetry) in use.

### Optional Scavengers or Co-Activators

In addition to these activator compounds, scavengers or co-activators may be used. Aluminum alkyl or organoaluminum compounds which may be utilized as scavengers or co-activators include, for example, trimethylaluminum, triethylaluminum, triisobutylaluminum, tri-n-hexylaluminum, tri-n-octylaluminum, and diethyl zinc.

In at least one embodiment, when using the complexes described herein, particularly when they are immobilized on a support, the catalyst system will additionally comprise one or more scavenging compounds. Here, the term scavenging compound means a compound that removes polar impurities from the reaction environment. These impurities adversely affect catalyst activity and stability. Typically, the scavenging compound will be an organometallic compound such as the group-13 organometallic compounds of U.S. Pat. Nos. 5,153,157; 5,241,025; WO-A-1991/009882; WO-A-1994/003506; WO-A-1993/014132; and that of WO 1995/007941. Exemplary compounds include triethylaluminum, triethyl borane, tri-iso-butyl aluminum, methyl alumoxane, iso-butyl alumoxane, and tri-n-octyl aluminum. Those scavenging compounds having bulky or C₆-C₂₀ linear hydrocarbyl substituents connected to the metal or metalloid center usually minimize adverse interaction with the active catalyst. Examples include triethylaluminum, bulky compounds such as tri-iso-butyl aluminum, tri-iso-prenyl aluminum, and long-chain linear alkylsubstituted aluminum compounds, such as tri-n-hexyl aluminum, tri-n-octyl aluminum, or tri-n-dodecyl aluminum. When alumoxane is used as the activator, any excess over that needed for activation will scavenge impurities and additional scavenging compounds may be unnecessary. Alumoxanes (methylalumoxane), aluminum oxides (e.g., bis(diisobutylaluminum)oxide), and modified alumoxanes (e.g., MMAO-3A) also may be added in scavenging quantities with other activators such as [Me₂HNPh]⁺[B(pfp)₄]⁻ or B(pfp)₃ (perfluorophenyl=pfp=C₆F₅).

### Polyolefin Products

The present disclosure relates to compositions of matter produced by the methods described herein.

In at least one embodiment, a process described herein produces C₂ to C₂₀ olefin homopolymers or copolymers, such as ethylene-hexene, ethylene-octene, propylene-ethylene and/or propylene-alphaolefin (such as C₃ to C₂₀) copolymers (such as propylene-hexene copolymers or propylene-octene copolymers) having low comonomer incorporation (such as C₆ wt %) and/or broad molecular weight distribution (MWD).

A polymer of the present disclosure can have an Mw from 15,000 to 1,000,000, such as from 50,000 to 900,000, such as from 100,000 to 800,000, such as from 200,000 to 700,000, such as from 300,000 to 600,000, such as from 350,000 to 570,000. A polymer of the present disclosure can have an Mn from 10,000 to 200,000, such as from 20,000 to 150,000 such as from 30,000 to 100,000, such as from 40,000 to 90,000, such as from 50,000 to 80,000.

In at least one embodiment, a polymer of the present disclosure has an Mw/Mn value from 1 to 5, such as from 2 to 4, such as from 2.5 to 3.5, such as from 3 to 3.5.

Likewise, the process of the present disclosure produces olefin polymers, such as polyethylene and polypropylene homopolymers and copolymers. In at least one embodiment, the polymers produced herein are homopolymers of ethylene or copolymers of ethylene having, for example, from 0.1 wt % to 25 wt %, alternately from 0.5 wt % to 20 wt %, alternately from 1 wt % to 15 wt %, such as from 1 wt % to 10 wt %, such as from 3 wt % to 10 wt % of one or more C₃ to C₂₀ olefin comonomer (such as C₃ to C₁₂ alpha-olefin, such as propylene, butene, hexene, octene, decene, dodecene, such as propylene, butene, hexene, octene). In at least one embodiment, the monomer is ethylene and the comonomer is hexene, such as from 1 wt % to 15 wt % hexene, such as from 3 wt % to 14 wt % hexene, such as from 6 wt % to 12 wt % hexene, alternately 9.0 wt % to 12 wt % based on the weight of the polymer.

In at least one embodiment, the polymers produced herein are homopolymers of propylene or are copolymers of propylene having, for example, from 0.1 wt % to 25 wt % (alternately from 0.5 wt % to 20 wt %, alternately from 1 wt % to 15 wt %, such as from 3 wt % to 10 wt %) of one or more of C₂ or C₄ to C₂₀ olefin comonomer (such as ethylene or C₄ to C₁₂ alpha-olefin, such asethylene, butene, hexene, octene, decene, dodecene, such as ethylene, butene, hexene, octene). In at least one embodiment, the monomer is propylene and the comonomer is hexene, such as from 1 wt % to 15 wt % hexene, such as from 3 wt % to 14 wt % hexene, such as from 6 wt % to 12 wt % hexene, alternately 9 wt % to 12 wt % based on the weight of the polymer.

In at least one embodiment, the polymers produced herein have an Mw of 50,000 to 1,000,000, and an Mn value of from 50,000 to 200,000, and/or an Mw/Mn of greater than 1 to 5, and a PDI of from 1 to 5, with melting point of 122° C. or greater, and further includes diethyl zinc as a chain transfer agent.

In at least one embodiment, a polymer is an ethylene alpha-olefin copolymer. In at least one embodiment, an ethylene alpha-olefin copolymer has a comonomer content of 6 wt % or greater, such as 8 wt % or greater, 10 wt % or greater, 12 wt % or greater, 14 wt % or greater, 16 wt % or greater, 18 wt % or greater. An ethylene alpha-olefin copolymer can have an Mw value of from 15,000 to 1,000,000, such as from 50,000 to 900,000, such as from 100,000 to 800,000, such as from 200,000 to 700,000, such as from 300,000 to 600,000, such as from 350,000 to 570,000. In at least one embodiment, an ethylene alpha-olefin copolymer has a Mn value of from 10,000 to 200,000, such as from 20,000 to 150,000 such as from 30,000 to 100,000, such as from 40,000 to 90,000, such as from 50,000 to 80,000. An ethylene alpha-olefin copolymer can have a PDI of 1 or greater, such as of 2 or greater, such as of 3 or greater, such as of 4 or greater, such as of 5 or greater. An ethylene alpha-olefin copolymer can have a melting point of 100° C. or greater, such as of 110° C. or greater, such as of 120° C. or greater, such as of 130° C. or greater.

In at least one embodiment, a polymer produced herein has a unimodal or multimodal molecular weight distribution as determined by Gel Permeation Chromatography (GPC). By “unimodal” is meant that the GPC trace has one peak or inflection point. By “multimodal” is meant that the GPC trace has at least two peaks or inflection points. An inflection point is that point where the second derivative of the curve changes in sign (e.g., from negative to positive or vice versus).

Molecular weight and measurement methods are described in the Experimental Section, in the event of conflict between the “Rapid GPC” and the GPC-4D methods, the GPC-4D method shall control.

Differential Scanning calorimetry (DSC-Procedure-2). Melting Temperature (Tm) is measured by differential scanning calorimetry (“DSC”) using a DSCQ200 unit. The sample is first equilibrated at 25° C. and subsequently heated to 220° C. using a heating rate of 10° C./min (first heat). The sample is held at 220° C. for 3 min. The sample is subsequently cooled down to −100° C. with a constant cooling rate of 10° C./min (first cool). The sample is equilibrated at −100° C. before being heated to 220° C. at a constant heating rate of 10° C./min (second heat). The exothermic peak of crystallization (first cool) is analyzed using the TA Universal Analysis software and the corresponding to 10° C./min cooling rate is determined. The endothermic peak of melting (second heat) is also analyzed using the TA Universal Analysis software and the peak melting temperature (Tm) corresponding to 10° C./min heating rate is determined. In the event of conflict between the DSC Procedure-1 and DSC procedure-2, DSC procedure-2 is used.

### End Uses

The polymers of the present disclosure may be blended and/or coextruded with any other polymer. Non-limiting examples of other polymers include linear low density polyethylenes, elastomers, plastomers, high pressure low density polyethylene, high density polyethylenes, isotactic polypropylene, ethylene propylene copolymers and the like.

Articles made using polymers produced herein may include, for example, molded articles (such as containers and bottles, e.g., household containers, industrial chemical containers, personal care bottles, medical containers, fuel tanks, and storageware, toys, sheets, pipes, tubing) films, non-wovens, and the like. It should be appreciated that the list of applications above is merely exemplary, and is not intended to be limiting.

In particular, polymers produced by the process of the present disclosure and blends thereof are useful in such forming operations as film, sheet, and fiber extrusion and co-extrusion as well as blow molding, injection molding, roto-molding. Films include blown or cast films formed by coextrusion or by lamination useful as shrink film, cling film, stretch film, sealing film or oriented films.

This invention further relates to:

1. A catalyst compound represented by Formula (I):

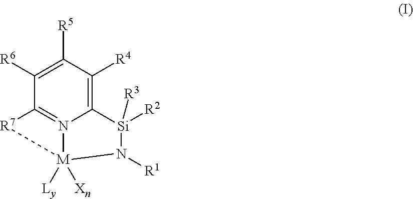

wherein:

M is a group 3, 4, 5, 6, 7, 8, 9, or 10 metal;

L is a neutral Lewis base, or two L groups may be joined to form a bidentate Lewis base;

y is 0, 1, or 2;

each of X is independently a univalent anionic ligand, a diene ligand, an alkylidene ligand, or two Xs are joined to form a metallocyclic ring;

X may be joined to L to form a monoanionic bidentate group;

n is 1 or 2;

n+y is not greater than 4;

R¹ is selected from substituted or unsubstituted hydrocarbyl or silyl groups;

R² and R³ are independently hydrogen, hydrocarbyl, alkoxy, silyl, amino, aryloxy, substituted hydrocarbyl, halogen, or phosphino, or R² and R³ are joined to form substituted or unsubstituted hydrocarbyl containing ring having 4, 5, 6 or 7 ring atoms including Si, such as a substituted or unsubstituted hydrocarbyl containing ring having 5 ring atoms including Si;

each of R⁴, R⁵, and R⁶ is independently hydrogen, hydrocarbyl, alkoxy, silyl, amino, aryloxy, substituted hydrocarbyl, halogen, phosphino, or R⁴ and R⁵ or R⁵ and R⁶ are joined to form a substituted hydrocarbyl ring, unsubstituted hydrocarbyl ring, substituted heterocyclic ring, or unsubstituted heterocyclic ring having 5, 6, 7, or 8 ring atoms; and

R⁷ is a group containing two or more carbons and is optionally bonded to M.

2. The catalyst compound of paragraph 1, wherein R⁷ is represented by the formula:

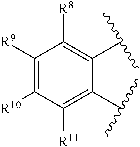

wherein:

each of R⁸, R⁹, R¹⁰, and R¹¹ is independently hydrogen, hydrocarbyl, alkoxy, silyl, amino, aryloxy, substituted hydrocarbyl, halogen, phosphino, or one or more R⁸ and R⁹, R⁹ and R¹⁰, or R¹⁰ and R¹¹ are joined to form one or more substituted hydrocarbyl rings, unsubstituted hydrocarbyl rings, substituted heterocyclic rings, or unsubstituted heterocyclic rings each having 5, 6, 7, or 8 ring atoms.

3. The catalyst compound of paragraph 1, wherein R⁷ is represented by the formula:

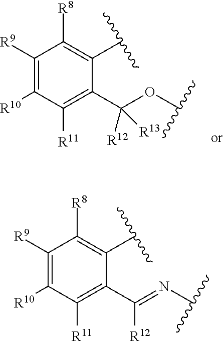

wherein:

each of R⁸, R⁹, R¹⁰, R¹¹, R¹², and R¹³ is independently hydrogen, hydrocarbyl, alkoxy, silyl, amino, aryloxy, substituted hydrocarbyl, halogen, phosphino, or one or more R⁸ and R⁹, R⁹ and R¹⁰, R¹⁰ and R¹¹, or R¹² and R¹³ are joined to form one or more substituted hydrocarbyl ring, unsubstituted hydrocarbyl rings, substituted heterocyclic rings, or unsubstituted heterocyclic rings each having 5, 6, 7, or 8 ring atoms.

4. The catalyst compound of any of paragraphs 1-3, wherein M is hafnium.
5. The catalyst compound of any of paragraphs 1-4, wherein R¹ is aryl.
6. The catalyst compound of paragraph 5, wherein R¹ is 2,6-disubstituted aryl.
7. The catalyst compound of paragraph 6, wherein R¹ is 2,6-diisopropylphenyl.
8. The catalyst compound of paragraph 6, wherein R¹ is 2,6-dimethylphenyl
9. The catalyst compound of any of paragraphs 1-8, wherein R⁴, R⁵, and R⁶ is hydrogen.
10. The catalyst compound of any of paragraphs 1-9, wherein R⁸, R⁹, R¹⁰, R¹¹, R¹² and R¹³ are independently hydrogen or C₁-C₁₀ alkyl.
11. The catalyst compound of paragraph 10, wherein R⁸, R⁹, R¹⁰, R¹¹, R¹² and R¹³ are hydrogen.
12. The catalyst compound of any of paragraphs 1-9, wherein R⁸ and R⁹ are joined to form substituted phenyl or unsubstituted phenyl.
13. The catalyst compound of paragraph 12, wherein R⁸ and R⁹ are joined to form unsubstituted phenyl.
14. The catalyst compound of any of paragraphs 1-13, wherein R² and R³ are independently hydrogen, hydrocarbyl, or R² and R³ are joined to form a substituted hydrocarbyl ring or unsubstituted hydrocarbyl ring having 5, 6, 7, or 8 ring atoms.
15. The catalyst compound of paragraph 14, wherein R² and R³ are phenyl.
16. The catalyst compound of paragraph 14, wherein R² and R³ are independently methyl or ethyl.
17. The catalyst compound of paragraph 14, wherein R² and R³ are joined to form substituted or unsubstituted hydrocarbyl containing ring having 4, 5, 6 or 7 ring atoms including Si, such as a substituted or unsubstituted hydrocarbyl containing ring having 5 ring atoms including Si.
18. The catalyst compound of any of paragraphs 1-17, wherein n is 2 and each X is independently chloro or hydrocarbyl.
19. The catalyst compound of any of paragraphs 1-18, wherein n is 2 and each Xis methyl.
20. The catalyst compound of any of paragraphs 1-19, wherein n is 2 and each X is benzyl.
21. The catalyst compound of paragraph 1, wherein the catalyst compound is selected from:

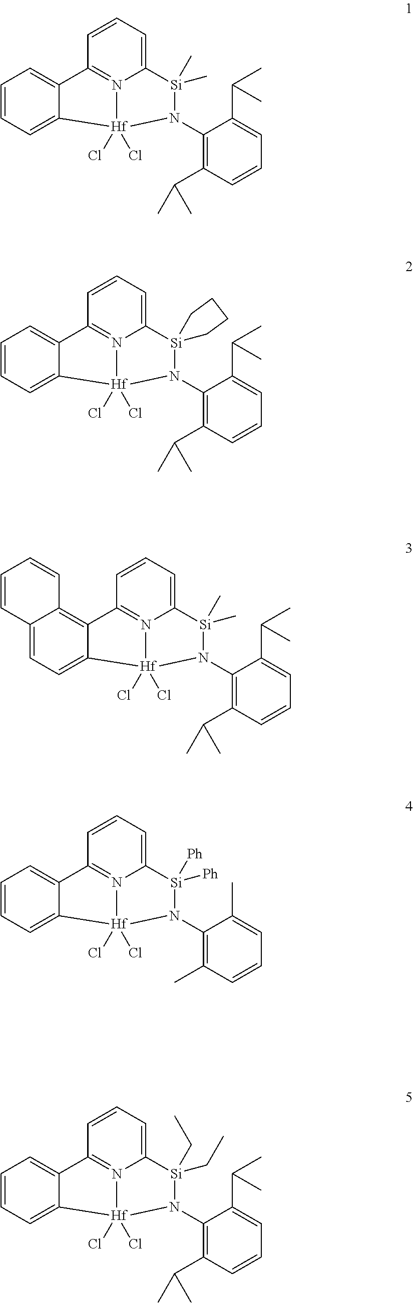

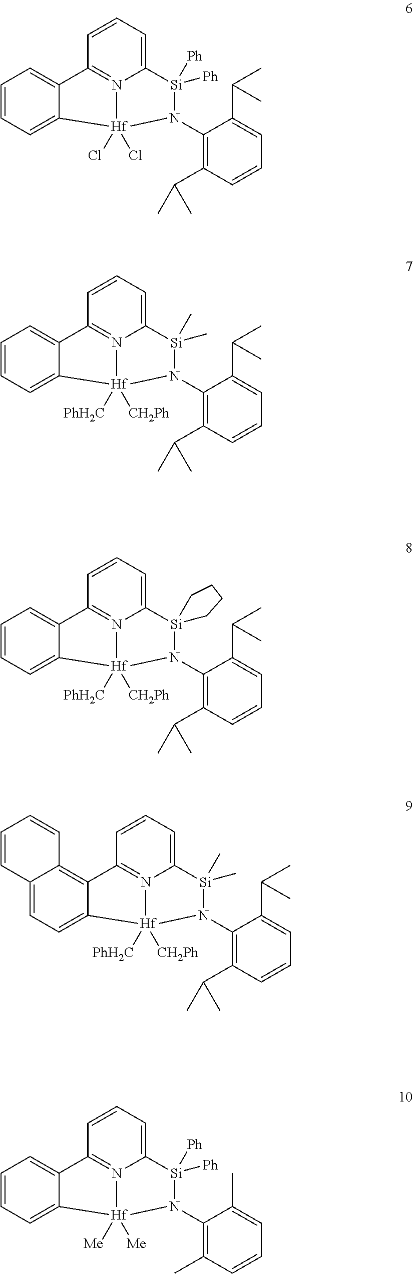

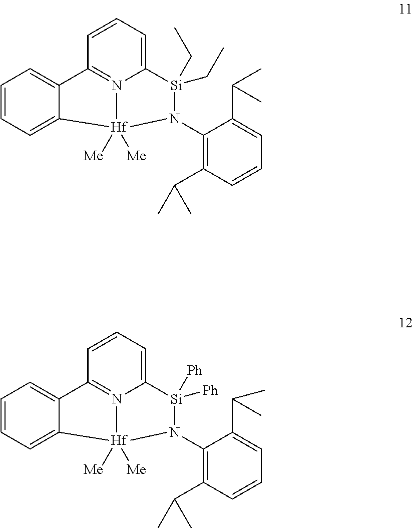

22. The catalyst compound of paragraph 17, wherein the catalyst compound is selected from:

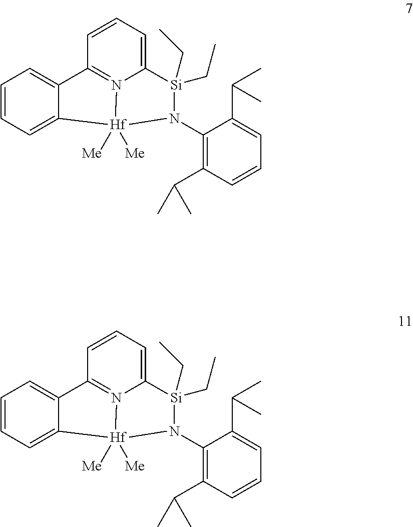

23. The catalyst compound of paragraph 2, wherein the catalyst compound is selected from:

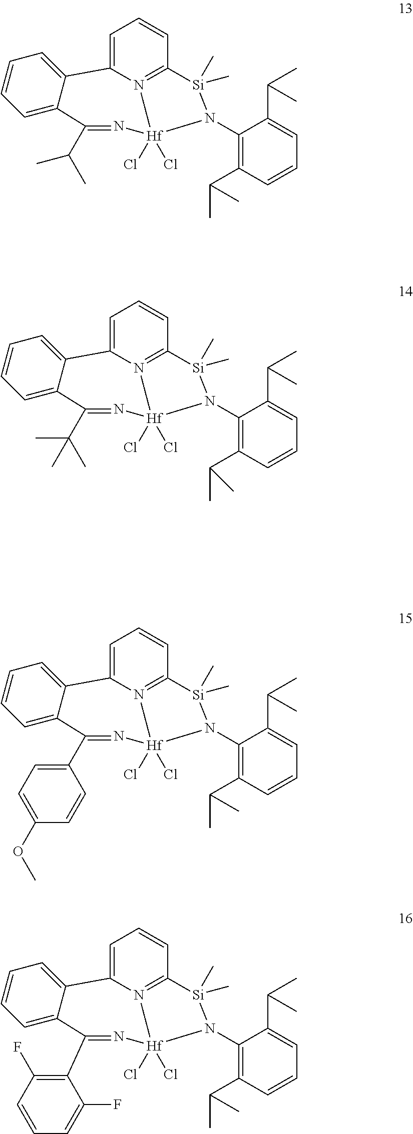

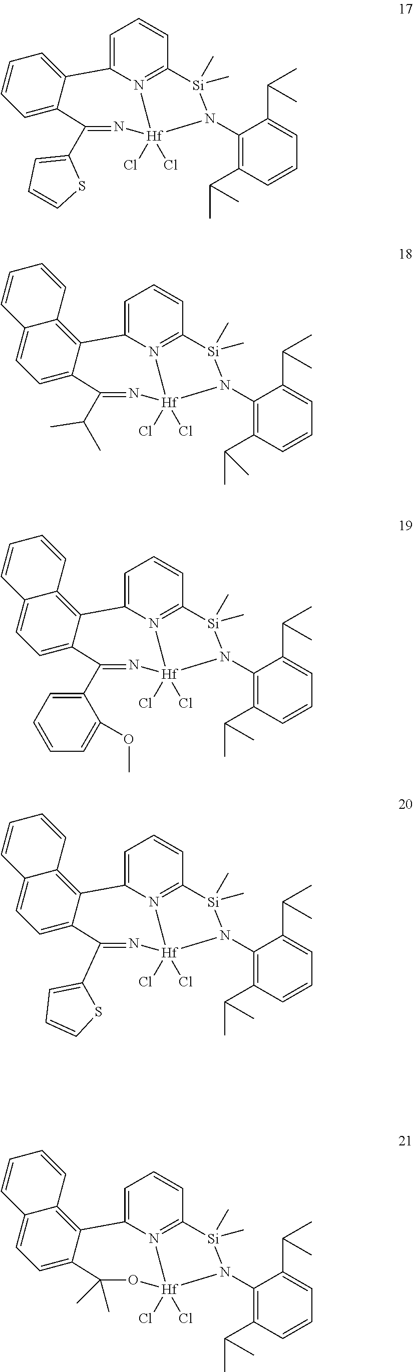

24. A catalyst system comprising an activator and the catalyst compound of any of paragraphs 1 to 23.
25. The catalyst system of paragraph 24, further comprising a support material.
26. The catalyst system of paragraph 25, wherein the support material is selected from Al₂O₃, ZrO₂, SiO₂, SiO₂/Al₂O₃, SiO₂/TiO₂, silica clay, silicon oxide/clay, or mixtures thereof.
27. The catalyst system of any of paragraphs 24 to 26, wherein the activator comprises an alkylalumoxane.
28. A process for the production of an ethylene alpha-olefin copolymer comprising: polymerizing ethylene and at least one C₃-C₂₀ alpha-olefin by contacting the ethylene and the at least one C₃-C₂₀ alpha-olefin with a catalyst system of any of paragraphs 24 to 27 in at least one gas phase reactor, slurry phase reactor, or solution phase reactor at a reactor pressure of from 0.7 to 150 bar and a reactor temperature of from 20° C. to 150° C. to form an ethylene alpha-olefin copolymer.
29. The process of paragraph 28, wherein the ethylene alpha-olefin copolymer has a comonomer content of 6 wt % or greater, an Mw value of from 50,000 to 1,000,000 g/mol, and Mn value of from 50,000 to 200,000 g/mol, and a PDI of from 1 to 5.
30. The process of paragraph 29, wherein the ethylene alpha-olefin copolymer has a melting point of 122° C. or greater.
31. The process of paragraph 30, wherein the catalyst system further comprises diethyl zinc.

### EXPERIMENTAL

All manipulations were performed under an inert atmosphere using glove box technique unless otherwise stated. Benzene-d₆ (Cambridge Isotopes or Sigma Aldrich) was degassed and dried over 3 Å molecular sieves prior to use. CDCl₃ (Deutero GmbH) was used as received. All anhydrous solvents were purchased from Fisher Chemical and were degassed and dried over molecular sieves prior to use. Deuterated solvents were purchased from Cambridge Isotope Laboratories and dried over molecular sieves prior to use. n-Butyl lithium (2.5 M solution in hexane) and tetramethyldichlorodisilane (Me₄Si₂Cl₂) were purchased from Sigma-Aldrich. Hafnium tetrachloride (HfCl₄) 99+% and trimethylsilylmethyltrifluoromethanesulfonate were purchased from Strem Chemicals and TCI America, respectively, and used as received. Potassium cyclopentadienide (KCp) was prepared according to the procedure described in Stadelhofer, J. et al. (1975) Jrnl. Organomet. Chem., v. 84(1), pp. C1-C4. The ¹H NMR measurements were obtained as described above.

All ¹H NMR data were collected on a Bruker AVANCE III 400 MHz spectrometer running Topspin™ 3.0 software at room temperature (RT) using a deuterated solvent for all materials.

C8 wt % is determined by ¹H NMR.

All molecular weights are reported in g/mol unless otherwise noted.

Slurry and solvent liquid ratios are given as weight ratios relative to the starting silica material, e.g., raw silica or silica supported MAO and/or catalyst. For example, if it is stated “the silica was slurried in 5× toluene,” it means that the silica was slurried in 5 g of toluene for every 1 g of silica.

### Ligands (Scheme 3)

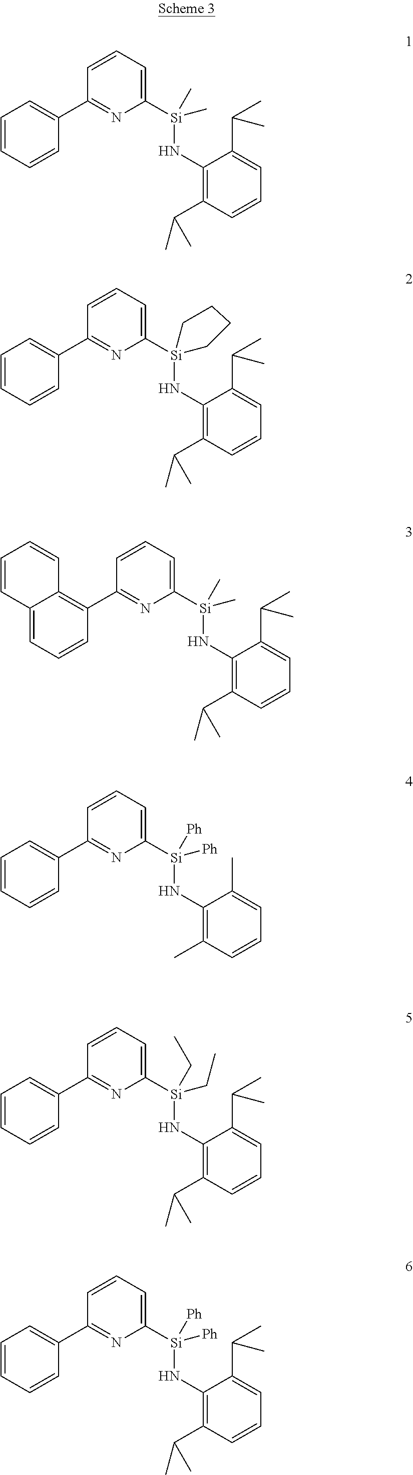 [SMILES: CC(C)c1cccc(C(C)C)c1N[Si](C)(C)c1cccc(-c2ccccc2)n1 ; CC(C)c1cccc(C(C)C)c1N[Si]1(c2cccc(-c3ccccc3)n2)CCCC1 ; CC(C)c1cccc(C(C)C)c1N[Si](C)(C)c1cccc(-c2cccc3ccccc23)n1 ; Cc1cccc(C)c1N[Si](c1ccccc1)(c1ccccc1)c1cccc(-c2ccccc2)n1 ; CC[Si](CC)(Nc1c(C(C)C)cccc1C(C)C)c1cccc(-c2ccccc2)n1 ; CC(C)c1cccc(C(C)C)c1N[Si](c1ccccc1)(c1ccccc1)c1cccc(-c2ccccc2)n1]

### Synthesis of 2-bromo-6-phenylpyridine (Method 1)

Butyllithium (50 mL, 49.2 mmol), hexanes (100 mL) and 2-(dimethylamino)ethanol (5.91 mL, 59.0 mmol) were combined and cooled to −10° C. 2-Phenylpyridine (7.63 g, 49.2 mmol) was added dropwise over 5 minutes to form a clear orange solution. After 1 hour, the solution had darkened to red-orange. The solution was then cooled to −40° C. and THF (500 mL) that had been cooled to −35° C. was added. Immediately 1,2-dibromoethane (25.4 mL, 295 mmol) was added in one portion. Allowed to warm to ambient temperature. The volatiles were removed by evaporation and the yellow oily paste was dissolved in Et₂O (125 mL) and water (100 mL). The aqueous layer was removed and the organics were dried over brine, then sodium sulfate. Evaporation of the ether afforded crude product that was crystallized from hexanes as yellow crystals (8.0 g, 69%).

### Synthesis of 2-bromo-6-phenylpyridine (Method 2)

A hexane solution of n-butyllithium (225 mL, 560 mmoles) was added dropwise to a mixture of 2-(dimethylamino)ethanol (25 g, 280 mmol) and hexane (350 mL) at 0° C. The resulting mixture was stirred for 30 minutes, then a solution of 2-phenylpyridine (14.5 g, 93 mmoles) in hexane (170 mL) was added dropwise. This mixture was stirred for 1 hour at 0° C., then cooled to −78° C. A solution of 1,2-dibromo-1,1,2,2-tetrafluoroethane (85 g, 327 mmoles) in hexane (170 mL) was then added. The obtained mixture was stirred for 1 hour, then the temperature was allowed to rise to room temperature. Water (200 ml) was added at 0° C. The organic layer was extracted with diethyl ether (2×100 mL), the organics were dried over Na₂SO₄ and evaporated under vacuum. Crude product was purified by flash chromatography on silica gel 60 (40-63 um; eluent: hexane-ethyl acetate) and then recrystallized from hexane to give yellow crystals of pure 2-bromo-6-phenylpyridine (37 g, 85%). ¹H NMR (CDCl₃), δ: 7.32 (d, J=7.6 Hz, 1H), 7.36-7.48 (m, 4H), 7.57 (t, J=7.6 Hz, 1H), 7.95 (br.d, J=8 Hz, 2H). ¹³C{¹H} NMR (CDCl₃), δ: 123.8, 125.8, 128.1, 129.0, 130.0, 134.4, 136.4, 139.3, 158.8. Anal. Calcd. for C₁₁H₈BrN: C, 56.44; H, 3.44; N, 5.98. Found: C, 56.19; H, 3.60; N, 6.14.

### Synthesis of 2-bromo-6-(naphthalen-1-yl)pyridine

Pd(PPh₃)₄ (3.9 g, 3.4 mmol) was added to a degassed solution of 2,6-dibromopyridine (10 g, 42 mmol) in 1,4-dioxane (60 mL). This mixture was stirred for 10 minutes at room temperature, then 2 M aqueous Cs₂CO₃ (21 mL, 42 mmol) and 1-naphthylboronic acid pinacol ester (10.7 g, 42 mmol) were added. The reaction mixture was heated to reflux for 24 hours and then evaporated to dryness under vacuum. The crude product was purified by flash chromatography on silica gel 60 (40-63 um; eluent: dichloromethane-hexane) to give the product as a colorless viscous oil (7.0 g, 58%). ¹H NMR (DMSO-d₆), δ: 8.06-8.00 (m, 3H), 7.93 (t, J=8.0 Hz, 1H), 7.73 (d, J=8.0 Hz, 1H), 7.72 (d, J=8.0 Hz, 1H), 7.63-7.62 (m, 2H), 7.58-7.53 (m, 2H). Anal. Calcd. for C₁₅H₁₀BrN: C, 63.40; H, 3.55; N, 4.93. Found: C, 63.80; H, 3.76; N, 4.65.

### Synthesis of 2-(chlorodimethylsilyl)-6-phenylpyridine

Tetrahydrofuran (35 mL) was added to 2-bromo-6-phenylpyridine (1.85 g, 7.91 mmol) to form a solution. At −80° C., a hexane solution of BuLi (3.35 mL, 7.91 mmol) was added dropwise to form a clear orange solution. After 20 minutes, Me₂SiCl₂ (4.08 g, 31.6 mmol) that was cooled to −80° C. was added in one portion. The solution was warmed to ambient temperature and the volatiles were removed under reduced pressure to afford an off-white solid. The solid was extracted into Et₂O (15 mL) and filtered. Removal of volatiles afforded 2-(chlorodimethylsilyl)-6-phenylpyridine as a white crystalline solid of suitable purity (1.90 g, 97%). ¹H NMR (benzene-d₆), δ: 8.05 (m, 2H), 7.53 (m, 1H), 7.26 (m, 3H), 7.19 (m, 1H), 7.11 (m, 1H), 0.64 (s, 6H).

### General Synthetic Procedure for 2-(chlorodialkylsilyl)-6-arylpyridines and 2 (chlorodiarylsilyl)-6-arylpyridines

These complexes were prepared and isolated analogously to 2-(chlorodimethylsilyl)-6-phenylpyridine using the appropriate dichlorodialkylsilyl or dichlorodiarylsilyl reagents in place of the dichlorodimethylsilane. Characterization data is presented for the individual complexes below.

### 2-(chlorodiethylsilyl)-6-phenylpyridine

Yield: 98% (colorless oil). ¹H NMR

(CDCl₃), δ: 8.06 (m, 2H), 7.72 (m, 3H), 7.48 (m, 2H), 7.42 (m, 1H), 1.17 (m, 4H), 1.09 (m, 6H).

### 2-(1-chlorosilolan-1-yl)-6-phenylpyridine

Yield: 80% (colorless oil). ¹H NMR (CDCl₃), δ: 8.06 (m, 2H), 7.74 (m, 3H), 7.48 (m, 2H), 7.42 (m, 1H), 1.91 (m, 4H), 1.31 (m, 2H), 1.08 (m, 2H).

### (2-chlorodiphenylsilyl)-6-phenylpyridine

Yield: 87% (white solid). ¹H NMR (benzene-d₆), δ: 8.02 (m, 2H), 7.98 (m, 4H), 7.73 (m, 1H), 7.26 (m, 1H), 7.19 (m, 2H), 7.12 (s, 8H).

### (2-chlorodimethylsilyl)-6-(1-naphthyl)pyridine

Yield: 98% (colorless oil). ¹H NMR (CDCl₃), δ: 7.63 (m, 1H), 7.36 (m, 2H), 7.24 (m, 1H), 7.06 (m, 1H), 7.00 (m, 2H), 6.93 (m, 3H), 0.19 (s, 6H).

### Synthesis of N-(2,6-diisopropylphenyl)-1,1-dimethyl-1-(6-phenylpyridin-2-yl)silanamine (Scheme 3, Ligand 1)

Benzene (4 mL) was added to a mixture of 2-(chlorodimethylsilyl)-6-phenylpyridine (0.245 g, 0.989 mmol) and LiNH(2,6-diisopropylbenzene) (0.181 g, 0.989 mmol) (previously prepared by reaction of 2,6-diisopropylaniline with one equivalent of butyllithium in hexane). To the stirred slurry was added a little tetrahydrofuran (10 drops). After about 1 hour the volatiles were removed and the oily residue was dissolved in benzene (2 mL). The extract was filtered and then evaporated to give pyridylamine 1 as an oil (0.358 g, 87%). ¹H NMR (CDCl₃), δ: 8.23 (m, 2H), 7.39-7.46 (m, 3H), 7.19-7.35 (m, 6H), 3.87 (s, 1H), 3.76 (sept, J=6.7 Hz, 2H), 1.30 (d, J=6.7 Hz, 12H), 0.59 (s, 6H).

### General Synthesis of Ligands 2-6

Ligands 2-6 were prepared and isolated analogously to ligand 1 using the appropriate lithium amide and 2-(chlorodialkylsilyl)-6-arylpyridine or 2-(chlorodiarylsilyl)-6-arylpyridine and lithium reactants. Characterization data for each of the individual ligands is given below.

### N-(2,6-Diisopropylphenyl)-1-(6-phenylpyridin-2-yl)silolan-1-amine (Scheme 3, Ligand 2)

Yield: 82%. ¹H NMR (benzene-d₆), δ: 8.09 (m, 2H), 7.28 (m, 4H), 7.09-7.20 (m, 5H), 3.87 (s, 1H), 3.64 (sept, J=6.9 Hz, 2H), 1.20 (d, J=6.9 Hz, 12H), 1.75 (m, 4H), 0.95-1.28 (m, 4H).

### N-(2,6-Diisopropylphenyl)-1,1-dimethyl-1-(6-(naphthalen-1-yl)pyridin-2-yl)silanamine (Scheme 3, Ligand 3)

Yield: 89%. ¹H NMR (benzene-d₆), δ: 8.27 (m, 1H), 7.69 (m, 2H), 7.58 (m, 1H), 7.04-7.35 (m, 9H), 3.90 (s, 1H), 3.58 (sept, J=6.7 Hz, 2H), 1.10 (d, J=6.7 Hz, 12H), 0.47 (s, 6H).

### N-(2,6-Dimethylphenyl)-1,1-diphenyl-1-(6-phenylpyridin-2-yl)silanamine (Scheme 3, Ligand 4)

Yield: 85%. ¹H NMR (benzene-d₆), δ: 8.04 (m, 2H), 7.88 (m, 4H), 7.22-7.29 (m, 5H), 7.14 (m, 6H), 7.01 (m, 1H), 6.93 (m, 2H), 6.79 (m, 1H), 5.28 (s, 1H), 2.29 (s, 6H).

### N-(2,6-Diisopropylphenyl)-1,1-diethyl-1-(6-phenylpyridin-2-yl)silanamine (Scheme 3, Ligand 5)

Yield: 89%. ¹H NMR (benzene-d₆), δ: 8.10 (m, 2H), 7.05-7.33 (m, 9H), 4.23 (s, 1H), 3.65 (sept, J=6.9 Hz, 2H), 1.20 (d, J=6.9 Hz, 12H), 0.94-1.16 (m, 10H).

### N-(2,6-Diisopropylphenyl)-1,1-diphenyl-1-(6-phenylpyridin-2-yl)silanamine (Scheme 3, Ligand 6)

Yield: 78%. ¹H NMR (benzene-d₆), δ: 8.03 (m, 2H), 7.79 (m, 4H), 7.00-7.29 (m, 15H), 5.30 (s, 1H), 3.74 (sept, J=6.7 Hz, 2H), 1.02 (d, J=6.7 Hz, 12H).

### Synthesis of Pyridylamide-Transition Metal Complexes Illustrated in Table 1

### General Preparation of Metal Dichloride Complexes

The group 4 dichloride complexes may be prepared by reaction of the diamine ligands (e.g. ligands 1 to 6) with approximately one molar equivalent of metal(amido)₂Cl₂ or metal(alkyl)₂Cl₂ reagents (e.g. HfBn₂Cl₂(OEt₂)₂, Hf(NMe₂)₂Cl₂(dme), ZrBn₂Cl₂(OEt₂), or Zr(NMe₂)₂Cl₂(dme). Specific examples are given below (dme=dimethyoxyethane).

### Preparation of Dichloride Complex 1

To a solution of (2,6-diisopropylphenyl)[dimethyl(6-phenylpyridin-2-yl)silyl]amine (ligand 1) (1.00 g, 2.57 mmol) in 80 mL of benzene HfCl₂Bn₂(Et₂O) (1.3 g, 2.57 mmol) was added in one portion. The formed solution was stirred for 2 days in a pressure bottle at 80° C. The mixture was evaporated to dryness and the residue was washed with hot hexane (30 mL). The obtained solid was re-crystallized from a 90:10 mixture of toluene and hexane giving 1.16 g (71%) of complex 1 as a yellowish crystalline solid. ¹H NMR (400 MHz, CD₂Cl₂): δ 8.17 (m, 1H), 7.97-8.06 (m, 2H), 7.90 (m, 1H), 7.63 (m, 1H), 7.39 (m, 2H), 7.07-7.16 (m, 3H), 3.38 (m, 2H), 1.25 (d, J=6.9 Hz, 6H), 1.15 (d, J=6.7 Hz, 6H), 0.39 (s, 6H). ¹³C{¹H} NMR (101 MHz, CD₂Cl₂): 199.7, 170.3, 164.0, 146.2, 144.5, 144.1, 143.5, 141.2, 138.2, 131.1, 130.3, 128.7, 128.0, 124.8, 124.2, 123.7, 199.2, 28.8, 26.1, 24.4, −0.14.

### Preparation of Dichloride Complex 3

To a solution of N-(2,6-diisopropylphenyl)-1,1-dimethyl-1-(6-(naphthalen-1-yl)pyridin-2-yl)silanamine (ligand 3) (1.00 g, 2.28 mmol) in 80 mL of benzene HfCl₂Bn₂(Et₂O) (1.15 g, 2.28 mmol) was added in one portion. The formed solution was stirred for 2 days in a pressure bottle at 80° C. Then the mixture was evaporated to dryness and the residue was washed with hot hexane (30 mL). The obtained solid was re-crystallized from a 90:10 mixture of toluene and hexane giving 960 mg (62%) of complex 3 as a yellow crystalline solid. ¹H NMR (400 MHz, CD₂Cl₂): δ 8.58 (d, J=8.5 Hz, 1H), 8.34 (d, J=7.9 Hz, 2H), 8.05 (dd, J₁=8.3 Hz, J₂=7.3 Hz, 1H), 7.91 (m, 1H), 7.81 (m, 1H), 7.64 (m, 1H), 7.62 (m, 1H), 7.55 (m, 1H), 7.20 (m, 2H), 7.13 (m, 1H), 3.44 (m, 2H), 1.32 (d, J=6.9 Hz, 6H), 1.18 (d, J=6.9 Hz, 6H), 0.46 (s, 6H). ¹³C{¹H} NMR (101 MHz, CD₂Cl₂): 205.5, 171.6, 164.9, 144.9, 143.8, 143.2, 140.3, 138.8, 136.1, 130.1, 129.73, 129.70, 129.4, 128.6, 127.6, 127.3, 126.7, 124.9, 124.6, 124.3, 124.2, 28.9, 26.0, 24.5, −0.34.

### Dichloride of Dichloride Complex 4

Prepared and isolated analogously to dichloride complex 5. Yield: 84% (white solid). ¹H NMR (CD₂Cl₂), δ: 8.22 (m, 1H), 8.09-8.15 (m, 2H), 7.96 (m, 1H), 7.67 (m, 1H), 7.43 (m, 8H), 7.31 (m, 4H), 6.89-6.97 (m, 3H), 1.89 (s, 6H). Anal. Calcd. for C₃₁H₂₆Cl₂HfN₂Si: C, 52.89; H, 3.72; N, 3.98. Found: C, 53.06; H, 3.63; N, 3.80.

### Preparation of Dichloride Complex 5

HfBn₂Cl₂(Et₂O)₂ (0.255 g, 0.439 mmol) was added to a solution of N-(2,6-diisopropylphenyl)-1,1-diethyl-1-(6-phenylpyridin-2-yl)silanamine (ligand 5) (0.183 g, 0.439 mmol) in benzene (4 mL). The obtained mixture was stirred for 12 hours at 80° C. in the dark, then cooled to ambient temperature and evaporated to dryness in vacuum. The residue was washed with hexane and then re-crystallized from toluene-hexane to give the complex 5 of suitable purity. Yield: 68% (brownish solid). ¹H NMR (CD₂Cl₂), δ: 8.17 (m, 1H), 8.01 (m, 2H), 7.90 (m, 1H), 7.39 (m, 2H), 7.07-7.16 (m, 4H), 3.40 (m, 2H), 1.25 (d, J=6.7 Hz, 6H), 1.18 (d, J=6.9 Hz, 6H), 0.89 (m, 10H). Anal. Calcd. for C₂₇H₃₄Cl₂HfN₂Si: C, 48.83; H, 5.16; N, 4.22. Found: C, 49.02; H, 5.39; N, 4.01.

### Preparation of Dichloride Complex 6

Prepared and isolated analogously to dichloride complex 5. Yield: 57% (brownish solid). ¹H NMR (CD₂Cl₂), δ: 8.21 (m, 1H), 8.09-8.11 (m, 2H), 7.96 (m, 1H), 7.63 (m, 1H), 7.43 (m, 8H), 7.29 (m, 4H), 7.00-7.03 (m, 3H), 3.18 (m, 2H), 1.16 (d, J=6.9 Hz, 6H), 0.25 (d, J=6.7 Hz, 6H). Anal. Calcd. for C₃₅H₃₄Cl₂HfN₂Si: C, 55.30; H, 4.51; N, 3.69. Found: C, 55.57; H, 3.69; N, 3.44.

### Synthesis of Catalyst Complex 7

Benzene (4 mL) was added to ligand 1 (0.184 g, 0.439 mmol) to form a solution. Solid tetrabenzylhafnium (0.239 g, 0.439 mmol) was then added and the mixture was heated to 70° C. in the dark. After 1 hour the volatiles were removed and the product was crystallized from a mixture of toluene-hexane to yield orange crystals of complex 7 (0.189 g, 58%). ¹H NMR (benzene-d₆), δ: 8.11 (m, 1H), 7.38 (m, 1H), 7.29 (m, 1H), 7.15 (m, 2H), 7.10 (m, 3H), 6.95 (m, 5H), 6.79 (m, 1H), 6.74 (m, 2H), 6.64 (m, 4H), 3.60 (m, 2H), 2.43 (d, J=11.7 Hz, 2H) 2.05 (d, J=11.7 Hz, 2H), 1.26 (d, J=6.7 Hz, 6H), 1.09 (d, J=6.7 Hz, 6H), 0.28 (s, 6H). Anal. Calcd. for C₃₉H₄₄HfN₂Si: C, 62.68; H, 5.93; N, 3.75. Found: C, 62.75; H, 6.01; N, 3.68.

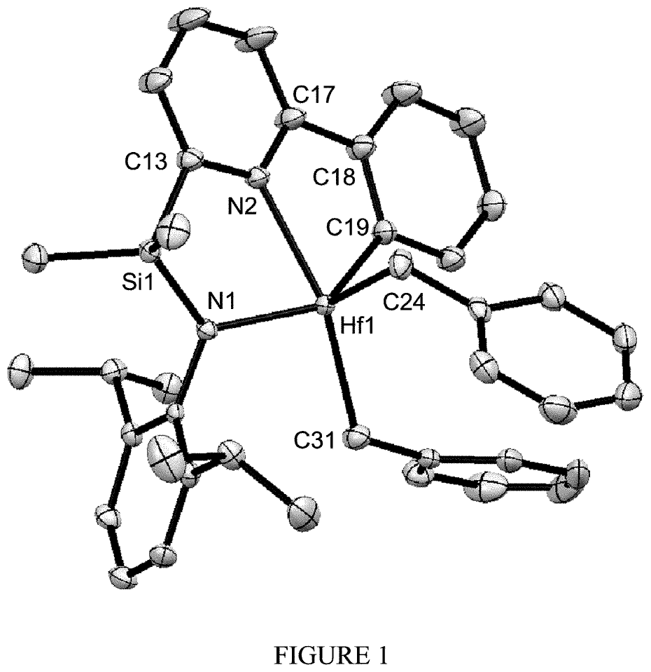

FIG. 1 shows the molecular structure (determined by X-ray diffraction) of complex 7 drawn with 50% thermal ellipsoids. Selected bond lengths (Å) and angles (deg): Hf1-N1 2.095(2), Hf1-N2 2.333(2), Hf1-C19 2.294(2), Hf1-C24 2.222(2), Hf1-C31 2.253(2), Si1-N1 1.729(2), Si1-C13 1.888(2), N2-C13 1.365(3), N2-C17 1.359(3), C17-C18 1.476(3), C18-C19 1.411(3), N1-Hf1-N2 77.17(6), N1-Hf1-C19 138.95(7), N1-Hf1-C24 105.17(8), N1-Hf1-C31 97.03(7), C19-Hf1N2 70.71(7), C24-Hf1-N2 94.26(8), C24-Hf1-C19 102.12(9), C24-Hf1-C31 110.33(9), C31-Hf1-N2 155.36(8), C31-Hf1-C19 101.56(8). Crystal data for C₃₉H₄₄HfN₂Si: space group P2₁/n (#14), with a=17.8250(9) Å, b=11.1737(6) Å, c=18.7813(9) Å, □=115.091(1)°, V=3387.7(3) Å³, d_{calcd}=1.465, and Z=4.

### Synthesis of Catalyst Complex 8

This complex was prepared and isolated analogously to complex 7. Yield: 44%. ¹H NMR (benzene-d₆), δ: 8.11 (m, 1H), 7.45 (m, 1H), 7.31 (m, 1H), 7.10-7.19 (m, 5H), 6.93 (m, 5H), 6.81 (m, 1H), 6.71 (m, 4H), 6.68 (m, 2H), 3.62 (m, 2H), 2.66 (d, J=11.9 Hz, 2H) 2.36 (d, J=11.9 Hz, 2H), 1.53 (m, 4H), 1.26 (d, J=6.9 Hz, 6H), 1.15 (d, J=6.7 Hz, 6H), 0.85 (m, 2H), 0.63 (m, 2H). Anal. Calcd. for C₄₁H₄₆HfN₂Si: C, 63.67; H, 6.00; N, 3.62. Found: C, 63.85; H, 6.18; N, 3.48.

### Synthesis of Catalyst Complex 9

This complex was prepared and isolated analogously to complex 7. Yield: 48%. ¹H NMR (benzene-d₆), δ: 8.21 (m, 1H), 8.17 (m, 1H), 7.64 (m, 1H), 7.61 (m, 1H), 7.28 (m, 1H), 7.25 (m, 1H), 7.17 (m, 2H), 7.10 (m, 1H), 6.97 (m, 1H), 6.91 (m, 4H), 6.80 (m, 1H), 6.66 (m, 6H), 3.68 (m, 2H), 2.44 (d, J=11.9 Hz, 2H) 2.25 (d, J=11.9 Hz, 2H), 1.25 (d, J=6.7 Hz, 6H), 1.11 (d, J=6.9 Hz, 6H), 0.30 (s, 6H). Anal. Calcd. for C₄₃H₄₆HfN₂Si: C, 64.77; H, 5.81; N, 3.51. Found: C, 64.92; H, 6.06; N, 3.40.

TABLE 1

| | |
|---|---|
| 1 | 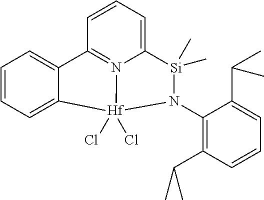 |
| 2 | 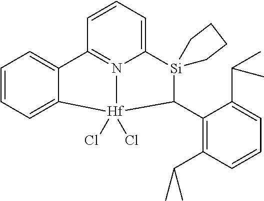 |
| 3 | 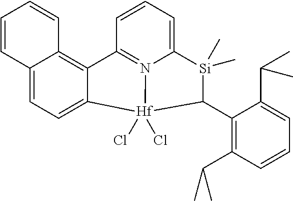 |
| 4 | 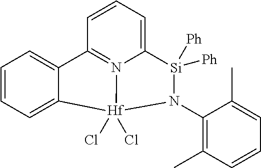 |
| 5 | 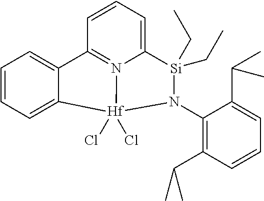 |
| 6 | 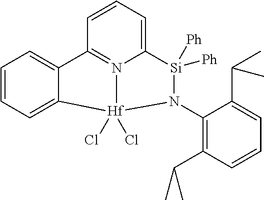 |
| 7 | 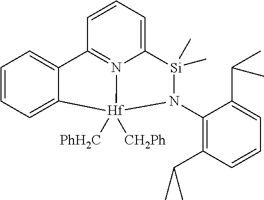 |
| 8 | 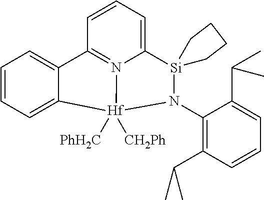 |
| 9 | 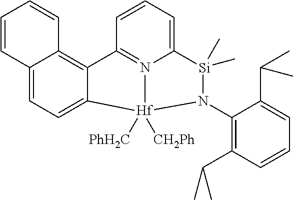 |
| 10 | 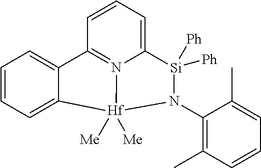 |
| 11 | 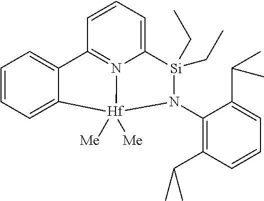 |
| 12 | 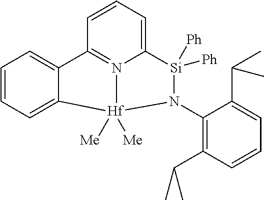 |

Reaction of Dichloride Complexes with Unsaturated Organics.

The metal-carbon bond of the aforementioned metal dichloride complexes is susceptible to reaction with a variety of electrophilic molecules, such as nitriles and ketones. Examples of the products formed by these types of reactions are shown in Table 2.

TABLE 2

| | |
|---|---|
| 13 | 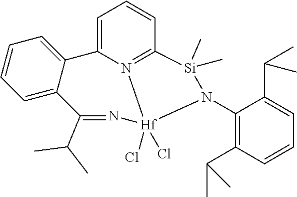 |
| 14 | 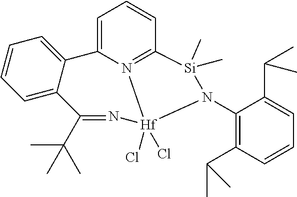 |
| 15 | 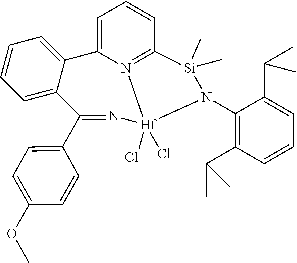 |
| 16 | 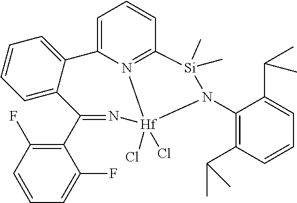 |
| 17 | 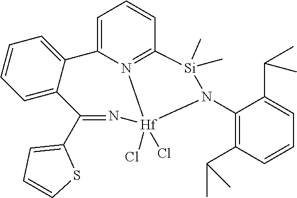 |
| 18 | 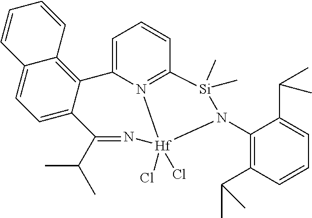 |
| 19 | 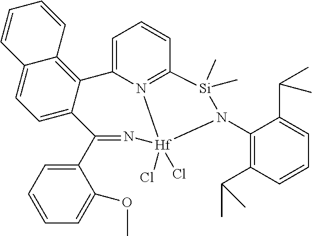 |
| 20 | 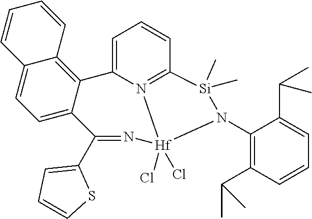 |
| 21 | 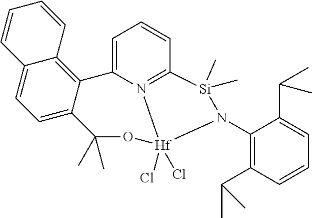 |
| 22 | 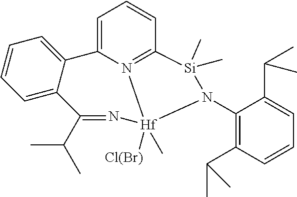 |
| 23 | 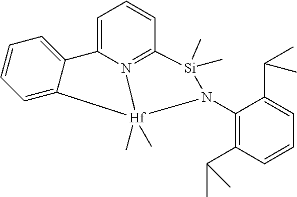 |

### Preparation of Complex 13

A mixture of 100 mg (0.157 mmol) of complex 1 and 11 mg (0.157 mmol) of isobutyronitrile in 5 mL of dichloromethane was stirred for 5 min at room temperature. Further on, this mixture was evaporated to dryness; the residue was washed with 2×5 mL of hexane and then dried in vacuum. This procedure gave 101 mg (91%) of the addition product as a yellow solid. ¹H NMR (400 MHz, CD₂Cl₂): δ 8.00 (m, 1H), 7.70 (m, 1H), 7.48-7.55 (m, 5H), 7.11-7.20 (m, 3H), 3.78 (m, 1H), 3.65 (m, 1H), 3.03 (m, 1H), 1.42 (d, J=6.7 Hz, 3H), 1.31 (d, J=6.8 Hz, 3H), 1.25-1.27 (m, 6H), 1.08 (d, J=6.4 Hz, 3H), 0.65 (d, J=7.1 Hz, 3H), 0.42 (s, 3H), 0.35 (s, 3H). ¹³C{¹H} NMR (101 MHz, CD₂Cl₂): δ 182.0, 167.4, 158.7, 147.4, 145.3, 145.1, 141.8, 138.4, 136.3, 132.3, 129.7, 129.3, 128.7, 125.3, 124.6, 124.4, 123.7, 37.7, 28.0, 27.8, 26.7, 26.6, 24.9, 24.8, 19.8, 18.9, 1.1, 0.8.

### Preparation of Complex 14

A mixture of 100 mg (0.157 mmol) of complex 1 and 13 mg (0.157 mmol) of trimethylacetonitrile in 5 mL of dichloromethane was stirred for 5 min at room temperature. Further on, this mixture was evaporated to dryness; the residue was washed with 2×5 mL of hexane and then dried in vacuum. This procedure gave 98 mg (87%) of the addition product as a yellow solid. ¹H NMR (400 MHz, CD₂Cl₂): δ 8.01 (m, 1H), 7.67 (m, 1H), 7.61 (m, 1H), 7.51 (m, 1H), 7.43-7.46 (m, 3H), 7.12-7.18 (m, 3H), 3.81 (m, 1H), 3.64 (m, 1H), 1.41 (d, J=6.7 Hz, 3H), 1.24-1.29 (m, 12H), 0.99 (s, 9H), 0.4 (s, 3H), 0.34 (s, 3H). ¹³C{¹H} NMR (101 MHz, CD₂Cl₂): δ 183.8, 167.8, 159.2, 146.8, 145.4, 145.2, 141.8, 138.6, 135.7, 132.0, 129.1, 128.7, 127.9, 125.3, 124.7, 124.4, 124.1, 42.8, 28.2, 27.9, 27.8, 27.6, 26.8, 26.4, 25.0, 24.7, 1.3, 0.9.

### Preparation of Complex 15

A mixture of 100 mg (0.157 mmol) of complex 1 and 21 mg (0.157 mmol) of p-methoxybenzonitrile in 5 mL of dichloromethane was stirred for 5 min at room temperature. Further on, this mixture was evaporated to dryness; the residue was washed with 2×5 mL of hexane and then dried in vacuum. This procedure gave 114 rag (94%) of the addition product as a yellow solid. ¹H NMR (400 MHz, CD₂Cl₂): δ 8.01 (m, 1H), 7.67-7.72 (m, 4H), 7.47-7.62 (m, 4H), 7.16-7.28 (m, 3H), 6.89 (m, 2H), 3.86 (s, 3H), 3.80 (m, 1H), 3.72 (m, 1H), 1.61 (d, J=6.7 Hz, 3H), 1.38 (d, J=6.7 Hz, 3H), 1.29-1.30 (m, 6H), 0.47 (s, 3H), 0.34 (s, 3H). ¹³C{¹H} NMR (101 MHz, CD₂Cl₂): δ 171.6, 167.4, 162.9, 158.8, 145.2, 145.1, 144.8, 142.1, 138.5, 137.5, 132.9, 132.0, 131.2, 129.5, 129.1, 128.91, 128.86, 126.4, 125.3, 124.6, 124.5, 113.9, 55.9, 28.1, 27.9, 26.9, 26.5, 25.1, 24.7, 1.76, 0.51.

### Preparation of Complex 16

A mixture of 100 mg (0.157 mmol) of complex 1 and 22 mg (0.157 mmol) of 2,6-difluorobenzonitrile in 5 mL of dichloromethane was stirred for 5 minutes at room temperature. Further on, this mixture was evaporated to dryness; the residue was washed with 2×5 mL of hexane and then dried in vacuum. This procedure gave 113 mg (93%) of the addition product as a yellow solid. ¹H NMR (400 MHz, CD₂Cl₂): δ 8.04 (m, 1H), 7.73 (m, 1H), 7.63 (m, 1H), 7.51-7.58 (m, 2H), 7.44 (m, 1H), 7.29-7.33 (m, 2H), 7.14-7.19 (m, 3H), 6.87 (m, 2H), 3.68 (m, 1H), 3.56 (m, 1H), 1.35 (d, J=6.7 Hz, 3H), 1.26-1.29 (m, 6H), 1.15 (d, J=6.7 Hz, 3H), 0.48 (s, 3H), 0.33 (s, 3H).

### Preparation of Complex 17

A mixture of 100 mg (0.157 mmol) of complex 1 and 17 mg (0.157 mmol) of thiophen-2-carbonitrile in 5 mL of dichloromethane was stirred for 5 minutes at room temperature. Further on, this mixture was evaporated to dryness; the residue was washed with 2×5 mL of hexane and then dried in vacuum. This procedure gave 106 mg (91%) of the addition product as a yellow solid. ¹H NMR (400 MHz, CD₂Cl₂): δ 7.98 (t, J=7.8 Hz, 1H), 7.49-7.69 (m, 8H), 7.11-7.21 (m, 3H), 7.02 (m, 1H), 3.80 (m, 1H), 3.65 (m, 1H), 1.56 (d, J=6.7 Hz, 3H), 1.31 (d, J=6.7 Hz, 3H), 1.28 (d, J=6.9 Hz, 3H), 1.26 (d, J=6.7 Hz, 3H), 0.42 (s, 3H), 0.31 (s, 3H).

### Preparation of Complex 18

A mixture of 108 mg (0.157 mmol) of complex 3 and 11 mg (0.157 mmol) of isobutyronitrile in 5 mL of dichloromethane was stirred for 5 minutes at room temperature. Further on, this mixture was evaporated to dryness; the residue was washed with 2×5 mL of hexane and then dried in vacuum. This procedure gave 101 mg (85%) of the addition product as a yellow solid. ¹H NMR (400 MHz, CD₂Cl₂): δ 7.93-7.99 (m, 3H), 7.75 (m, 1H), 7.47-7.62 (m, 5H), 7.11-7.20 (m, 3H), 3.79 (m, 1H), 3.69 (m, 1H), 3.10 (m, 1H), 1.43 (d, J=6.5 Hz, 3H), 1.25-1.29 (m, 9H), 1.08 (d, J=6.5 Hz, 3H), 0.65 (d, J=7.3 Hz, 3H), 0.47 (s, 3H), 0.39 (s, 3H). ¹³C{¹H} NMR (101 MHz, CD₂Cl₂): δ 182.2, 167.6, 156.1, 147.4, 145.5, 145.2, 141.5, 137.3, 133.5, 133.1, 132.2, 131.4, 130.2, 129.0, 128.8, 127.7, 127.2, 127.0, 125.4, 124.7, 124.5, 121.3, 37.5, 28.0, 27.8, 26.7, 26.6, 25.0, 24.9, 19.7, 18.9, 1.53, 0.46.

### Preparation of Complex 19

A mixture of 108 mg (0.157 mmol) of complex 3 and 21 mg (0.157 mmol) of 2-methoxybenzonitrile in 5 mL of dichloromethane was stirred for 5 minutes at room temperature. Further on, this mixture was evaporated to dryness; the residue was washed with 2×5 mL of hexane and then dried in vacuum. This procedure gave 119 mg (92%) of the addition product as a yellow solid. ¹H NMR (400 MHz, CD₂Cl₂): δ 8.00 (t, J=7.7 Hz, 1H), 7.91 (m, 1H), 7.84 (d, J=8.5 Hz, 1H), 7.76 (m, 1H), 7.72 (m, 1H), 7.48-7.62 (m, 4H), 7.41 (m, 1H), 7.32 (d, J=8.5 Hz, 1H), 7.13-7.21 (m, 2H), 6.99-7.03 (m, 2H), 6.84 (d, J=8.3 Hz, 1H), 3.66-3.77 (m, 2H), 3.38 (m, 3H), 1.47 (d, J=6.7 Hz, 3H), 1.31 (d, J=6.7 Hz, 3H), 1.27 (d, J=6.7 Hz, 3H), 1.21 (d, J=6.7 Hz, 3H), 0.52 (s, 3H), 0.36 (s, 3H). ¹³C{¹H} NMR (101 MHz, CD₂Cl₂): δ 172.6, 167.1, 159.4, 156.4, 147.6, 145.5, 145.2, 141.6, 137.3, 133.5, 133.4, 132.7, 131.9, 131.2, 129.5, 129.4, 129.0, 128.8, 127.4, 127.2, 126.8, 125.4, 124.6, 124.5, 122.1, 121.1, 112.1, 111.8, 55.7, 28.1, 27.8, 26.8, 26.5, 25.1, 24.6, 2.28, −0.12.

### Preparation of Complex 20

A mixture of 108 mg (0.157 mmol) of complex 3 and 17 mg (0.157 mmol) of thiophen-2-carbonitrile in 5 mL of dichloromethane was stirred for 5 minutes at morn temperature. Further on, this mixture was evaporated to dryness; the residue was washed with 2×5 mL of hexane and then dried in vacuum. This procedure gave 111 mg (89%) of the addition product as a yellow solid. ¹H NMR (400 MHz, CD₂Cl₂): δ 7.95-8.03 (m, 3H), 7.75 (m, 2H), 7.50-7.66 (m, 5H), 7.10-7.23 (m, 4H), 7.04 (m, 1H), 3.82 (m, 1H), 3.70 (m, 1H), 1.57 (d, J=6.7 Hz, 3H), 1.26-1.32 (m, 9H), 0.49 (s, 3H), 0.37 (s, 3H).

### Preparation of Complex 21

A mixture of 108 mg (0.157 mmol) of complex 3 and 9 mg (0.157 mmol) of acetone in 5 mL of dichloromethane was stirred for 5 minutes at morn temperature. Further on, this mixture was evaporated to dryness; the residue was washed with 2×5 mL of hexane and then dried in vacuum. This procedure gave 102 mg (87%) of the addition product as a white solid. ¹H NMR (400 MHz, CD₂Cl₂): δ 7.99-8.06 (m, 2H), 7.94 (m, 1H), 7.83 (m, 2H), 7.79 (m, 1H), 7.51-7.55 (m, 2H), 7.44 (m, 1H), 7.37 (m, 1H), 7.06-7.14 (m, 3H), 3.66 (m, 1H), 3.51 (m, 1H), 1.82 (s, 3H), 1.35 (d, J=6.7 Hz, 3H), 1.29 (d, J=6.7 Hz, 3H), 1.25-1.29 (m, 6H), 1.09 (s, 3H), 0.58 (s, 3H), 0.27 (s, 3H).

### Preparation of Complex 11 (Table 1)

A solution of MeMgBr in diethyl ether (3.66 ml, 10 mmol) was added to a solution of dichloride complex 5 (1.3 g, 2.0 mmol) in toluene (50 ml). The reaction mixture was stirred for 3 hours at 70° C. and then cooled to ambient temperature and evaporated to dryness. Crude product was extracted from the residue with hot hexane (3×30 ml). The combined extract was evaporated to dryness and the residue was washed with cold pentane, then recrystallized from toluene-hexane to give the desired product as a white solid. Yield: 41%. ¹H NMR (benzene-d₆), δ: 8.45 (m, 1H), 7.55 (m, 1H), 7.39 (m, 1H), 7.22 (m, 1H), 7.09-7.18 (m, 4H), 6.97 (m, 2H), 3.75 (m, 2H), 1.32 (d, J=6.7 Hz, 6H), 1.21 (d, J=6.7 Hz, 6H), 0.92-0.97 (m, 4H), 0.86-0.89 (m, 6H), 0.74 (s, 6H). Anal. Calcd. for C₂₉H₄₀HfN₂Si: C, 55.89; H, 6.47; N, 4.49. Found: C, 56.02; H, 6.64; N, 4.21.

### Complex 10 (Table 1)

Prepared and isolated analogously to complex 11. Yield: 62%. ¹H NMR (benzene-d₆), δ: 8.53 (m, 1H), 7.56-7.61 (m, 5H), 7.49 (m, 1H), 7.31 (m, 1H), 7.27 (m, 1H), 7.09-7.21 (m, 7H), 7.03 (m, 2H), 6.97 (m, 2H), 2.08 (s, 6H), 0.90 (s, 6H). Anal. Calcd. for C₃₃H₃₂HfN₂Si: C, 59.76; H, 4.86; N, 4.22. Found: C, 59.85; H, 5.02; N, 4.11.

### Complex 12 (Table 1)

Prepared and isolated analogously to complex 11. Yield: 34%. ¹H NMR (benzene-d₆), δ: 8.52 (m, 1H), 7.60 (m, 4H), 7.41 (m, 1H), 7.24 (m, 2H), 7.19 (m, 1H), 7.07-7.13 (m, 9H), 6.91 (m, 2H), 3.62 (m, 2H), 1.26 (d, J=6.9 Hz, 6H), 0.87 (s, 6H), 0.52 (d, J=6.9 Hz, 6H). Anal. Calcd. for C₃₇H₄₀HfN₂Si: C, 61.78; H, 5.61; N, 3.89. Found: C, 61.99; H, 5.87; N, 3.72.

### Preparation of Complex 22 (Table 2)

A solution of MeMgBr (0.2 mL, 2.9 M) in diethyl ether was added via syringe to a solution of 400 mg (0.567 mmol) of complex 13 in 10 ml of dichloromethane at −30° C. The resulting mixture was stirred overnight at room temperature and then evaporated to dryness. The residue was extracted with hot hexane, and the obtained solution was filtered through the short pad of diatomaceous earth. The filtrate was evaporated to dryness, and the residual solid was washed with cold pentane giving 300 mg (77%) of the mono-methylation product as a pale yellow solid. ¹H NMR (400 MHz, CD₂Cl₂, mixture of isomers): δ 7.95 (m, 1H), 7.68 (m, 1H), 7.38-7.55 (m, 5H), 7.10-7.18 (m, 3H), 3.77 (m, 1H), 3.58 (m, 1H), 3.04 (m, 1H), 1.20-1.38 (m, 12H), 1.03 (m, 3H), 0.67 (m, 3H), 0.43 (m, 3H), 0.32 (s, 3H), −0.36 (m, 3H).

### Preparation of Complex 23 (Table 2)

A solution of MeMgBr (1.15 mL, 2.9 M) in diethyl ether was added via syringe to a solution of 1.01 g (1.59 mmol) of complex 1 in 20 ml of dichloromethane at −30° C. The resulting mixture was stirred overnight at room temperature and then evaporated to dryness. The residue was extracted with hot hexane, and the obtained solution was filtered through the short pad of diatomaceous earth. The filtrate was evaporated to dryness, and the residue was recrystallized from a ca. 20:80 mixture of toluene and hexane giving 700 mg (74%) of the methylation product as s pale yellow crystalline material. ¹H NMR (400 MHz, C₆D₆): δ 8.43 (d, J=6.9 Hz, 1H), 7.55 (d, J=7.7 Hz, 1H), 7.38 (t, J=7.1 Hz, 1H), 7.14-7.24 (m, 4H), 7.10 (m, 1H), 7.00 (m, 1H), 6.86 (m, 1H), 3.71 (m, 2H), 1.30 (d, J=6.9 Hz, 6H), 1.17 (d, J=6.9 Hz, 6H), 0.71 (s, 6H), 0.33 (s, 6H). ¹³C{¹H} NMR (101 MHz, C₆D₆): δ 202.9, 171.1, 165.1, 146.8, 144.1, 142.3, 140.4, 139.4, 130.9, 128.8, 128.6, 127.9, 126.7, 124.3, 124.2, 123.4, 118.2, 64.9, 28.4, 25.7, 24.7, 1.0.

### Polymerization Examples

All polymerizations were carried out in a parallel, pressure reactor, as generally described in U.S. Pat. Nos. 6,306,658; 6,455,316; 6,489,168; WO 2000/009255; and Murphy, V. et al. (2003) J. Am. Chem. Soc., v. 125, pp. 4306-4317, each of which is fully incorporated herein by reference to the extent not inconsistent with this specification. The following describes a general procedure used to screen catalysts. The temperatures, pressures, quantities of chemicals used (e.g. precatalysts, activators, scavengers, chain transfer agents, etc.) will vary from experiment to experiment, and specific values are given in the Tables where data are presented. A pre-weighed glass vial insert and disposable stirring paddle were fitted to each reaction vessel of the reactor, which contains 48 individual reaction vessels. The reactor was then closed and each vessel was individually heated to the desired temperature and pressurized to a predetermined pressure (typically 75 psi=0.517 MPa). If desired, comonomer, such as 1-octene, was then injected into each reaction vessel through a valve, followed by enough solvent (typically isohexane or toluene) to bring the total reaction volume, including the subsequent additions, to the desired volume (typically 5 mL). The contents of the vessel were then stirred at 800 rpm. A solution of scavenger (typically an organoaluminum reagent in isohexane or toluene) was then added along with a solvent chaser (typically 500 microliters). If desired, a solution of an additional scavenger or chain transfer agent was then added along with a solvent chaser (typically 500 microliters). An activator solution in toluene (typically 1 molar equivalent relative to the precatalyst complex) was then injected into the reaction vessel along with a solvent chaser (typically 500 microliters). Then a toluene solution of the precatalyst complex dissolved was added along with and a solvent chaser (typically 500 microliters). The reaction was then allowed to proceed until either a set amount of pressure had been taken up by the polymerization (typically 12 psi=0.137 MPa for reactions performed at 75 psi) ethylene had been taken up by the reaction (ethylene pressure was maintained in each reaction vessel at the pre-set level by computer control). At this point, the reaction was quenched by pressurizing the vessel with compressed air. After the polymerization reaction, the glass vial insert containing the polymer product and solvent was removed from the pressure cell and the inert atmosphere glove box, and the volatile components were removed using a Genevac HT-12 centrifuge and Genevac VC3000D vacuum evaporator operating at elevated temperature and reduced pressure. The vial was then weighed to determine the yield of the polymer product. The resultant polymer was analyzed by Rapid GPC (see below) to determine the molecular weight.

To determine various molecular weight related values by GPC, high temperature size exclusion chromatography was performed using an automated “Rapid GPC” system as generally described in U.S. Pat. Nos. 6,491,816; 6,491,823; 6,475,391; 6,461,515; 6,436,292; 6,406,632; 6,175,409; 6,454,947; 6,260,407; and 6,294,388. This apparatus has a series of three 30 cm×7.5 mm linear columns, each containing PLgel 10 um, Mix B. The GPC system was calibrated using polystyrene standards ranging from 580 g/mol-3,390,000 g/mol. The system was operated at an eluent flow rate of 2.0 mL/min and an oven temperature of 165° C. 1,2,4-trichlorobenzene was used as the eluent. The polymer samples were dissolved in 1,2,4-trichlorobenzene at a concentration of 0.1 mg/mL-0.9 mg/mL. 250 μL of a polymer solution was injected into the system. The concentration of the polymer in the eluent was monitored using an evaporative light scattering detector. The molecular weights presented in the examples are relative to linear polystyrene standards.

Differential Scanning calorimetry (DSC) measurements were performed on a TA-Q100 instrument to determine the melting point of the polymers. Samples were pre-annealed at 220° C. for 15 minutes and then allowed to cool to room temperature overnight. The samples were then heated to 220° C. at a rate of 100° C./minutes and then cooled at a rate of 50° C./min. Melting points were collected during the heating period.

Data shown in Table 3 indicate that activated complexes of the general type described in the present disclosure are capable of polymerizing alkenes. Table 3 illustrates that the inventive examples (runs 1 through 3, Complex 7) have an Mw value of 301,389 to 568,651 without the presence of the chain transfer agent diethyl zinc (DEZ), whereas the examples (runs 4 through 6, Complex 7) have an Mw of 35,417 to 61,870 when DEZ is present in the polymerization process. Furthermore, higher melting points were obtained in the presence of DEZ (e.g., Tm of 116° C.-119° C. for runs 1 through 3 compared to Tm of 126° C.-127° C. for runs 4 through 6). Similar observations were obtained for Complex 8, with runs 7 through 9 displaying an Mw of 86,772 to 92,895 without the presence of DEZ, whereas the examples of runs 10 through 12 (Complex 8) have an Mw of 29,034 to 39,605 when DEZ is present in the polymerization process. Furthermore, higher melting points were obtained in the presence of DEZ (e.g., Tm of 118° C.-120° C. for runs 7 through 9 compared to Tm of 126° C. for runs 10 through 12). These results show that the catalyst is sensitive to the chain transfer agent. The catalyst system has shown to be versatile as it provides a wide range of various polymers of various Mw and/or PDI, thus thanks to its tunable activity, while maintaining the polymer properties. Also, the presence of the chain transfer agent DEZ influences the Tm by lowering the octene comonomer incorporation. Indeed, as shown in Table 3, when DEZ is added to the polymerization mixture, an olefin polymer with lower content of C₈ wt % and a higher Tm is obtained.

Similar results were obtained with Complex 10 (runs 19 through 21), without DEZ, with average Mw of 69,424, average Tm of 119° C., and average comonomer C₈ content of 7.8 wt % compared to runs 22 through 24, with DEZ, providing an average Mw of 29,876, average Tm of 124° C., and average comonomer C₈ content of 6.1 wt %. Complex 11 (runs 25 through 27), without DEZ, provided an average Mw of 109,526, average Tm of 110° C., and average comonomer C₈ content of 11.2 wt % compared to runs 28 through 30, with DEZ, with average Mw of 21,037, average Tm of 113° C., and average comonomer C₈ content of 12.3 wt %. Furthermore, Complex 12 (runs 31 through 33), without DEZ, provided an average Mw of 114,934, average Tm of 107° C., and average comonomer C₈ content of 12.7 wt % compared to runs 34 through 36, with DEZ, which provided an average Mw of 23,983, average Tm of 112° C. and average comonomer C₈ content of 11.9 wt %.

TABLE 3
Run conditions and data for ethylene-octene copolymerizations performed in
high-throughput reactor. General: temp 80 deg C., pressure = 75 psi ethylene,
1-octene = 0.1 mL, volume = 5 mL, solvent = isohexane,
activator = [PhNMe₂H][B(C₆F₅)₄] (1 equiv).

| | | | | | activity | | | | | m.p. |
|---|---|---|---|---|---|---|---|---|---|---|
| | Com- | DEZ | quench | yield | (g/mmol/ | wt % | | | | (deg |
| Run | plex | (nmol) | time (s) | (mg) | h/bar) | C8 | Mw | Mn | PDI | C.) |
| 1 | 7 | 0 | 344 | 27 | 2,702 | 9.1 | 301,389 | 98,742 | 3.1 | 119 |
| 2 | 7 | 0 | 292 | 28 | 3,318 | 6.9 | 568,651 | 125,034 | 4.5 | 117 |
| 3 | 7 | 0 | 244 | 25 | 3,580 | 6.8 | 384,210 | 109,653 | 3.5 | 116 |
| 4 | 7 | 1000 | 1174 | 18 | 543 | 6.3 | 61,870 | 23,632 | 2.6 | 127 |
| 5 | 7 | 1000 | 806 | 12 | 518 | 6.8 | 35,417 | 14,563 | 2.4 | 127 |
| 6 | 7 | 1000 | 578 | 17 | 1,036 | 5.7 | 46,865 | 21,141 | 2.2 | 126 |
| 7 | 8 | 0 | 655 | 19 | 989 | 8.3 | 86,772 | 63,770 | 1.4 | 120 |
| 8 | 8 | 0 | 472 | 22 | 1,584 | 8.4 | 92,895 | 73,509 | 1.3 | 118 |
| 9 | 8 | 0 | 775 | 24 | 1,095 | 8.0 | | | | 119 |
| 10 | 8 | 1000 | 1801 | 15 | 292 | 7.4 | 39,605 | 18,734 | 2.1 | 126 |
| 11 | 8 | 1000 | 869 | 13 | 501 | 7.7 | 34,100 | 15,768 | 2.2 | 126 |
| 12 | 8 | 1000 | 1630 | 11 | 239 | 8.5 | 29,034 | 13,144 | 2.2 | 126 |
| 13 | 9 | 0 | 1801 | 4 | 85 | | | | | |
| 14 | 9 | 0 | 1615 | 7 | 157 | | | | | |
| 15 | 9 | 0 | 1801 | 9 | 176 | | | | | |
| 16 | 9 | 1000 | 895 | 2 | 58 | | | | | |
| 17 | 9 | 1000 | 1800 | 3 | 52 | | | | | |
| 18 | 9 | 1000 | 1801 | 1 | 21 | | | | | |
| 19 | 10 | 0 | 1801 | 19 | 359 | 8.2 | 70,523 | 54,356 | 1.3 | 119 |
| 20 | 10 | 0 | 1802 | 9 | 182 | | | | | |
| 21 | 10 | 0 | 1670 | 19 | 394 | 7.3 | 68,325 | 55,777 | 1.2 | 119 |
| 22 | 10 | 1000 | 1801 | 13 | 242 | 7.0 | 36,385 | 12,658 | 2.9 | 124 |
| 23 | 10 | 1000 | 1072 | 14 | 438 | 5.3 | 30,962 | 13,824 | 2.2 | 123 |
| 24 | 10 | 1000 | 1801 | 11 | 203 | 6.0 | 22,280 | 10,128 | 2.2 | 124 |
| 25 | 11 | 0 | 385 | 27 | 2,393 | 11.6 | 116,187 | 87,845 | 1.3 | 111 |
| 26 | 11 | 0 | 349 | 24 | 2,352 | 10.1 | 109,854 | 84,330 | 1.3 | 110 |
| 27 | 11 | 0 | 334 | 22 | 2,316 | 11.9 | 102,537 | 73,420 | 1.4 | 110 |
| 28 | 11 | 1000 | 615 | 19 | 1,058 | 10.4 | 23,502 | 20,327 | 1.2 | 113 |
| 29 | 11 | 1000 | 426 | 15 | 1,185 | 14.2 | 18,572 | 15,955 | 1.2 | 113 |
| 30 | 11 | 1000 | 1800 | 0 | 0 | | | | | |
| 31 | 12 | 0 | 287 | 29 | 3,455 | 13.8 | 119,848 | 87,767 | 1.4 | 106 |
| 32 | 12 | 0 | 287 | 23 | 2,768 | 12.5 | 111,612 | 79,673 | 1.4 | 108 |
| 33 | 12 | 0 | 326 | 23 | 2,433 | 11.9 | 113,343 | 85,602 | 1.3 | 107 |
| 34 | 12 | 1000 | 532 | 24 | 1,550 | 9.6 | 28,779 | 24,884 | 1.2 | 111 |
| 35 | 12 | 1000 | 318 | 16 | 1,775 | 16.7 | 20,579 | 17,723 | 1.2 | 111 |
| 36 | 12 | 1000 | 435 | 18 | 1,433 | 9.5 | 22,592 | 19,400 | 1.2 | 114 |

### Polymerization Examples in Tables 4-7

Solutions of the pre-catalysts were made using toluene (ExxonMobil Chemical Company—anhydrous, stored under N2) (98%). Pre-catalyst solutions were typically 0.5 mmol/L.

Solvents, polymerization grade toluene and/or isohexanes were supplied by ExxonMobil Chemical Company and are purified by passing through a series of columns: two 500 cc Oxyclear cylinders in series from Labclear (Oakland, Calif.), followed by two 500 cc columns in series packed with dried 3 Å mole sieves (8-12 mesh; Aldrich Chemical Company), and two 500 cc columns in series packed with dried 5 Å mole sieves (8-12 mesh; Aldrich Chemical Company).

1-octene (C₈; 98%, Aldrich Chemical Company) was dried by stirring over NaK overnight followed by filtration through basic alumina (Aldrich Chemical Company, Brockman Basic 1).

Polymerization grade ethylene (C₂) was used and further purified by passing it through a series of columns: 500 cc Oxyclear cylinder from Labclear (Oakland, Calif.) followed by a 500 cc column packed with dried 3 Å mole sieves (8-12 mesh; Aldrich Chemical Company), and a 500 cc column packed with dried 5 Å mole sieves (8-12 mesh; Aldrich Chemical Company).

Polymerization grade propylene (C₃) was used and further purified by passing it through a series of columns: 2250 cc Oxiclear cylinder from Labclear followed by a 2250 cc column packed with 3 Å mole sieves (8-12 mesh; Aldrich Chemical Company), then two 500 cc columns in series packed with 5 Å mole sieves (8-12 mesh; Aldrich Chemical Company), then a 500 cc column packed with Selexsorb CD (BASF), and finally a 500 cc column packed with Selexsorb COS (BASF).

Activation of the pre-catalysts was by dimethylanilinium tetrakisperfluorophenylborate (Activator A, Boulder Scientific and Albemarle Corp) typically used as a 5 mmol/L solution in toluene or by MAO typically used as a 0.5 mass % solution in toluene (Activator B, 10 wt % in toluene available from Albemarle Corp). The molar ratio of activator to pre-catalyst was 1.1:1 for activator A and 500:1 for activator B. For polymerization runs using dimethylanilinium tetrakisperfluorophenylborate, tri-n-octylaluminum (TnOAl, neat, AkzoNobel) was also used as a scavenger prior to introduction of the activator and pre-catalyst into the reactor. TnOAl was typically used as a 5 mmol/L solution in toluene.

### Reactor Description and Preparation:

Polymerizations were conducted in an inert atmosphere (N2) drybox using autoclaves equipped with an external heater for temperature control, glass inserts (internal volume of reactor=23.5 mL for C₂ and C₂/C₈; 22.5 mL for C₂/C₃ runs), septum inlets, regulated supply of nitrogen, ethylene and propylene, and equipped with disposable PEEK mechanical stirrers (800 RPM). The autoclaves were prepared by purging with dry nitrogen at 110° C. or 115° C. for 5 hours and then at 25° C. for 5 hours.

Ethylene Polymerization (PE) or Ethylene/1-octene Copolymerization (EO):

The reactor was prepared as described above, and then purged with ethylene. For dimethylanilinium tetrakisperfluorophenylborate activated runs, toluene, 1-octene (100 μL when used) and scavenger (TnOAl, 0.5 μmol) were added via syringe at room temperature and atmospheric pressure. The reactor was then brought to process temperature (80° C.) and charged with ethylene to process pressure (75 psig=618.5 kPa or 200 psig=1480.3 kPa) while stirring at 800 RPM. The activator solution, followed by the pre-catalyst solution, was injected via syringe to the reactor at process conditions. Ethylene was allowed to enter (through the use of computer controlled solenoid valves) the autoclaves during polymerization to maintain reactor gauge pressure (+/−2 psig). Reactor temperature was monitored and typically maintained within +/−1° C. Polymerizations were halted by addition of approximately 50 psi O₂/Ar (5 mole % O₂) gas mixture to the autoclave for approximately 30 seconds. The polymerizations were quenched after a predetermined cumulative amount of ethylene had been added (maximum quench value in psid) or for a maximum of 30 minutes polymerization time. Afterwards, the reactors were cooled and vented. Polymers were isolated after the solvent was removed in-vacuo. Yields reported include total weight of polymer and residual catalyst. Catalyst activity is reported as grams of polymer per mmol transition metal compound per hour of reaction time (g/mmol·hr). Ethylene homopolymerization runs are summarized in Table 4, and ethylene/l-octene copolymerization runs are summarized in Table 5.

### Ethylene Homopolymerization (PE) and Ethylene Propylene Copolymerization (EP):

The reactor was prepared as described above, then heated to 40° C. and then purged with ethylene gas at atmospheric pressure. Ethylene pressure (125 psid) was then added to the reactor. Isohexanes and scavenger (TnOAl, 0.5 μmol) were added via syringe. The stirrers were then started and maintained at 800 RPM. Liquid propylene (0 to 200 μL) was then injected into the reactor. The reactor was then brought to process temperature (70° C.). The activator solution, followed by the pre-catalyst solution, was injected via syringe to the reactor at process conditions. Reactor temperature was monitored and typically maintained within +/−1° C. of 70° C. Polymerizations were halted by addition of approximately 50 psi O₂/Ar (5 mole % O₂) gas mixture to the autoclaves for approximately 30 seconds. The polymerizations were quenched based on a predetermined pressure loss of approximately 6 psi or for a maximum of 20 minutes polymerization time. The reactors were cooled and vented. The polymer was isolated after the solvent was removed in-vacuo. The quench time (s) is reported in Table 6 for each run. Yields reported include total weight of polymer and residual catalyst. Catalyst activity is reported as grams of polymer per mmol transition metal compound per hour of reaction time (g/mmol·hr). Ethylene homopolymerization and Ethylene/propylene copolymerization examples are reported in Table 6.

### Propylene Homopolymerization (PP) and Ethylene Propylene Copolymerization (EP):

The reactor was prepared as described above, then heated to 40° C. and then purged with ethylene gas at atmospheric pressure (only cells using ethylene) or nitrogen (cells not using ethylene). The listed ethylene pressure (10, 20, 40, 60 or 80 psid) was then added to the reactor. Isohexanes and scavenger (TnOAl, 0.5 μmol) were added via syringe. The stirrers were then started and maintained at 800 RPM. Liquid propylene (1.0 ml) was then injected into the reactor. The reactor was then brought to process temperature (70° C.). The activator solution, followed by the pre-catalyst solution, was injected via syringe to the reactor at process conditions. Reactor temperature was monitored and typically maintained within +/−1° C. Polymerizations were halted by addition of approximately 50 psi O₂/Ar (5 mole % O₂) gas mixture to the autoclaves for approximately 30 seconds. The polymerizations were quenched based on a predetermined pressure loss of approximately 5 psid or for a maximum of 45 minutes polymerization time. The reactors were cooled and vented. The polymer was isolated after the solvent was removed in-vacuo. The quench time (s) and max quench value (psi) are reported in Table 7 for each run. Yields reported include total weight of polymer and residual catalyst. Catalyst activity is reported as grams of polymer per mmol transition metal compound per hour of reaction time (g/mmol·hr). Ethylene/propylene copolymerization examples are collected in Table 7.

### Polymer Characterization

For analytical testing, polymer sample solutions were prepared by dissolving polymer in 1,2,4-trichlorobenzene (TCB, 99+% purity from Sigma-Aldrich) containing 2,6-di-tert-butyl-4-methylphenol (BHT, 99% from Aldrich) at 165° C. in a shaker oven for approximately 3 hours. The typical concentration of polymer in solution was between 0.1 to 0.9 mg/mL with a BHT concentration of 1.25 mg BHT/mL of TCB. Samples were cooled to 135° C. for testing.

High temperature size exclusion chromatography was performed using an automated “Rapid GPC” system as described in U.S. Pat. Nos. 6,491,816; 6,491,823; 6,475,391; 6,461,515; 6,436,292; 6,406,632; 6,175,409; 6,454,947; 6,260,407; and 6,294,388; each of which is incorporated herein by reference. Molecular weights (weight average molecular weight (Mw), number average molecular weight (Mn) and z-average molecular weight (Mz)) and molecular weight distribution (MWD=Mw/Mn), which is also sometimes referred to as the polydispersity (PDI) of the polymer, were measured by Gel Permeation Chromatography using a Symyx Technology GPC equipped with dual wavelength infrared detector and calibrated using polystyrene standards (Polymer Laboratories: Polystyrene Calibration Kit S-M-10: Mp (peak Mw) between 580 and 3,039,000). Samples (250 μL of a polymer solution in TCB were injected into the system) were run at an eluent flow rate of 2.0 mL/minute (135° C. sample temperatures, 165° C. oven/columns) using three Polymer Laboratories: PLgel 10 μm Mixed-B 300×7.5 mm columns in series. No column spreading corrections were employed. Numerical analyses were performed using Epoch® software available from Symyx Technologies or Automation Studio software available from Freeslate. The molecular weights obtained are relative to linear polystyrene standards. Molecular weight data is reported in Tables 4-7 under the headings Mn, Mw, Mz and PDI (or Mw/Mn) as defined above.

Differential Scanning calorimetry (DSC) measurements were performed on a TA-Q100 instrument to determine the melting point of the polymers. Samples were pre-annealed at 220° C. for 15 minutes and then allowed to cool to room temperature overnight. The samples were then heated to 220° C. at a rate of 100° C./minute and then cooled at a rate of 50° C./minute. Melting points were collected during the heating period. The results are reported in the Tables 1 and 2 under the heading, Tm (° C.). The polypropylenes produced (see Tables 3) are largely amorphous polyolefins with no recordable Tm.

Samples for infrared analysis were prepared by depositing the stabilized polymer solution onto a silanized wafer (Part number S10860, Symyx). By this method, approximately between 0.12 and 0.24 mg of polymer is deposited on the wafer cell. The samples were subsequently analyzed on a Brucker Equinox 55 FTIR spectrometer equipped with Pikes' MappIR specular reflectance sample accessory. Spectra, covering a spectral range of 5000 cm⁻¹ to 500 cm⁻¹, were collected at a 2 cm⁻¹ resolution with 32 scans.

For ethylene-1-octene copolymers, the wt % octene in the copolymer was determined via measurement of the methyl deformation band at ˜1375 cm⁻¹. The peak height of this band was normalized by the combination and overtone band at ˜4321 cm⁻¹, which corrects for path length differences. The normalized peak height was correlated to individual calibration curves from ¹H NMR data to predict the wt % octene content within a concentration range of ˜2 to 35 wt % for octene. Typically, R² correlations of 0.98 or greater are achieved. These numbers are reported in Table 4 under the heading C8 wt %).

For ethylene-propylene copolymers, the wt. % ethylene is determined via measurement of the methylene rocking band (˜770 cm⁻¹ to 700 cm⁻¹). The peak area of this band is normalized by sum of the band areas of the combination and overtone bands in the 4500 cm⁻¹ to 4000 cm⁻¹ range. The normalized band area is then correlated to a calibration curve from ¹³C NMR data to predict the wt. % ethylene within a concentration range of approx. 5 to 40 wt. %. Typically, R² correlations of 0.98 or greater are achieved. These numbers are reported in Table 7 under the heading C2 wt. %.

For high ethylene content polymers, ¹H NMR was used to calculate the amount of propylene present in the polymer.

For some samples, polymer end-group analysis was determined by ¹H NMR using a Varian Unity+400 MHz instrument run with a single 30° flip angle, RF pulse. 120 pulses with a delay of 8 seconds between pulses were signal averaged. The polymer sample was dissolved in heated d₂-1,1,2,2-tetrachloroethane and signal collection took place at 120° C. Vinylenes were measured as the number of vinylenes per 1,000 carbon atoms using the resonances between 5.5-5.31 ppm. Trisubstituted end-groups (“trisubs”) were measured as the number of trisubstituted groups per 1,000 carbon atoms using the resonances between 5.3-4.85 ppm, by difference from vinyls. Vinyl end-groups were measured as the number of vinyls per 1,000 carbon atoms using the resonances between 5.9-5.65 and between 5.3-4.85 ppm. Vinylidene end-groups were measured as the number of vinylidenes per 1,000 carbon atoms using the resonances between 4.85-4.65 ppm. The values reported are % vinylene, % trisubstituted (% trisub), % vinyl and % vinylidene where the percentage is relative to the total olefinic unsaturation per 1,000 carbon atoms.

“Complex” identifies the pre-catalyst used in the experiment. Corresponding numbers identifying the pre-catalyst are located in the synthetic experimental section. “Complex (μmol)” is the amount of pre-catalyst added to the reactor. For all experiments using borate activators, the molar ratio of activator:pre-catalyst was 1.1:1. For all experiments using MAO as the activation, the activator:pre-catalyst was 500:1. T(° C.) is the polymerization temperature. “Yield” is polymer yield, and is not corrected for catalyst residue. “Quench time (s)” is the actual duration of the polymerization run in seconds. “Quench Value (psid)” for ethylene based polymerization runs is the set maximum amount of ethylene uptake (conversion) for the experiment. If a polymerization quench time is less than the maximum time set, then the polymerization ran until the set maximum value of ethylene uptake was reached. For propylene based runs, quench value indicates the maximum set pressure loss (conversion) of propylene and ethylene (when present) during the polymerization. Activity is reported at grams polymer per mmol of catalyst per hour.

TABLE 4
part 1. Run conditions and data for additional ethylene-octene copolymerizations
performed in high-throughput reactor. General: temp = 80° C., volume = 5 mL,
solvent = toluene, activator A = [PhNMe₂H][B(C₆F₅)₄] (1.1 equiv) or activator
B = MAO (500 equiv); at 200 psi C2, quench pressure set at 15 psid; at 75 psi C2,
quench pressure set at 20 psid; or 30 minutes max reaction time.

| | | | | | | | | | Activity |
|---|---|---|---|---|---|---|---|---|---|
| | | | Com- | | | | quench | | (gP/ |
| Run | Com- | Acti- | plex | TnOAl | octene | C2 | time | yield | mmol |
| # | plex | vator | (μmol) | (μmol) | (μL) | (psig) | (s) | (g) | cat.hr) |
| 37 | 7 | A | 0.040 | 0.5 | 100 | 75 | 438 | 0.045 | 9,164 |
| 38 | 7 | A | 0.040 | 0.5 | 100 | 75 | 268 | 0.035 | 11,888 |
| 39 | 7 | A | 0.040 | 0.5 | 100 | 75 | 219 | 0.037 | 15,370 |
| 40 | 7 | B | 0.025 | 0.0 | 100 | 75 | 1265 | 0.035 | 3,961 |
| 41 | 7 | B | 0.025 | 0.0 | 100 | 75 | 808 | 0.038 | 6,826 |
| 42 | 7 | B | 0.025 | 0.0 | 100 | 75 | 1303 | 0.033 | 3,625 |
| 43 | 7 | A | 0.040 | 0.5 | 100 | 200 | 436 | 0.051 | 10,486 |
| 44 | 7 | A | 0.040 | 0.5 | 100 | 200 | 132 | 0.042 | 28,909 |
| 45 | 7 | A | 0.040 | 0.5 | 100 | 200 | 327 | 0.047 | 12,908 |
| 46 | 7 | B | 0.025 | 0.0 | 100 | 200 | 484 | 0.034 | 10,235 |
| 47 | 7 | B | 0.025 | 0.0 | 100 | 200 | 425 | 0.038 | 12,706 |
| 48 | 7 | B | 0.025 | 0.0 | 100 | 200 | 482 | 0.031 | 9,202 |
| 49 | 7 | A | 0.040 | 0.5 | 200 | 200 | 74 | 0.047 | 57,405 |
| 50 | 7 | A | 0.040 | 0.5 | 200 | 200 | 62 | 0.046 | 66,339 |
| 51 | 7 | A | 0.040 | 1.6 | 200 | 200 | 40 | 0.041 | 92,925 |
| 52 | 7 | A | 0.040 | 1.6 | 200 | 200 | 41 | 0.040 | 87,585 |
| 53 | 7 | A | 0.040 | 3.2 | 200 | 200 | 40 | 0.041 | 91,800 |
| 54 | 7 | A | 0.040 | 3.2 | 200 | 200 | 39 | 0.041 | 95,077 |
| 55 | 7 | A | 0.040 | 6.4 | 200 | 200 | 39 | 0.039 | 89,308 |
| 56 | 7 | A | 0.040 | 6.4 | 200 | 200 | 34 | 0.039 | 101,912 |
| 57 | 7 | A | 0.040 | 12.8 | 200 | 200 | 37 | 0.039 | 94,865 |
| 58 | 7 | A | 0.040 | 12.8 | 200 | 200 | 39 | 0.042 | 95,769 |
| 59 | 7 | A | 0.040 | 25.6 | 200 | 200 | 40 | 0.039 | 87,975 |
| 60 | 7 | A | 0.040 | 25.6 | 200 | 200 | 42 | 0.038 | 81,643 |
| 61 | 8 | A | 0.040 | 0.5 | 100 | 75 | 860 | 0.030 | 3,108 |
| 62 | 8 | A | 0.040 | 0.5 | 100 | 75 | 881 | 0.028 | 2,820 |
| 63 | 8 | A | 0.040 | 0.5 | 100 | 75 | 441 | 0.026 | 5,286 |
| 64 | 8 | B | 0.025 | 0.0 | 100 | 75 | 1802 | 0.024 | 1,878 |
| 65 | 8 | B | 0.025 | 0.0 | 100 | 75 | 1801 | 0.021 | 1,671 |
| 66 | 8 | B | 0.025 | 0.0 | 100 | 75 | 1801 | 0.025 | 1,999 |
| 67 | 8 | A | 0.040 | 0.5 | 100 | 200 | 267 | 0.023 | 7,618 |
| 68 | 8 | A | 0.040 | 0.5 | 100 | 200 | 397 | 0.024 | 5,395 |
| 69 | 8 | A | 0.040 | 0.5 | 100 | 200 | 396 | 0.024 | 5,432 |
| 70 | 8 | B | 0.025 | 0.0 | 100 | 200 | 1800 | 0.033 | 2,600 |
| 71 | 8 | B | 0.025 | 0.0 | 100 | 200 | 1801 | 0.030 | 2,375 |
| 72 | 8 | B | 0.025 | 0.0 | 100 | 200 | 1801 | 0.006 | 512 |
| 73 | 9 | A | 0.040 | 0.5 | 100 | 75 | 1800 | 0.017 | 860 |
| 74 | 9 | A | 0.040 | 0.5 | 100 | 75 | 1801 | 0.020 | 994 |
| 75 | 9 | A | 0.040 | 0.5 | 100 | 75 | 1019 | 0.015 | 1,334 |
| 76 | 9 | B | 0.025 | 0.0 | 100 | 75 | 1800 | 0.024 | 1,928 |
| 77 | 9 | B | 0.025 | 0.0 | 100 | 75 | 1801 | 0.031 | 2,447 |
| 78 | 9 | B | 0.025 | 0.0 | 100 | 75 | 1490 | 0.029 | 2,764 |
| 79 | 9 | A | 0.040 | 0.5 | 100 | 200 | 1172 | 0.016 | 1,213 |
| 80 | 9 | A | 0.040 | 0.5 | 100 | 200 | 254 | 0.012 | 4,075 |
| 81 | 9 | A | 0.040 | 0.5 | 100 | 200 | 1801 | 0.016 | 775 |
| 82 | 9 | B | 0.025 | 0.0 | 100 | 200 | 1067 | 0.031 | 4,116 |
| 83 | 9 | B | 0.025 | 0.0 | 100 | 200 | 1380 | 0.029 | 3,057 |
| 84 | 9 | B | 0.025 | 0.0 | 100 | 200 | 980 | 0.034 | 4,996 |
| 85 | 10 | A | 0.040 | 0.5 | 100 | 75 | 1802 | 0.017 | 839 |
| 86 | 10 | A | 0.040 | 0.5 | 100 | 75 | 1801 | 0.015 | 730 |
| 87 | 10 | A | 0.040 | 0.5 | 100 | 75 | 1800 | 0.016 | 785 |
| 88 | 10 | B | 0.025 | 0.0 | 100 | 75 | 1802 | 0.018 | 1,414 |
| 89 | 10 | B | 0.025 | 0.0 | 100 | 75 | 1801 | 0.015 | 1,175 |
| 90 | 10 | B | 0.025 | 0.0 | 100 | 75 | 1801 | 0.019 | 1,495 |
| 91 | 10 | A | 0.040 | 0.5 | 100 | 200 | 244 | 0.011 | 4,020 |
| 92 | 10 | A | 0.040 | 0.5 | 100 | 200 | 1801 | 0.016 | 810 |
| 93 | 10 | A | 0.040 | 0.5 | 100 | 200 | 208 | 0.010 | 4,327 |
| 94 | 10 | B | 0.025 | 0.0 | 100 | 200 | 1800 | 0.026 | 2,040 |
| 95 | 10 | B | 0.025 | 0.0 | 100 | 200 | 1801 | 0.024 | 1,911 |
| 96 | 10 | B | 0.025 | 0.0 | 100 | 200 | 1801 | 0.024 | 1,943 |
| 97 | 11 | A | 0.040 | 0.5 | 100 | 75 | 294 | 0.034 | 10,408 |
| 98 | 11 | A | 0.040 | 0.5 | 100 | 75 | 248 | 0.032 | 11,504 |
| 99 | 11 | A | 0.040 | 0.5 | 100 | 75 | 293 | 0.033 | 10,044 |
| 100 | 11 | B | 0.025 | 0.0 | 100 | 75 | 186 | 0.050 | 38,632 |
| 101 | 11 | B | 0.025 | 0.0 | 100 | 75 | 161 | 0.046 | 41,232 |
| 102 | 11 | B | 0.025 | 0.0 | 100 | 75 | 230 | 0.049 | 30,490 |
| 103 | 11 | A | 0.040 | 0.5 | 100 | 200 | 172 | 0.025 | 12,977 |
| 104 | 11 | A | 0.040 | 0.5 | 100 | 200 | 154 | 0.024 | 13,968 |
| 105 | 11 | A | 0.040 | 0.5 | 100 | 200 | 44 | 0.009 | 18,818 |
| 106 | 11 | B | 0.025 | 0.0 | 100 | 200 | 112 | 0.058 | 74,443 |
| 107 | 11 | B | 0.025 | 0.0 | 100 | 200 | 109 | 0.059 | 77,417 |
| 108 | 11 | B | 0.025 | 0.0 | 100 | 200 | 113 | 0.061 | 77,480 |
| 109 | 11 | A | 0.040 | 0.5 | 200 | 200 | 104 | 0.026 | 22,846 |
| 110 | 11 | A | 0.040 | 0.5 | 200 | 200 | 115 | 0.027 | 21,130 |
| 111 | 11 | A | 0.040 | 1.6 | 200 | 200 | 78 | 0.024 | 27,462 |
| 112 | 11 | A | 0.040 | 1.6 | 200 | 200 | 83 | 0.023 | 25,157 |
| 113 | 11 | A | 0.040 | 3.2 | 200 | 200 | 84 | 0.029 | 30,536 |
| 114 | 11 | A | 0.040 | 3.2 | 200 | 200 | 104 | 0.028 | 24,231 |
| 115 | 11 | A | 0.040 | 6.4 | 200 | 200 | 76 | 0.027 | 31,618 |
| 116 | 11 | A | 0.040 | 6.4 | 200 | 200 | 81 | 0.028 | 31,000 |
| 117 | 11 | A | 0.040 | 12.8 | 200 | 200 | 76 | 0.025 | 29,605 |
| 118 | 11 | A | 0.040 | 12.8 | 200 | 200 | 122 | 0.027 | 19,844 |
| 119 | 11 | A | 0.040 | 25.6 | 200 | 200 | 131 | 0.034 | 23,290 |
| 120 | 11 | A | 0.040 | 25.6 | 200 | 200 | 136 | 0.029 | 19,324 |
| 121 | 12 | A | 0.040 | 0.5 | 100 | 75 | 139 | 0.039 | 25,511 |
| 122 | 12 | A | 0.040 | 0.5 | 100 | 75 | 161 | 0.037 | 20,907 |
| 123 | 12 | A | 0.040 | 0.5 | 100 | 75 | 149 | 0.036 | 21,745 |
| 124 | 12 | B | 0.025 | 0.0 | 100 | 75 | 1667 | 0.036 | 3,084 |
| 125 | 12 | B | 0.025 | 0.0 | 100 | 75 | 1525 | 0.034 | 3,182 |
| 126 | 12 | B | 0.025 | 0.0 | 100 | 75 | 1801 | 0.033 | 2,639 |
| 127 | 12 | A | 0.040 | 0.5 | 100 | 200 | 74 | 0.031 | 38,068 |
| 128 | 12 | A | 0.040 | 0.5 | 100 | 200 | 77 | 0.033 | 38,571 |
| 129 | 12 | A | 0.040 | 0.5 | 100 | 200 | 82 | 0.034 | 36,768 |
| 130 | 12 | B | 0.025 | 0.0 | 100 | 200 | 1802 | 0.033 | 2,613 |
| 131 | 12 | B | 0.025 | 0.0 | 100 | 200 | 781 | 0.036 | 6,601 |
| 132 | 12 | B | 0.025 | 0.0 | 100 | 200 | 1801 | 0.031 | 2,479 |
| 133 | 13 | B | 0.025 | 0.0 | 100 | 75 | 1800 | 0.000 | 16 |
| 134 | 13 | B | 0.025 | 0.0 | 100 | 75 | 1800 | 0.001 | 48 |
| 135 | 13 | B | 0.025 | 0.0 | 100 | 75 | 1800 | 0.000 | −32 |
| 136 | 13 | B | 0.025 | 0.0 | 100 | 200 | 1800 | 0.003 | 256 |
| 137 | 13 | B | 0.025 | 0.0 | 100 | 200 | 1801 | 0.003 | 224 |
| 138 | 13 | B | 0.025 | 0.0 | 100 | 200 | 996 | 0.002 | 304 |
| 139 | 14 | B | 0.040 | 0.0 | 100 | 75 | 1801 | 0.007 | 340 |
| 140 | 14 | B | 0.040 | 0.0 | 100 | 75 | 1800 | 0.006 | 310 |
| 141 | 14 | B | 0.040 | 0.0 | 100 | 75 | 1800 | 0.005 | 245 |
| 142 | 14 | B | 0.040 | 0.0 | 100 | 200 | 1802 | 0.010 | 489 |
| 143 | 14 | B | 0.040 | 0.0 | 100 | 200 | 1802 | 0.010 | 479 |
| 144 | 14 | B | 0.040 | 0.0 | 100 | 200 | 1801 | 0.009 | 470 |
| 145 | 15 | B | 0.040 | 0.0 | 100 | 75 | 1800 | 0.005 | 230 |
| 146 | 15 | B | 0.040 | 0.0 | 100 | 75 | 1801 | 0.005 | 240 |
| 147 | 15 | B | 0.040 | 0.0 | 100 | 75 | 1802 | 0.007 | 330 |
| 148 | 15 | B | 0.040 | 0.0 | 100 | 200 | 1800 | 0.009 | 435 |
| 149 | 15 | B | 0.040 | 0.0 | 100 | 200 | 1800 | 0.008 | 405 |
| 150 | 15 | B | 0.040 | 0.0 | 100 | 200 | 1802 | 0.009 | 459 |
| 151 | 16 | B | 0.025 | 0.0 | 100 | 75 | 1800 | 0.004 | 288 |
| 152 | 16 | B | 0.025 | 0.0 | 100 | 75 | 1800 | 0.004 | 304 |
| 153 | 16 | B | 0.025 | 0.0 | 100 | 75 | 1801 | 0.005 | 368 |
| 154 | 16 | B | 0.025 | 0.0 | 100 | 200 | 1777 | 0.029 | 2,334 |
| 155 | 16 | B | 0.025 | 0.0 | 100 | 200 | 1801 | 0.021 | 1,647 |
| 156 | 16 | B | 0.025 | 0.0 | 100 | 200 | 1800 | 0.014 | 1,080 |
| 157 | 17 | B | 0.040 | 0.0 | 100 | 75 | 1802 | 0.005 | 260 |
| 158 | 17 | B | 0.040 | 0.0 | 100 | 75 | 1801 | 0.006 | 320 |
| 159 | 17 | B | 0.040 | 0.0 | 100 | 75 | 1800 | 0.005 | 270 |
| 160 | 17 | B | 0.040 | 0.0 | 100 | 200 | 1800 | 0.009 | 455 |
| 161 | 17 | B | 0.040 | 0.0 | 100 | 200 | 1800 | 0.010 | 500 |
| 162 | 17 | B | 0.040 | 0.0 | 100 | 200 | 1801 | 0.010 | 510 |
| 163 | 18 | B | 0.025 | 0.0 | 100 | 75 | 1801 | 0.006 | 456 |
| 164 | 18 | B | 0.025 | 0.0 | 100 | 75 | 1800 | 0.003 | 240 |
| 165 | 18 | B | 0.025 | 0.0 | 100 | 75 | 1800 | 0.003 | 240 |
| 166 | 18 | B | 0.025 | 0.0 | 100 | 200 | 1800 | 0.013 | 1,024 |
| 167 | 18 | B | 0.025 | 0.0 | 100 | 200 | 1801 | 0.013 | 1,031 |
| 168 | 18 | B | 0.025 | 0.0 | 100 | 200 | 1801 | 0.009 | 744 |
| 169 | 19 | B | 0.040 | 0.0 | 100 | 75 | 1802 | 0.008 | 415 |
| 170 | 19 | B | 0.040 | 0.0 | 100 | 75 | 1801 | 0.009 | 445 |
| 171 | 19 | B | 0.040 | 0.0 | 100 | 75 | 1800 | 0.009 | 465 |
| 172 | 19 | B | 0.040 | 0.0 | 100 | 200 | 1801 | 0.024 | 1,194 |
| 173 | 19 | B | 0.040 | 0.0 | 100 | 200 | 1743 | 0.024 | 1,244 |
| 174 | 19 | B | 0.040 | 0.0 | 100 | 200 | 1801 | 0.024 | 1,174 |
| 175 | 20 | B | 0.040 | 0.0 | 100 | 75 | 1802 | 0.007 | 340 |
| 176 | 20 | B | 0.040 | 0.0 | 100 | 75 | 1800 | 0.008 | 390 |
| 177 | 20 | B | 0.040 | 0.0 | 100 | 75 | 1801 | 0.008 | 380 |
| 178 | 20 | B | 0.040 | 0.0 | 100 | 200 | 1800 | 0.015 | 730 |
| 179 | 20 | B | 0.040 | 0.0 | 100 | 200 | 1801 | 0.016 | 820 |
| 180 | 20 | B | 0.040 | 0.0 | 100 | 200 | 1800 | 0.014 | 700 |
| 181 | 21 | B | 0.025 | 0.0 | 100 | 75 | 1802 | 0.004 | 288 |
| 182 | 21 | B | 0.025 | 0.0 | 100 | 75 | 1800 | 0.004 | 320 |
| 183 | 21 | B | 0.025 | 0.0 | 100 | 75 | 1800 | 0.005 | 392 |
| 184 | 21 | B | 0.025 | 0.0 | 100 | 200 | 1800 | 0.010 | 800 |
| 185 | 21 | B | 0.025 | 0.0 | 100 | 200 | 1801 | 0.013 | 1,063 |
| 186 | 21 | B | 0.025 | 0.0 | 100 | 200 | 1800 | 0.012 | 936 |
| 187 | 22 | B | 0.025 | 0.0 | 100 | 75 | 1800 | 0.002 | 160 |
| 188 | 22 | B | 0.025 | 0.0 | 100 | 75 | 1800 | 0.001 | 80 |
| 189 | 22 | B | 0.025 | 0.0 | 100 | 75 | 1801 | 0.004 | 320 |
| 190 | 22 | B | 0.025 | 0.0 | 100 | 200 | 990 | 0.025 | 3,680 |
| 191 | 22 | B | 0.025 | 0.0 | 100 | 200 | 1801 | 0.010 | 760 |
| 192 | 22 | B | 0.025 | 0.0 | 100 | 200 | 1801 | 0.008 | 608 |

TABLE 4
part 2. Characterization of ethylene-octene copolymers.

| Run | | | | | octene | Tm |
|---|---|---|---|---|---|---|
| # | Mn | Mw | Mz | PDI | (wt %) | (° C.) |
| 37 | 206,597 | 1,613,445 | 6,439,515 | 7.81 | 3.8* | 119.6 |
| 38 | 166,997 | 1,390,536 | 7,954,204 | 8.33 | 6.8 | 119.3 |
| 39 | 148,361 | 982,315 | 6,401,100 | 6.62 | 4.5 | 118.9 |
| 40 | 29,594 | 1,343,350 | 4,233,969 | 45.39 | 15.1 | 125.1 |
| 41 | 27,644 | 1,452,947 | 4,702,457 | 52.56 | 16.2 | 124.7 |
| 42 | 41,698 | 1,499,081 | 4,203,224 | 35.95 | 12.8 | 125.0 |
| 43 | 212,545 | 1,833,557 | 6,146,334 | 8.63 | 1.3* | 126.2 |
| 44 | 226,142 | 1,661,008 | 6,153,834 | 7.34 | 0.8* | 126.0 |
| 45 | 233,602 | 1,782,367 | 6,219,113 | 7.63 | 0.9* | 126.2 |
| 46 | 28,901 | 1,734,722 | 4,552,005 | 60.02 | 20.7 | 127.5 |
| 47 | 30,109 | 1,785,742 | 5,094,679 | 59.31 | 20.5 | 126.8 |
| 48 | 45,355 | 1,953,017 | 4,870,761 | 43.06 | 15.9 | 127.1 |
| 49 | 239,758 | 1,091,076 | 5,403,657 | 4.55 | 3.2* | 119.8 |
| 50 | 218,781 | 804,492 | 5,175,500 | 3.68 | 3.0* | 119.5 |
| 51 | 52,691 | 82,711 | 150,245 | 1.57 | 4.9 | 121.6 |
| 52 | 55,773 | 80,725 | 138,870 | 1.45 | 3.9* | 121.8 |
| 53 | 24,431 | 38,574 | 67,790 | 1.58 | 5.4 | 122.7 |
| 54 | 26,578 | 41,735 | 76,283 | 1.57 | 3.9* | 122.7 |
| 55 | 9,403 | 15,443 | 29,680 | 1.64 | 4.8 | 123.1 |
| 56 | 9,700 | 15,703 | 29,780 | 1.62 | 4.6 | 123.4 |
| 57 | 4,826 | 7,713 | 14,468 | 1.60 | 5.7 | 119.2 |
| 58 | 5,040 | 8,303 | 15,735 | 1.65 | 12.1 | 120.2 |
| 59 | 2,335 | 3,900 | 7,373 | 1.67 | 18.6 | 107.3 |
| 60 | 2,251 | 3,858 | 7,208 | 1.71 | 19.5 | 110.3 |
| 61 | 120,351 | 1,084,121 | 6,043,039 | 9.01 | 3.7* | 120.1 |
| 62 | 123,185 | 1,080,127 | 6,026,215 | 8.77 | 4.3 | 119.3 |
| 63 | 125,743 | 791,118 | 6,379,157 | 6.29 | 4.0 | 119.5 |
| 64 | 25,962 | 1,454,171 | 4,647,603 | 56.01 | 16.8 | 125.5 |
| 65 | 22,879 | 1,475,838 | 4,719,095 | 64.50 | 23.0 | 126.0 |
| 66 | 28,502 | 1,707,289 | 4,866,142 | 59.90 | 13.9 | 126.3 |
| 67 | 177,990 | 1,075,980 | 6,136,315 | 6.05 | 0.9* | 126.0 |
| 68 | 149,430 | 1,184,794 | 6,251,081 | 7.93 | 1.1* | 126.1 |
| 69 | 174,558 | 1,242,644 | 6,397,451 | 7.12 | 1.2* | 126.0 |
| 70 | 24,372 | 1,878,938 | 5,030,792 | 77.09 | 18.1 | 128.1 |
| 71 | 85,415 | 1,874,050 | 4,839,455 | 21.94 | 6.3 | 127.1 |
| 72 | | | | | | |
| 73 | 87,621 | 705,715 | 6,150,148 | 8.05 | 6.4 | 118.2 |
| 74 | 91,490 | 863,327 | 7,237,521 | 9.44 | 6.5 | 117.5 |
| 75 | 81,862 | 682,354 | 6,129,981 | 8.34 | 5.9 | 118.0 |
| 76 | 35,920 | 1,664,914 | 4,721,055 | 46.35 | 9.7 | 126.0 |
| 77 | 71,301 | 1,638,839 | 4,710,639 | 22.98 | 11.9 | 125.2 |
| 78 | 78,595 | 1,734,935 | 5,353,220 | 22.07 | 13.5 | 125.5 |
| 79 | 160,390 | 1,006,563 | 6,240,432 | 6.28 | 2.3* | 123.9 |
| 80 | 111,290 | 471,863 | 5,880,567 | 4.24 | 2.5* | 122.6 |
| 81 | 128,365 | 972,040 | 6,123,445 | 7.57 | 4.6 | 123.8 |
| 82 | 89,322 | 1,999,842 | 5,006,974 | 22.39 | 9.8 | 127.8 |
| 83 | 147,835 | 2,079,774 | 5,005,876 | 14.07 | 10.1 | 127.3 |
| 84 | 137,453 | 1,967,268 | 5,010,753 | 14.31 | 11.3 | 126.2 |
| 85 | 66,457 | 562,647 | 4,151,383 | 8.47 | 1.9* | 124.5 |
| 86 | 62,937 | 562,853 | 4,549,276 | 8.94 | 1.9* | 124.3 |
| 87 | 63,525 | 576,075 | 4,492,461 | 9.07 | 1.6* | 124.4 |
| 88 | 562,892 | 2,287,947 | 4,976,550 | 4.06 | 15.2 | 126.8 |
| 89 | 580,557 | 2,371,685 | 4,984,394 | 4.09 | 14.2 | 126.9 |
| 90 | 511,652 | 2,350,904 | 4,984,455 | 4.59 | 14.4 | 127.0 |
| 91 | 66,698 | 464,289 | 3,962,146 | 6.96 | 0.3* | 129.3 |
| 92 | 82,199 | 890,861 | 4,914,697 | 10.84 | 0.4* | 129.3 |
| 93 | 62,507 | 475,981 | 4,208,116 | 7.61 | 0.8* | 128.6 |
| 94 | 722,430 | 2,428,324 | 4,895,084 | 3.36 | 10.1 | 128.4 |
| 95 | 648,068 | 2,339,743 | 4,892,749 | 3.61 | 5.4 | 128.5 |
| 96 | 602,931 | 2,271,622 | 4,844,875 | 3.77 | 6.0 | 127.3 |
| 97 | 147,743 | 250,389 | 522,150 | 1.69 | 5.6 | 116.0 |
| 98 | 122,445 | 218,311 | 433,866 | 1.78 | 5.2 | 116.6 |
| 99 | 142,975 | 243,194 | 486,024 | 1.70 | 5.4 | 117.0 |
| 100 | 77,828 | 357,103 | 4,124,219 | 4.59 | 8.1 | 112.3 |
| 101 | 74,502 | 348,686 | 4,815,812 | 4.68 | 6.3 | 112.0 |
| 102 | 98,356 | 481,217 | 4,732,128 | 4.89 | 7.4 | 113.1 |
| 103 | 191,850 | 342,427 | 735,046 | 1.78 | 1.7* | 124.7 |
| 104 | 179,047 | 323,950 | 719,343 | 1.81 | 1.6* | 124.9 |
| 105 | | | | | | |
| 106 | 129,022 | 800,661 | 4,951,526 | 6.21 | 1.4* | 121.8 |
| 107 | 126,072 | 629,205 | 4,980,503 | 4.99 | 2.0* | 122.0 |
| 108 | 135,838 | 634,892 | 4,933,656 | 4.67 | 1.9* | 122.0 |
| 109 | 158,332 | 258,961 | 513,688 | 1.64 | 4.3 | 119.0 |
| 110 | 161,957 | 273,882 | 537,646 | 1.69 | 4.5 | 119.3 |
| 111 | 47,387 | 76,129 | 149,574 | 1.61 | 4.6 | 121.6 |
| 112 | 42,504 | 69,480 | 130,604 | 1.63 | 6.4 | 122.2 |
| 113 | 27,957 | 43,429 | 79,864 | 1.55 | 4.9 | 123.1 |
| 114 | 26,210 | 41,155 | 77,300 | 1.57 | 4.8 | 123.5 |
| 115 | 9,193 | 16,248 | 31,609 | 1.77 | 5.4 | 123.4 |
| 116 | 10,001 | 16,338 | 31,141 | 1.63 | 6.6 | 123.6 |
| 117 | 4,269 | 7,932 | 16,876 | 1.86 | 10.2 | 119.4 |
| 118 | 4,632 | 8,172 | 16,657 | 1.76 | 9.3 | 120.5 |
| 119 | 2,727 | 4,554 | 9,439 | 1.67 | 7.7 | 115.6 |
| 120 | 1,998 | 3,816 | 7,899 | 1.91 | 7.1 | 115.6 |
| 121 | 190,142 | 309,066 | 636,860 | 1.63 | 6.7 | 113.1 |
| 122 | 186,271 | 298,449 | 573,988 | 1.60 | 6.6 | 112.9 |
| 123 | 158,193 | 270,698 | 546,242 | 1.71 | 6.3 | 114.2 |
| 124 | 61,001 | 1,121,695 | 4,631,364 | 18.39 | 11.1 | 124.3 |
| 125 | 53,765 | 1,316,508 | 4,840,580 | 24.49 | 8.6 | 125.1 |
| 126 | 77,529 | 1,458,258 | 5,373,653 | 18.81 | 7.9 | 125.1 |
| 127 | 305,740 | 492,391 | 895,506 | 1.61 | 1.3* | 121.9 |
| 128 | 280,497 | 464,599 | 870,882 | 1.66 | 1.8* | 122.5 |
| 129 | 272,536 | 439,032 | 826,698 | 1.61 | 2.6* | 123.1 |
| 130 | 113,406 | 1,822,503 | 5,598,807 | 16.07 | 5.6 | 127.3 |
| 131 | 140,344 | 1,695,322 | 4,757,849 | 12.08 | 7.4 | 126.8 |
| 132 | 115,818 | 1,888,700 | 4,708,536 | 16.31 | 5.8 | 128.4 |
| 133 | | | | | | |
| 134 | | | | | | |
| 135 | | | | | | |
| 136 | | | | | | |
| 137 | | | | | | |
| 138 | | | | | | |
| 139 | | | | | | |
| 140 | | | | | | |
| 141 | | | | | | |
| 142 | | | | | | |
| 143 | | | | | | |
| 144 | | | | | | |
| 145 | | | | | | |
| 146 | | | | | | |
| 147 | | | | | | |
| 148 | | | | | | |
| 149 | | | | | | |
| 150 | | | | | | |
| 151 | | | | | | |
| 152 | | | | | | |
| 153 | | | | | | |
| 154 | 956,415 | 1,653,710 | 3,678,691 | 1.73 | 5.3 | 128.7 |
| 155 | 1,047,469 | 1,937,668 | 3,934,655 | 1.85 | 4.7 | 129.4 |
| 156 | 1,030,064 | 1,928,806 | 4,060,473 | 1.87 | 4.5 | 128.9 |
| 157 | | | | | | |
| 158 | | | | | | |
| 159 | | | | | | |
| 160 | | | | | | |
| 161 | 348,047 | 2,261,529 | 4,696,448 | 6.50 | 4.9 | |
| 162 | 1,336,867 | 2,599,249 | 4,792,485 | 1.94 | 2.8* | |
| 163 | | | | | | |
| 164 | | | | | | |
| 165 | | | | | | |
| 166 | 1,059,348 | 2,005,961 | 4,094,918 | 1.89 | 7.2 | 128.0 |
| 167 | 12,471 | 1,488,069 | 4,126,133 | 119.32 | 11.3 | 127.8 |
| 168 | | | | | | |
| 169 | | | | | | |
| 170 | | | | | | |
| 171 | | | | | | |
| 172 | 126,269 | 1,396,718 | 4,599,271 | 11.06 | 5.5 | |
| 173 | 137,660 | 1,276,819 | 6,012,555 | 9.28 | 7.5 | |
| 174 | 116,202 | 1,332,762 | 4,660,675 | 11.47 | 7.1 | |
| 175 | | | | | | |
| 176 | | | | | | |
| 177 | | | | | | |
| 178 | 639,203 | 2,369,485 | 4,654,623 | 3.71 | 2.2* | |
| 179 | 720,767 | 2,481,169 | 4,567,964 | 3.44 | 2.0* | |
| 180 | 476,839 | 2,293,398 | 4,855,540 | 4.81 | 1.6* | |
| 181 | | | | | | |
| 182 | | | | | | |
| 183 | | | | | | |
| 184 | 1,031,847 | 2,065,750 | 4,110,637 | 2.00 | 4.6 | 127.2 |
| 185 | 1,156,086 | 2,163,710 | 4,297,066 | 1.87 | 5.7 | 127.9 |
| 186 | 20,326 | 1,969,250 | 4,244,830 | 96.88 | 8.6 | 127.3 |
| 187 | | | | | | |
| 188 | | | | | | |
| 189 | | | | | | |
| 190 | 921,369 | 1,710,402 | 3,862,907 | 1.86 | 1.5* | 128.7 |
| 191 | | | | | | |
| 192 | | | | | | |

*Outside calibration range.

TABLE 5
part 1. Run conditions and data for additional ethylene homopolymerizations
performed in high-throughput reactor. General: temp = 80 deg C., volume =
5 mL, solvent = toluene, activator A = [PhNMe₂H][B(C₆F₅)₄] (1.1 equiv) or
activator B = MAO (500 equiv); at 200 psi C2, quench pressure set at 15 psid;
at 75 psi C2, quench pressure set at 20 psid; or 30 minutes max reaction time

| | | | | | | | | Activity |
|---|---|---|---|---|---|---|---|---|
| | | | | | | quench | | (gP/ |
| Run | | | complex | TnOAl | C2 | time | yield | mmol |
| # | Complex | Activator | (μmol) | (μmol) | (psig) | (s) | (g) | cat.hr) |
| 193 | 7 | A | 0.040 | 0.5 | 75 | 282 | 0.039 | 12,574 |
| 194 | 7 | A | 0.040 | 0.5 | 75 | 269 | 0.041 | 13,784 |
| 195 | 7 | A | 0.040 | 0.5 | 75 | 272 | 0.039 | 12,772 |
| 196 | 7 | B | 0.025 | 0.0 | 75 | 487 | 0.038 | 11,177 |
| 197 | 7 | B | 0.025 | 0.0 | 75 | 1801 | 0.027 | 2,159 |
| 198 | 7 | B | 0.025 | 0.0 | 75 | 1801 | 0.029 | 2,279 |
| 199 | 7 | A | 0.040 | 0.5 | 200 | 315 | 0.060 | 17,200 |
| 200 | 7 | A | 0.040 | 0.5 | 200 | 324 | 0.060 | 16,750 |
| 201 | 7 | A | 0.040 | 1.6 | 200 | 51 | 0.041 | 71,824 |
| 202 | 7 | A | 0.040 | 1.6 | 200 | 57 | 0.039 | 61,579 |
| 203 | 7 | A | 0.040 | 3.2 | 200 | 36 | 0.042 | 103,750 |
| 204 | 7 | A | 0.040 | 3.2 | 200 | 37 | 0.042 | 101,676 |
| 205 | 7 | A | 0.040 | 6.4 | 200 | 38 | 0.041 | 97,105 |
| 206 | 7 | A | 0.040 | 6.4 | 200 | 44 | 0.034 | 68,523 |
| 207 | 7 | A | 0.040 | 12.8 | 200 | 36 | 0.041 | 103,250 |
| 208 | 7 | A | 0.040 | 12.8 | 200 | 35 | 0.039 | 100,800 |
| 209 | 7 | A | 0.040 | 25.6 | 200 | 39 | 0.040 | 93,000 |
| 210 | 7 | A | 0.040 | 25.6 | 200 | 42 | 0.039 | 84,429 |
| 211 | 8 | A | 0.040 | 0.5 | 75 | 409 | 0.029 | 6,315 |
| 212 | 8 | A | 0.040 | 0.5 | 75 | 992 | 0.025 | 2,268 |
| 213 | 8 | A | 0.040 | 0.5 | 75 | 750 | 0.028 | 3,384 |
| 214 | 8 | B | 0.025 | 0.0 | 75 | 1801 | 0.019 | 1,487 |
| 215 | 8 | B | 0.025 | 0.0 | 75 | 1800 | 0.022 | 1,728 |
| 216 | 8 | B | 0.025 | 0.0 | 75 | 1801 | 0.026 | 2,055 |
| 217 | 9 | A | 0.040 | 0.5 | 75 | 1580 | 0.015 | 872 |
| 218 | 9 | A | 0.040 | 0.5 | 75 | 1801 | 0.016 | 790 |
| 219 | 9 | A | 0.040 | 0.5 | 75 | 1800 | 0.016 | 805 |
| 220 | 9 | B | 0.025 | 0.0 | 75 | 1800 | 0.019 | 1,496 |
| 221 | 9 | B | 0.025 | 0.0 | 75 | 1800 | 0.025 | 1,960 |
| 222 | 9 | B | 0.025 | 0.0 | 75 | 1800 | 0.028 | 2,264 |
| 223 | 10 | A | 0.040 | 0.5 | 75 | 1803 | 0.018 | 874 |
| 224 | 10 | A | 0.040 | 0.5 | 75 | 1801 | 0.016 | 795 |
| 225 | 10 | A | 0.040 | 0.5 | 75 | 1801 | 0.015 | 750 |
| 226 | 10 | B | 0.025 | 0.0 | 75 | 1800 | 0.014 | 1,096 |
| 227 | 10 | B | 0.025 | 0.0 | 75 | 1802 | 0.018 | 1,454 |
| 228 | 10 | B | 0.025 | 0.0 | 75 | 1800 | 0.016 | 1,296 |
| 229 | 11 | A | 0.040 | 0.5 | 75 | 281 | 0.032 | 10,121 |
| 230 | 11 | A | 0.040 | 0.5 | 75 | 308 | 0.034 | 9,847 |
| 231 | 11 | A | 0.040 | 0.5 | 75 | 320 | 0.033 | 9,197 |
| 232 | 11 | B | 0.025 | 0.0 | 75 | 193 | 0.051 | 37,753 |
| 233 | 11 | B | 0.025 | 0.0 | 75 | 355 | 0.054 | 21,783 |
| 234 | 11 | B | 0.025 | 0.0 | 75 | 194 | 0.045 | 33,699 |
| 235 | 11 | A | 0.040 | 0.5 | 200 | 183 | 0.038 | 18,541 |
| 236 | 11 | A | 0.040 | 0.5 | 200 | 159 | 0.028 | 16,019 |
| 237 | 11 | A | 0.040 | 1.6 | 200 | 90 | 0.025 | 25,000 |
| 238 | 11 | A | 0.040 | 1.6 | 200 | 86 | 0.026 | 26,686 |
| 239 | 11 | A | 0.040 | 3.2 | 200 | 86 | 0.028 | 28,779 |
| 240 | 11 | A | 0.040 | 3.2 | 200 | 103 | 0.030 | 26,039 |
| 241 | 11 | A | 0.040 | 6.4 | 200 | 103 | 0.028 | 24,641 |
| 242 | 11 | A | 0.040 | 6.4 | 200 | 99 | 0.027 | 24,364 |
| 243 | 11 | A | 0.040 | 12.8 | 200 | 75 | 0.027 | 31,920 |
| 244 | 11 | A | 0.040 | 12.8 | 200 | 88 | 0.026 | 26,898 |
| 245 | 11 | A | 0.040 | 25.6 | 200 | 99 | 0.027 | 24,727 |
| 246 | 11 | A | 0.040 | 25.6 | 200 | 115 | 0.025 | 19,722 |
| 247 | 12 | A | 0.040 | 0.5 | 75 | 139 | 0.035 | 22,597 |
| 248 | 12 | A | 0.040 | 0.5 | 75 | 121 | 0.035 | 25,810 |
| 249 | 12 | A | 0.040 | 0.5 | 75 | 150 | 0.036 | 21,540 |
| 250 | 12 | B | 0.025 | 0.0 | 75 | 1365 | 0.028 | 2,922 |
| 251 | 12 | B | 0.025 | 0.0 | 75 | 1800 | 0.030 | 2,424 |
| 252 | 12 | B | 0.025 | 0.0 | 75 | 1800 | 0.024 | 1,912 |
| 253 | 13 | B | 0.025 | 0.0 | 75 | 1800 | 0.000 | 32 |
| 254 | 13 | B | 0.025 | 0.0 | 75 | 1801 | 0.000 | 32 |
| 255 | 13 | B | 0.025 | 0.0 | 75 | 1800 | 0.001 | 48 |
| 256 | 14 | B | 0.040 | 0.0 | 75 | 1802 | 0.019 | 934 |
| 257 | 14 | B | 0.040 | 0.0 | 75 | 1801 | 0.007 | 345 |
| 258 | 14 | B | 0.040 | 0.0 | 75 | 1801 | 0.008 | 395 |
| 259 | 15 | B | 0.040 | 0.0 | 75 | 1802 | 0.005 | 265 |
| 260 | 15 | B | 0.040 | 0.0 | 75 | 1801 | 0.007 | 335 |
| 261 | 15 | B | 0.040 | 0.0 | 75 | 1800 | 0.006 | 295 |
| 262 | 16 | B | 0.025 | 0.0 | 75 | 1312 | 0.033 | 3,622 |
| 263 | 16 | B | 0.025 | 0.0 | 75 | 1801 | 0.009 | 736 |
| 264 | 16 | B | 0.025 | 0.0 | 75 | 1802 | 0.009 | 695 |
| 265 | 17 | B | 0.040 | 0.0 | 75 | 1801 | 0.007 | 360 |
| 266 | 17 | B | 0.040 | 0.0 | 75 | 1800 | 0.007 | 345 |
| 267 | 17 | B | 0.040 | 0.0 | 75 | 1800 | 0.008 | 380 |
| 268 | 18 | B | 0.025 | 0.0 | 75 | 1800 | 0.008 | 624 |
| 269 | 18 | B | 0.025 | 0.0 | 75 | 1800 | 0.009 | 736 |
| 270 | 18 | B | 0.025 | 0.0 | 75 | 1802 | 0.006 | 455 |
| 271 | 19 | B | 0.040 | 0.0 | 75 | 1800 | 0.020 | 980 |
| 272 | 19 | B | 0.040 | 0.0 | 75 | 1713 | 0.024 | 1,250 |
| 273 | 19 | B | 0.040 | 0.0 | 75 | 1800 | 0.019 | 925 |
| 274 | 20 | B | 0.040 | 0.0 | 75 | 1800 | 0.010 | 480 |
| 275 | 20 | B | 0.040 | 0.0 | 75 | 1800 | 0.010 | 515 |
| 276 | 20 | B | 0.040 | 0.0 | 75 | 1800 | 0.010 | 490 |
| 277 | 21 | B | 0.025 | 0.0 | 75 | 1801 | 0.007 | 552 |
| 278 | 21 | B | 0.025 | 0.0 | 75 | 1801 | 0.008 | 672 |
| 279 | 21 | B | 0.025 | 0.0 | 75 | 1801 | 0.008 | 640 |
| 280 | 22 | B | 0.025 | 0.0 | 75 | 1800 | 0.002 | 136 |
| 281 | 22 | B | 0.025 | 0.0 | 75 | 1801 | 0.002 | 168 |
| 282 | 22 | B | 0.025 | 0.0 | 75 | 1801 | 0.002 | 160 |

TABLE 5
part 2. Characterization of polyethylene homopolymers.

| Run | | | | | Tm |
|---|---|---|---|---|---|
| # | Mn | Mw | Mz | PDI | (° C.) |
| 193 | 155,727 | 1,354,349 | 6,482,133 | 8.70 | 136.3 |
| 194 | 144,476 | 1,332,438 | 7,073,701 | 9.22 | 136.9 |
| 195 | 167,413 | 1,365,033 | 6,440,414 | 8.15 | 136.0 |
| 196 | 64,276 | 1,382,217 | 3,924,958 | 21.50 | 134.4 |
| 197 | 82,702 | 1,575,640 | 4,263,438 | 19.05 | 134.7 |
| 198 | 76,126 | 1,525,242 | 4,182,768 | 20.04 | 134.4 |
| 199 | 305,199 | 1,705,165 | 5,278,619 | 5.59 | 136.8 |
| 200 | 265,418 | 1,639,933 | 5,089,260 | 6.18 | 136.8 |
| 201 | 58,206 | 448,184 | 4,902,230 | 7.70 | 134.8 |
| 202 | 57,425 | 444,055 | 4,821,848 | 7.73 | 135.1 |
| 203 | 26,566 | 40,643 | 72,370 | 1.53 | 133.4 |
| 204 | 28,596 | 42,734 | 77,584 | 1.49 | 133.0 |
| 205 | 10,550 | 16,530 | 29,723 | 1.57 | 129.9 |
| 206 | 8,791 | 14,727 | 28,053 | 1.68 | 129.4 |
| 207 | 4,972 | 8,179 | 15,326 | 1.64 | 125.7 |
| 208 | 5,168 | 8,189 | 15,227 | 1.58 | 125.5 |
| 209 | 2,502 | 4,103 | 7,864 | 1.64 | 119.5 |
| 210 | 2,037 | 3,743 | 7,490 | 1.84 | 118.8 |
| 211 | 117,035 | 926,885 | 6,126,680 | 7.92 | 136.1 |
| 212 | 132,405 | 1,433,459 | 8,196,375 | 10.83 | 135.5 |
| 213 | 118,258 | 1,191,290 | 6,796,711 | 10.07 | 136.1 |
| 214 | 50,605 | 1,463,451 | 4,961,775 | 28.92 | 133.7 |
| 215 | 39,470 | 1,553,416 | 5,047,709 | 39.36 | 134.0 |
| 216 | 55,683 | 1,523,719 | 4,874,010 | 27.36 | 134.4 |
| 217 | 77,056 | 820,602 | 6,408,368 | 10.65 | 135.9 |
| 218 | 74,904 | 781,149 | 5,844,220 | 10.43 | 135.8 |
| 219 | 70,040 | 778,109 | 6,253,086 | 11.11 | 135.7 |
| 220 | 34,087 | 1,498,745 | 4,713,498 | 43.97 | 134.2 |
| 221 | 29,654 | 1,356,940 | 4,447,337 | 45.76 | 134.2 |
| 222 | 41,327 | 1,463,290 | 4,593,326 | 35.41 | 134.0 |
| 223 | 59,324 | 659,440 | 4,955,501 | 11.12 | 135.7 |
| 224 | 61,431 | 609,148 | 4,739,512 | 9.92 | 135.7 |
| 225 | 61,132 | 569,926 | 5,266,390 | 9.32 | 135.5 |
| 226 | 423,301 | 1,825,550 | 4,834,405 | 4.31 | 134.0 |
| 227 | 538,305 | 2,253,678 | 5,004,513 | 4.19 | 134.4 |
| 228 | 534,509 | 2,098,426 | 4,960,265 | 3.93 | 134.2 |
| 229 | 116,168 | 283,042 | 895,750 | 2.44 | 136.6 |
| 230 | 129,101 | 303,035 | 1,078,005 | 2.35 | 136.6 |
| 231 | 127,935 | 341,289 | 2,182,624 | 2.67 | 136.2 |
| 232 | 82,086 | 413,546 | 4,055,857 | 5.04 | 134.5 |
| 233 | 88,043 | 606,492 | 4,354,386 | 6.89 | 133.8 |
| 234 | 78,421 | 476,302 | 4,434,064 | 6.07 | 134.4 |
| 235 | 205,848 | 605,530 | 4,897,752 | 2.94 | 137.6 |
| 236 | 190,390 | 572,496 | 5,466,795 | 3.01 | 137.4 |
| 237 | 45,850 | 76,748 | 151,462 | 1.67 | 134.8 |
| 238 | 44,192 | 74,450 | 142,672 | 1.68 | 135.0 |
| 239 | 24,333 | 39,964 | 81,410 | 1.64 | 133.6 |
| 240 | 25,806 | 40,850 | 73,617 | 1.58 | 133.6 |
| 241 | 9,740 | 16,321 | 31,696 | 1.68 | 130.0 |
| 242 | 9,068 | 16,130 | 31,318 | 1.78 | 130.0 |
| 243 | 5,735 | 9,601 | 18,986 | 1.67 | 127.5 |
| 244 | 5,295 | 8,921 | 17,326 | 1.68 | 127.4 |
| 245 | 2,328 | 4,255 | 9,179 | 1.83 | 120.3 |
| 246 | 2,370 | 4,006 | 8,101 | 1.69 | 119.8 |
| 247 | 162,083 | 273,655 | 524,888 | 1.69 | 137.4 |
| 248 | 173,784 | 277,445 | 564,775 | 1.60 | 137.5 |
| 249 | 162,994 | 269,268 | 518,908 | 1.65 | 137.2 |
| 250 | 60,480 | 1,405,064 | 4,810,008 | 23.23 | 133.9 |
| 251 | 66,233 | 1,395,111 | 4,848,465 | 21.06 | 134.6 |
| 252 | 78,844 | 1,718,151 | 5,147,181 | 21.79 | 134.4 |
| 253 | | | | | |
| 254 | | | | | |
| 255 | | | | | |
| 256 | 698,155 | 1,868,337 | 4,181,690 | 2.68 | |
| 257 | | | | | |
| 258 | | | | | |
| 259 | | | | | |
| 260 | | | | | |
| 261 | | | | | |
| 262 | 982,908 | 1,604,804 | 3,545,269 | 1.63 | 135.6 |
| 263 | | | | | |
| 264 | | | | | |
| 265 | | | | | |
| 266 | | | | | |
| 267 | | | | | |
| 268 | | | | | |
| 269 | | | | | |
| 270 | | | | | |
| 271 | 139,704 | 1,009,627 | 5,261,327 | 7.23 | |
| 272 | 130,461 | 977,330 | 4,992,029 | 7.49 | |
| 273 | 177,075 | 1,092,720 | 5,129,019 | 6.17 | |
| 274 | | | | | |
| 275 | 705,437 | 2,351,339 | 4,461,653 | 3.33 | |
| 276 | | | | | |
| 277 | | | | | |
| 278 | | | | | |
| 279 | | | | | |
| 280 | | | | | |
| 281 | | | | | |
| 282 | | | | | |

TABLE 6
part 1. Run conditions and data for additional ethylene homopolymerizations
and ethylene-propylene copolymerizations performed in high-throughput
reactor. General: temp = 70 deg C., volume = 5.1 mL, activator
A = [PhNMe₂H][B(C₆F₅)₄] (1.1 equiv), 0.5 μmol TnOAl scavenger, run at 200
psi C2 without makeup pressure set at 6 psid or 20 minutes max reaction time.

| | | | | | | | | Activity |
|---|---|---|---|---|---|---|---|---|
| | | | | | | quench | | (gP/ |
| | | complex | propylene | Toluene | Isohexane | time | yield | mmol) |
| Run | complex | (μmol) | (μL) | (μL) | (μL) | (s) | (g) | cat.hr) |
| 283 | 7 | 0.040 | 0 | 356 | 4744 | 29 | 0.058 | 180,000 |
| 284 | 7 | 0.040 | 0 | 356 | 4744 | 26 | 0.058 | 200,769 |
| 285 | 7 | 0.050 | 0 | 420 | 4680 | 37 | 0.058 | 112,865 |
| 286 | 7 | 0.050 | 0 | 420 | 4680 | 27 | 0.052 | 138,667 |
| 287 | 7 | 0.040 | 100 | 356 | 4644 | 34 | 0.049 | 129,706 |
| 288 | 7 | 0.050 | 100 | 420 | 4580 | 33 | 0.059 | 128,727 |
| 289 | 7 | 0.040 | 200 | 356 | 4544 | 38 | 0.054 | 127,895 |
| 290 | 7 | 0.050 | 200 | 420 | 4480 | 61 | 0.086 | 101,508 |
| 291 | 7 | 0.050 | 200 | 420 | 4480 | 45 | 0.068 | 108,800 |
| 292 | 8 | 0.040 | 0 | 356 | 4744 | 33 | 0.046 | 125,455 |
| 293 | 8 | 0.040 | 0 | 356 | 4744 | 37 | 0.047 | 114,324 |
| 294 | 8 | 0.050 | 0 | 420 | 4680 | 54 | 0.050 | 66,667 |
| 295 | 8 | 0.050 | 0 | 420 | 4680 | 51 | 0.050 | 70,588 |
| 296 | 8 | 0.040 | 100 | 356 | 4644 | 39 | 0.041 | 94,615 |
| 297 | 8 | 0.050 | 100 | 420 | 4580 | 44 | 0.050 | 81,818 |
| 298 | 8 | 0.040 | 200 | 356 | 4544 | 45 | 0.044 | 88,000 |
| 299 | 8 | 0.040 | 200 | 356 | 4544 | 39 | 0.043 | 99,231 |
| 300 | 8 | 0.050 | 200 | 420 | 4480 | 57 | 0.058 | 73,263 |
| 301 | 8 | 0.050 | 200 | 420 | 4480 | 52 | 0.052 | 72,000 |
| 302 | 9 | 0.040 | 0 | 356 | 4744 | 140 | 0.021 | 13,500 |
| 303 | 9 | 0.040 | 0 | 356 | 4744 | 210 | 0.024 | 10,286 |
| 304 | 9 | 0.050 | 0 | 420 | 4680 | 268 | 0.024 | 6,448 |
| 305 | 9 | 0.050 | 0 | 420 | 4680 | 366 | 0.026 | 5,115 |
| 306 | 9 | 0.040 | 100 | 356 | 4644 | 295 | 0.020 | 6,102 |
| 307 | 9 | 0.050 | 100 | 420 | 4580 | 354 | 0.020 | 4,068 |
| 308 | 9 | 0.040 | 200 | 356 | 4544 | 321 | 0.021 | 5,888 |
| 309 | 9 | 0.040 | 200 | 356 | 4544 | 412 | 0.030 | 6,553 |
| 310 | 9 | 0.050 | 200 | 420 | 4480 | 395 | 0.021 | 3,828 |
| 311 | 9 | 0.050 | 200 | 420 | 4480 | 303 | 0.021 | 4,990 |
| 312 | 10 | 0.040 | 0 | 356 | 4744 | 181 | 0.024 | 11,934 |
| 313 | 10 | 0.040 | 0 | 356 | 4744 | 161 | 0.028 | 15,652 |
| 314 | 10 | 0.050 | 0 | 420 | 4680 | 193 | 0.028 | 10,446 |
| 315 | 10 | 0.050 | 0 | 420 | 4680 | 205 | 0.030 | 10,537 |
| 316 | 10 | 0.040 | 100 | 356 | 4644 | 182 | 0.029 | 14,341 |
| 317 | 10 | 0.050 | 100 | 420 | 4580 | 174 | 0.026 | 10,759 |
| 318 | 10 | 0.040 | 200 | 356 | 4544 | 165 | 0.028 | 15,273 |
| 319 | 10 | 0.040 | 200 | 356 | 4544 | 149 | 0.030 | 18,121 |
| 320 | 10 | 0.050 | 200 | 420 | 4480 | 291 | 0.029 | 7,175 |
| 321 | 10 | 0.050 | 200 | 420 | 4480 | 159 | 0.025 | 11,321 |
| 322 | 11 | 0.040 | 0 | 356 | 4744 | 121 | 0.029 | 21,570 |
| 323 | 11 | 0.040 | 0 | 356 | 4744 | 110 | 0.027 | 22,091 |
| 324 | 11 | 0.050 | 0 | 420 | 4680 | 144 | 0.036 | 18,000 |
| 325 | 11 | 0.050 | 0 | 420 | 4680 | 156 | 0.036 | 16,615 |
| 326 | 11 | 0.040 | 100 | 356 | 4644 | 126 | 0.029 | 20,714 |
| 327 | 11 | 0.050 | 100 | 420 | 4580 | 143 | 0.027 | 13,594 |
| 328 | 11 | 0.040 | 200 | 356 | 4544 | 197 | 0.035 | 15,990 |
| 329 | 11 | 0.040 | 200 | 356 | 4544 | 127 | 0.029 | 20,551 |
| 330 | 11 | 0.050 | 200 | 420 | 4480 | 576 | 0.045 | 5,625 |
| 331 | 11 | 0.050 | 200 | 420 | 4480 | 132 | 0.026 | 14,182 |
| 332 | 12 | 0.040 | 0 | 356 | 4744 | 82 | 0.029 | 31,829 |
| 333 | 12 | 0.040 | 0 | 356 | 4744 | 54 | 0.039 | 65,000 |
| 334 | 12 | 0.050 | 0 | 420 | 4680 | 69 | 0.042 | 43,826 |
| 335 | 12 | 0.050 | 0 | 420 | 4680 | 67 | 0.044 | 47,284 |
| 336 | 12 | 0.040 | 100 | 356 | 4644 | 55 | 0.032 | 52,364 |
| 337 | 12 | 0.050 | 100 | 420 | 4580 | 66 | 0.039 | 42,545 |
| 338 | 12 | 0.040 | 200 | 356 | 4544 | 68 | 0.037 | 48,971 |
| 339 | 12 | 0.040 | 200 | 356 | 4544 | 57 | 0.039 | 61,579 |
| 340 | 12 | 0.050 | 200 | 420 | 4480 | 282 | 0.046 | 11,745 |
| 341 | 12 | 0.050 | 200 | 420 | 4480 | 67 | 0.039 | 41,910 |

TABLE 6
part 2. Characterization of polyethylene homopolymers and ethylene-propylene copolymers.

| | | | | | C2 | C3 | |
|---|---|---|---|---|---|---|---|
| | | | | | wt % | wt % | |
| | | | | | by 1H | by 1H | Tm |
| Run | Mn | Mw | Mz | PDI | NMR | NMR | (° C.) |
| 283 | 133,498 | 1,499,303 | 5,396,789 | 11.23 | | | 132.5 |
| 284 | 166,915 | 1,447,362 | 4,884,079 | 8.67 | | | 132.1 |
| 285 | 132,767 | 1,170,055 | 4,902,488 | 8.81 | | | 127 |
| 286 | 128,918 | 883,295 | 5,710,624 | 6.85 | | | 125.2 |
| 287 | 113,481 | 156,717 | 239,308 | 1.38 | 93.9 | 6.1 | 113.1 |
| 288 | 225,489 | 321,832 | 587,958 | 1.43 | 83.7 | 16.3 | 92.6 |
| 289 | 156,039 | 200,915 | 293,928 | 1.29 | 92.5 | 7.5 | 103.8 |
| 290 | 373,176 | 524,469 | 829,583 | 1.41 | 83.0 | 17.0 | 72 |
| 291 | 294,761 | 411,731 | 647,666 | 1.40 | | | 74.8 |
| 292 | 130,795 | 1,397,843 | 5,130,928 | 10.69 | | | 133.3 |
| 293 | 142,253 | 1,571,565 | 5,430,921 | 11.05 | | | 134.3 |
| 294 | 155,793 | 1,521,940 | 4,917,840 | 9.77 | | | 130.4 |
| 295 | 105,707 | 1,499,109 | 5,392,959 | 14.18 | | | 131 |
| 296 | 97,750 | 134,051 | 201,814 | 1.37 | 95.3 | 4.7 | 115.4 |
| 297 | 223,850 | 290,671 | 437,150 | 1.30 | 82.5 | 17.5 | 98.5 |
| 298 | 98,230 | 134,060 | 207,419 | 1.36 | 92.2 | 7.8 | 104.5 |
| 299 | 98,458 | 132,472 | 199,434 | 1.35 | | | 106.3 |
| 300 | 339,650 | 445,360 | 676,342 | 1.31 | 85.1 | 14.9 | 77.7 |
| 301 | 244,591 | 327,099 | 511,539 | 1.34 | | | 79.3 |
| 302 | 56,749 | 975,598 | 4,028,482 | 17.19 | | | 133.1 |
| 303 | 56,490 | 1,140,904 | 4,784,776 | 20.20 | | | 133.1 |
| 304 | 53,374 | 950,810 | 3,943,743 | 17.81 | | | 130.2 |
| 305 | 73,933 | 1,037,618 | 4,221,605 | 14.03 | | | 130.4 |
| 306 | 48,187 | 213,814 | 1,377,900 | 4.44 | | | 117.2 |
| 307 | 121,765 | 166,594 | 261,783 | 1.37 | | | 99.7 |
| 308 | 51,482 | 71,292 | 116,016 | 1.38 | | | 106 |
| 309 | 45,328 | 64,025 | 99,266 | 1.41 | | | 105.9 |
| 310 | 262,915 | 399,241 | 738,221 | 1.52 | | | 81.9 |
| 311 | 107,629 | 159,865 | 286,417 | 1.49 | | | 89.5 |
| 312 | 89,188 | 1,689,355 | 4,992,891 | 18.94 | | | 133.9 |
| 313 | 74,921 | 1,676,368 | 4,873,444 | 22.38 | | | 134.4 |
| 314 | 55,971 | 1,610,390 | 5,447,594 | 28.77 | | | 132.2 |
| 315 | 52,657 | 1,562,363 | 4,695,973 | 29.67 | | | 131.5 |
| 316 | 67,212 | 1,627,577 | 4,943,376 | 24.22 | | | 122.9 |
| 317 | 152,298 | 317,097 | 560,054 | 2.08 | 86.1 | 13.9 | 113.4 |
| 318 | 61,635 | 524,722 | 2,460,581 | 8.51 | | | 117.2 |
| 319 | 55,761 | 379,724 | 1,856,590 | 6.81 | | | 117 |
| 320 | 760,976 | 1,272,854 | 2,454,037 | 1.67 | 90.3 | 9.7 | 101 |
| 321 | 198,682 | 251,117 | 370,380 | 1.26 | | | 96.7 |
| 322 | 77,236 | 997,955 | 4,525,307 | 12.92 | | | 133.1 |
| 323 | 64,444 | 917,860 | 4,007,131 | 14.24 | | | 133.5 |
| 324 | 91,309 | 1,341,557 | 5,130,573 | 14.69 | | | 130.2 |
| 325 | 77,208 | 1,315,365 | 5,356,324 | 17.04 | | | 130.7 |
| 326 | 62,266 | 108,863 | 218,847 | 1.75 | | | 116.5 |
| 327 | 187,560 | 306,966 | 579,503 | 1.64 | 89.4 | 10.6 | 96.4 |
| 328 | 85,810 | 119,059 | 187,792 | 1.39 | | | 103.7 |
| 329 | 71,141 | 100,230 | 160,846 | 1.41 | | | 104.7 |
| 330 | 1,933,898 | 3,224,266 | 5,437,385 | 1.67 | 83.3 | 16.7 | 70.2 |
| 331 | 203,535 | 304,966 | 592,580 | 1.50 | | | 76.9 |
| 332 | 65,914 | 953,360 | 4,486,130 | 14.46 | | | 132.7 |
| 333 | 118,755 | 1,184,259 | 4,810,440 | 9.97 | | | 132.6 |
| 334 | 106,382 | 1,223,159 | 4,705,924 | 11.50 | | | 130 |
| 335 | 106,356 | 1,323,693 | 5,796,961 | 12.45 | | | 129.1 |
| 336 | 88,828 | 137,327 | 229,274 | 1.55 | 95.0 | 5.0 | 113.4 |
| 337 | 352,051 | 544,961 | 1,002,181 | 1.55 | 82.4 | 17.6 | 94.1 |
| 338 | 102,709 | 147,273 | 243,902 | 1.43 | | | 103 |
| 339 | 100,768 | 143,172 | 237,921 | 1.42 | 92.1 | 7.9 | 101.9 |
| 340 | 2,490,170 | 3,823,195 | 5,770,404 | 1.54 | 82.2 | 17.8 | 73.7 |
| 341 | 317,194 | 460,633 | 783,495 | 1.45 | | | 77.5 |

TABLE 7
part 1. Run conditions and data for propylene homopolymerizations and ethylene-
propylene copolymerizations performed in high-throughput reactor. General:
temp = 70 deg C., volume = 5.1 mL, 0.04 μmol catalyst, activator A =
[PhNMe₂H][B(C₆F₅)₄] (1.1 equiv), 268 μL toluene used for catalyst and
activator solutions, 0.5 μmol TnOAl scavenger, when used C2 without
makeup gas, quench pressure set at 5 psid or 45 minutes max reaction time.

| | | | | | | Activity |
|---|---|---|---|---|---|---|
| | | | Iso- | quench | | (gP/ |
| | Com- | C2 | hexane | time | yield | mmol |
| Run | plex | (psi) | (uL) | (s) | (g) | cat.hr) |
| 342 | 7 | 0 | 3832 | 543 | 0.046 | 7,624 |
| 343 | 7 | 10 | 3812 | 105 | 0.052 | 44,571 |
| 344 | 7 | 20 | 3792 | 103 | 0.063 | 55,049 |
| 345 | 7 | 40 | 3772 | 81 | 0.070 | 77,778 |
| 346 | 7 | 60 | 3752 | 70 | 0.077 | 99,000 |
| 347 | 7 | 80 | 3732 | 66 | 0.079 | 107,727 |
| 348 | 7 | 0 | 3832 | 461 | 0.037 | 7,223 |
| 349 | 7 | 10 | 3812 | 125 | 0.061 | 43,920 |
| 350 | 7 | 20 | 3792 | 104 | 0.064 | 55,385 |
| 351 | 7 | 40 | 3772 | 87 | 0.074 | 76,552 |
| 352 | 7 | 60 | 3752 | 76 | 0.080 | 94,737 |
| 353 | 7 | 80 | 3732 | 73 | 0.083 | 102,329 |
| 354 | 8 | 0 | 3832 | 620 | 0.032 | 4,645 |
| 355 | 8 | 10 | 3812 | 161 | 0.059 | 32,981 |
| 356 | 8 | 20 | 3792 | 132 | 0.055 | 37,500 |
| 357 | 8 | 40 | 3772 | 90 | 0.053 | 53,000 |
| 358 | 8 | 60 | 3752 | 97 | 0.066 | 61,237 |
| 359 | 8 | 80 | 3732 | 94 | 0.072 | 68,936 |
| 360 | 8 | 0 | 3832 | 819 | 0.046 | 5,055 |
| 361 | 8 | 10 | 3812 | 168 | 0.050 | 26,786 |
| 362 | 8 | 20 | 3792 | 126 | 0.053 | 37,857 |
| 363 | 8 | 40 | 3772 | 97 | 0.057 | 52,887 |
| 364 | 8 | 60 | 3752 | 85 | 0.063 | 66,706 |
| 365 | 8 | 80 | 3732 | 95 | 0.068 | 64,421 |
| 366 | 9 | 0 | 3832 | 2701 | 0.008 | 267 |
| 367 | 9 | 10 | 3812 | 1506 | 0.028 | 1,673 |
| 368 | 9 | 20 | 3792 | 746 | 0.024 | 2,895 |
| 369 | 9 | 40 | 3772 | 577 | 0.024 | 3,744 |
| 370 | 9 | 60 | 3752 | 501 | 0.025 | 4,491 |
| 371 | 9 | 80 | 3732 | 379 | 0.023 | 5,462 |
| 372 | 9 | 0 | 3832 | 2701 | 0.009 | 300 |
| 373 | 9 | 10 | 3812 | 1099 | 0.025 | 2,047 |
| 374 | 9 | 20 | 3792 | 806 | 0.024 | 2,680 |
| 375 | 9 | 40 | 3772 | 508 | 0.024 | 4,252 |
| 376 | 9 | 60 | 3752 | 448 | 0.025 | 5,022 |
| 377 | 9 | 80 | 3732 | 375 | 0.023 | 5,520 |
| 378 | 10 | 0 | 3832 | 1193 | 0.044 | 3,319 |
| 379 | 10 | 10 | 3812 | 296 | 0.035 | 10,642 |
| 380 | 10 | 20 | 3792 | 238 | 0.033 | 12,479 |
| 381 | 10 | 40 | 3772 | 189 | 0.033 | 15,714 |
| 382 | 10 | 60 | 3752 | 195 | 0.038 | 17,538 |
| 383 | 10 | 80 | 3732 | 187 | 0.038 | 18,289 |
| 384 | 10 | 0 | 3832 | 411 | 0.018 | 3,942 |
| 385 | 10 | 10 | 3812 | 307 | 0.034 | 9,967 |
| 386 | 10 | 20 | 3792 | 264 | 0.035 | 11,932 |
| 387 | 10 | 40 | 3772 | 200 | 0.034 | 15,300 |
| 388 | 10 | 60 | 3752 | 195 | 0.035 | 16,154 |
| 389 | 10 | 80 | 3732 | 175 | 0.035 | 18,000 |
| 390 | 11 | 0 | 3832 | 1696 | 0.043 | 2,282 |
| 391 | 11 | 10 | 3812 | 316 | 0.039 | 11,108 |
| 392 | 11 | 20 | 3792 | 244 | 0.036 | 13,279 |
| 393 | 11 | 40 | 3772 | 183 | 0.032 | 15,738 |
| 394 | 11 | 60 | 3752 | 179 | 0.037 | 18,603 |
| 395 | 11 | 80 | 3732 | 189 | 0.043 | 20,476 |
| 396 | 11 | 0 | 3832 | 1675 | 0.042 | 2,257 |
| 397 | 11 | 10 | 3812 | 317 | 0.039 | 11,073 |
| 398 | 11 | 20 | 3792 | 255 | 0.037 | 13,059 |
| 399 | 11 | 40 | 3772 | 199 | 0.035 | 15,829 |
| 400 | 11 | 60 | 3752 | 200 | 0.041 | 18,450 |
| 401 | 11 | 80 | 3732 | 182 | 0.040 | 19,780 |
| 402 | 12 | 0 | 3832 | 1852 | 0.040 | 1,944 |
| 403 | 12 | 10 | 3812 | 158 | 0.043 | 24,494 |
| 404 | 12 | 20 | 3792 | 150 | 0.052 | 31,200 |
| 405 | 12 | 40 | 3772 | 99 | 0.052 | 47,273 |
| 406 | 12 | 60 | 3752 | 102 | 0.058 | 51,176 |
| 407 | 12 | 80 | 3732 | 103 | 0.065 | 56,796 |
| 408 | 12 | 0 | 3832 | 1310 | 0.041 | 2,817 |
| 409 | 12 | 10 | 3812 | 186 | 0.051 | 24,677 |
| 410 | 12 | 20 | 3792 | 153 | 0.052 | 30,588 |
| 411 | 12 | 40 | 3772 | 93 | 0.047 | 45,484 |
| 412 | 12 | 60 | 3752 | 103 | 0.061 | 53,301 |
| 413 | 12 | 80 | 3732 | 92 | 0.051 | 49,891 |

TABLE 7
part 2. Characterization of polypropylene homopolymers and ethylene-propylene copolymers.

| | | | | | C2 | C2 | C3 | |
|---|---|---|---|---|---|---|---|---|
| | | | | | (wt %) | wt % | wr % | |
| | | | | | by | by 1H | by 1H | Tm |
| Run | Mn | Mw | Mz | PDI | FTIR | NMR | NMR | (° C.) |
| 342 | 16,457 | 29,479 | 61,534 | 1.79 | | | | 129 |
| 343 | 79,460 | 131,589 | 256,887 | 1.66 | 33.9 | | | |
| 344 | 94,643 | 155,052 | 296,059 | 1.64 | 39.2 | | | |
| 345 | 106,847 | 167,497 | 290,296 | 1.57 | 47.4 | | | |
| 346 | 128,462 | 184,894 | 303,133 | 1.44 | 58.3* | | | |
| 347 | 135,946 | 192,777 | 313,163 | 1.42 | 63.2* | | | |
| 348 | 17,809 | 31,067 | 63,242 | 1.74 | | | | 131 |
| 349 | 80,842 | 139,401 | 280,740 | 1.72 | 32.6 | | | |
| 350 | 95,212 | 155,163 | 285,382 | 1.63 | 40.9 | | | |
| 351 | 126,817 | 185,360 | 319,047 | 1.46 | 48.0 | 49.5 | 50.5 | |
| 352 | 122,343 | 180,121 | 298,192 | 1.47 | 52.3 | | | |
| 353 | 137,971 | 192,255 | 307,785 | 1.39 | 62.1* | 59.0 | 41.0 | |
| 354 | 21,071 | 36,105 | 72,575 | 1.71 | | | | 133 |
| 355 | 92,581 | 153,258 | 299,443 | 1.66 | 34.1 | | | |
| 356 | 89,982 | 144,960 | 267,354 | 1.61 | 41.8 | | | |
| 357 | 93,738 | 143,057 | 252,736 | 1.53 | 46.5 | | | |
| 358 | 114,254 | 165,847 | 271,073 | 1.45 | 56.0* | | | |
| 359 | 115,550 | 165,291 | 263,665 | 1.43 | 60.5* | | | |
| 360 | 21,560 | 37,279 | 72,971 | 1.73 | | | | 135 |
| 361 | 85,354 | 141,804 | 302,122 | 1.66 | 32.1 | | | |
| 362 | 81,635 | 135,108 | 254,243 | 1.66 | 42.1 | | | |
| 363 | 92,546 | 153,263 | 293,290 | 1.66 | 51.1 | 50.7 | 49.3 | |
| 364 | 103,969 | 151,627 | 253,230 | 1.46 | 52.9 | | | |
| 365 | 119,145 | 167,764 | 276,651 | 1.41 | 61.8* | 59.6 | 40.4 | |
| 366 | | | | | | | | |
| 367 | 43,745 | 78,154 | 154,971 | 1.79 | 35.9 | | | |
| 368 | 45,857 | 71,167 | 133,172 | 1.55 | 48.0 | | | |
| 369 | 49,987 | 71,716 | 119,178 | 1.43 | 52.6 | | | |
| 370 | 55,923 | 81,835 | 137,077 | 1.46 | 59.9* | | | |
| 371 | 52,266 | 73,461 | 117,773 | 1.41 | 59.6* | | | |
| 372 | | | | | | | | |
| 373 | 43,054 | 77,558 | 163,974 | 1.8 | 39.6 | | | |
| 374 | 49,060 | 77,667 | 137,773 | 1.58 | 49.7 | | | |
| 375 | 47,866 | 72,219 | 134,751 | 1.51 | 50.7 | | | |
| 376 | 51,251 | 75,175 | 126,357 | 1.47 | 55.7* | | | |
| 377 | 51,508 | 75,514 | 126,363 | 1.47 | 59.0* | | | |
| 378 | 28,054 | 54,129 | 123,290 | 1.93 | | | | |
| 379 | 67,753 | 107,783 | 234,343 | 1.59 | 37.1 | | | |
| 380 | 63,239 | 94,218 | 183,226 | 1.49 | 46.2 | | | |
| 381 | 63,083 | 84,527 | 131,774 | 1.34 | 53.1 | | | |
| 382 | 77,094 | 104,717 | 160,367 | 1.36 | 60.0* | | | |
| 383 | 74,799 | 98,553 | 143,448 | 1.32 | 58.5* | | | |
| 384 | 26,301 | 50,303 | 106,394 | 1.91 | | | | |
| 385 | 62,483 | 110,266 | 249,134 | 1.76 | 37.8 | | | |
| 386 | 73,998 | 107,744 | 203,278 | 1.46 | 50.0 | | | |
| 387 | 58,056 | 84,545 | 138,642 | 1.46 | 54.2* | | | |
| 388 | 71,016 | 99,375 | 158,718 | 1.4 | 55.9* | | | |
| 389 | 73,377 | 93,388 | 133,717 | 1.27 | 60.1* | | | |
| 390 | 9,629 | 21,794 | 48,355 | 2.26 | | | | 138 |
| 391 | 63,512 | 111,977 | 226,549 | 1.76 | 49.4 | | | |
| 392 | 65,943 | 111,498 | 240,012 | 1.69 | 51.3 | | | |
| 393 | 61,931 | 101,377 | 189,249 | 1.64 | 52.4 | | | |
| 394 | 73,238 | 114,002 | 198,055 | 1.56 | 56.4* | | | |
| 395 | 85,350 | 124,760 | 210,619 | 1.46 | 61.9* | 60.3 | 39.7 | |
| 396 | 10,886 | 21,502 | 46,589 | 1.98 | | | | 135 |
| 397 | 65,539 | 109,460 | 216,723 | 1.67 | 37.1 | | | |
| 398 | 71,857 | 116,434 | 228,766 | 1.62 | 45.2 | | | |
| 399 | 67,960 | 110,737 | 213,231 | 1.63 | 53.9* | 52.2 | 47.8 | |
| 400 | 81,183 | 123,725 | 219,280 | 1.52 | 60.2* | | | |
| 401 | 77,389 | 114,121 | 194,754 | 1.47 | 61.3* | | | |
| 402 | 9,016 | 21,366 | 52,295 | 2.37 | | | | 134 |
| 403 | 73,247 | 118,611 | 222,509 | 1.62 | 36.8 | | | |
| 404 | 84,928 | 144,567 | 286,135 | 1.7 | 45.2 | | | |
| 405 | 106,798 | 170,287 | 326,297 | 1.59 | 48.3 | | | |
| 406 | 130,364 | 196,697 | 370,125 | 1.51 | 48.9 | | | |
| 407 | 133,638 | 205,507 | 375,233 | 1.54 | 56.4* | | | |
| 408 | 12,238 | 26,968 | 61,578 | 2.2 | | | | 131 |
| 409 | 79,416 | 134,400 | 271,066 | 1.69 | 33.9 | | | |
| 410 | 97,306 | 164,124 | 322,782 | 1.69 | 44.3 | | | |
| 411 | 100,713 | 166,525 | 325,160 | 1.65 | 46.8 | | | |
| 412 | 148,773 | 217,713 | 380,890 | 1.46 | 54.2* | | | |
| 413 | 133,626 | 199,916 | 368,068 | 1.5 | 56.5* | | | |

*Outside calibration range.

Overall, catalysts, catalyst systems, and processes of the present disclosure can provide polyolefins at activity values of from 20 g/mmol/h/bar to 3,500 g/mmol/h/bar or greater, Mw values in the range of 18,000 to 568,000 g/mol or greater, Mn values of 125,000 g/mol or greater, and narrow PDIs (e.g., about 3 or less). Furthermore, in the presence of diethyl zinc, catalysts, catalyst systems, and processes of the present disclosure can provide polymers having low comonomer content (e.g., 6.0 wt % or lower) and high melting point (e.g., 127° C.).

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A catalyst compound represented by Formula (I): 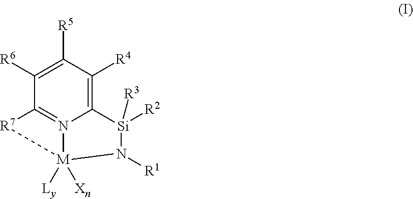
wherein:
M is a group 3, 4, 5, 6, 7, 8, 9, or 10 metal;
L is a neutral Lewis base, or two L groups may be joined to form a bidentate Lewis base;
y is 0, 1, or 2;
each of X is independently a univalent anionic ligand, a diene ligand, an alkylidene ligand, or two Xs are joined to form a metallocyclic ring;
X may be joined to L to form a monoanionic bidentate group;
n is 1 or 2;
n+y is not greater than 4;
R¹ is selected from substituted or unsubstituted hydrocarbyl or silyl groups;
R² and R³ are independently hydrogen, hydrocarbyl, alkoxy, silyl, amino, aryloxy, substituted hydrocarbyl, halogen, or phosphino, or R² and R³ are joined to form substituted or unsubstituted hydrocarbyl containing ring having 4, 5, 6 or 7 ring atoms including Si, such as a substituted or unsubstituted hydrocarbyl containing ring having 5 ring atoms including Si;
each of R⁴, R⁵, and R⁶ is independently hydrogen, hydrocarbyl, alkoxy, silyl, amino, aryloxy, substituted hydrocarbyl, halogen, phosphino, or R⁴ and R⁵ or R⁵ and R⁶ are joined to form a substituted hydrocarbyl ring, unsubstituted hydrocarbyl ring, substituted heterocyclic ring, or unsubstituted heterocyclic ring having 5, 6, 7, or 8 ring atoms; and
R⁷ is a group containing two or more carbons and is optionally bonded to M.

2. The catalyst compound of claim 1, wherein R⁷ is represented by the formula: 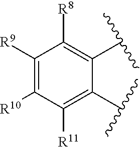
wherein:
each of R⁸, R⁹, R¹⁰, and R¹¹ is independently hydrogen, hydrocarbyl, alkoxy, silyl, amino, aryloxy, substituted hydrocarbyl, halogen, phosphino, or one or more R⁸ and R⁹, R⁹ and R¹⁰, or R¹⁰ and R¹¹ are joined to form one or more substituted hydrocarbyl rings, unsubstituted hydrocarbyl rings, substituted heterocyclic rings, or unsubstituted heterocyclic rings each having 5, 6, 7, or 8 ring atoms.

3. The catalyst compound of claim 1, wherein R⁷ is represented by the formula: 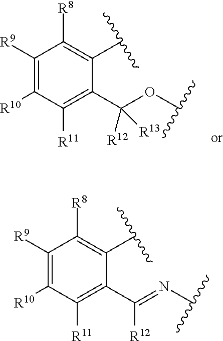
wherein:
each of R⁸, R⁹, R¹⁰, R¹¹, R¹², and R¹³ is independently hydrogen, hydrocarbyl, alkoxy, silyl, amino, aryloxy, substituted hydrocarbyl, halogen, phosphino, or one or more R⁸ and R⁹, R⁹ and R¹⁰, R¹⁰ and R¹¹, or R¹² and R¹³ are joined to form one or more substituted hydrocarbyl ring, unsubstituted hydrocarbyl rings, substituted heterocyclic rings, or unsubstituted heterocyclic rings each having 5, 6, 7, or 8 ring atoms.

4. The catalyst compound of claim 1, wherein M is hafnium.

5. The catalyst compound of claim 1, wherein R¹ is aryl.

6. The catalyst compound of claim 5, wherein R¹ is 2,6-disubstituted aryl.

7. The catalyst compound of claim 6, wherein R¹ is 2,6-diisopropylphenyl.

8. The catalyst compound of claim 6, wherein R¹ is 2,6-dimethylphenyl.

9. The catalyst compound of claim 1, wherein R⁴, R⁵, and R⁶ is hydrogen.

10. The catalyst compound of claim 1, wherein R⁸, R⁹, R¹⁰, R¹¹, R¹² and R¹³ are independently hydrogen or C₁-C₁₀ alkyl.

11. The catalyst compound of claim 10, wherein R⁸, R⁹, R¹⁰, R¹¹, R¹² and R¹³ are hydrogen.

12. The catalyst compound of claim 1, wherein R⁸ and R⁹ are joined to form substituted phenyl or unsubstituted phenyl.

13. The catalyst compound of claim 12, wherein R⁸ and R⁹ are joined to form unsubstituted phenyl.

14. The catalyst compound of claim 1, wherein R² and R³ are independently hydrogen, hydrocarbyl, or R² and R³ are joined to form a substituted hydrocarbyl ring or unsubstituted hydrocarbyl ring having 5, 6, 7, or 8 ring atoms.

15. The catalyst compound of claim 14, wherein R² and R³ are phenyl.

16. The catalyst compound of claim 14, wherein R² and R³ are independently methyl or ethyl.

17. The catalyst compound of claim 14, wherein R² and R³ are joined to form substituted or unsubstituted hydrocarbyl containing ring having 4, 5, 6 or 7 ring atoms including Si, such as a substituted or unsubstituted hydrocarbyl containing ring having 5 ring atoms including Si.

18. The catalyst compound of claim 1, wherein n is 2 and each X is independently chloro or hydrocarbyl.

19. The catalyst compound of claim 1, wherein n is 2 and each X is methyl or benzyl.

20. The catalyst compound of claim 2, wherein n is 2 and each X is methyl or benzyl.

21. The catalyst compound of claim 1, wherein the catalyst compound is selected from:

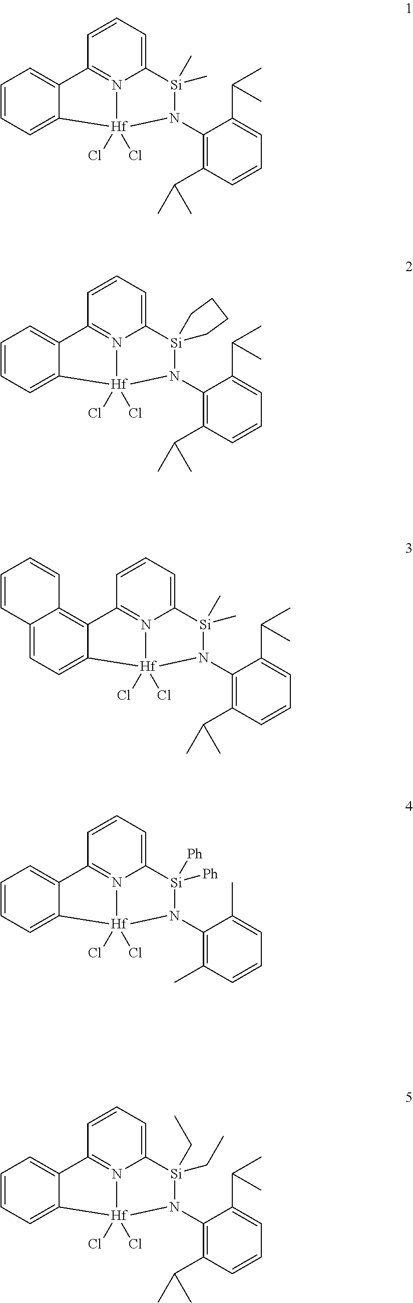

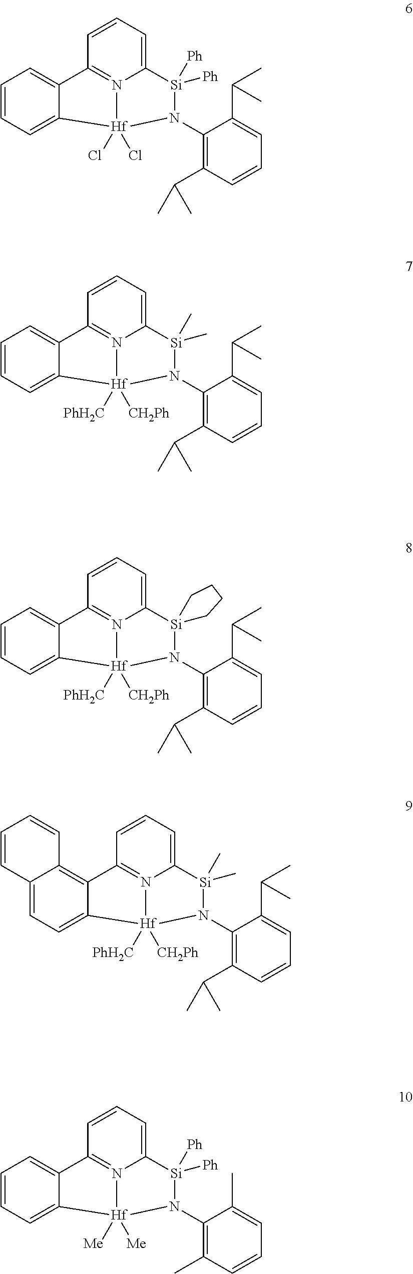

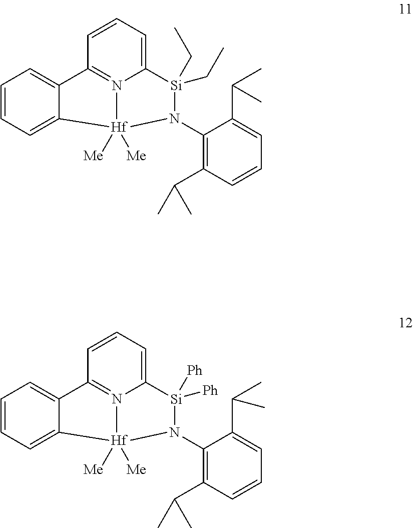

22. The catalyst compound of claim 1, wherein the catalyst compound is selected from:

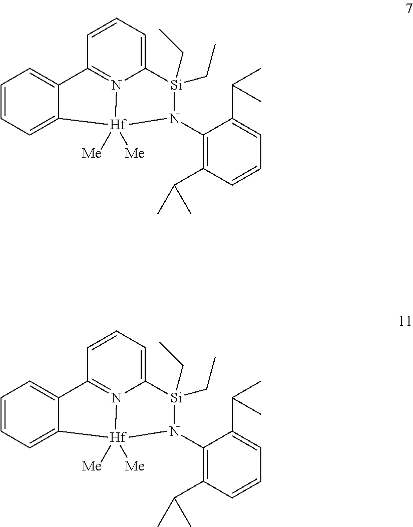

23. The catalyst compound of claim 2, wherein the catalyst compound is selected from:

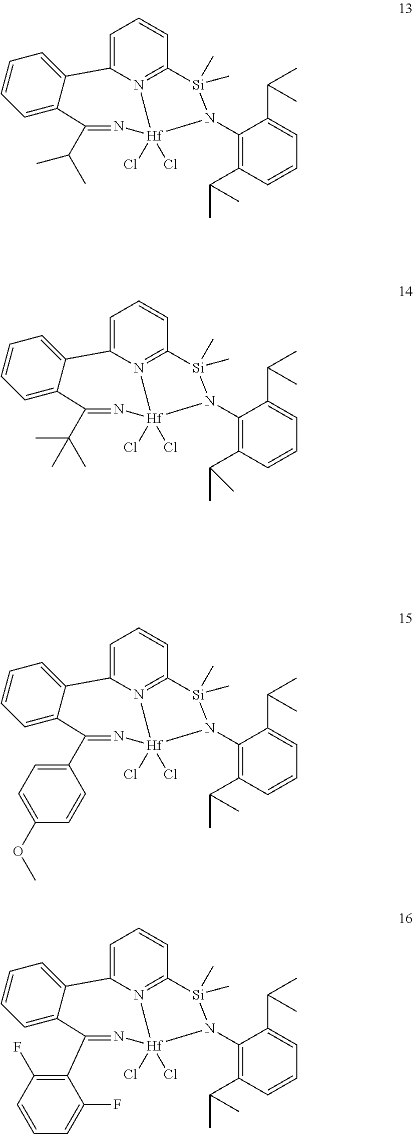

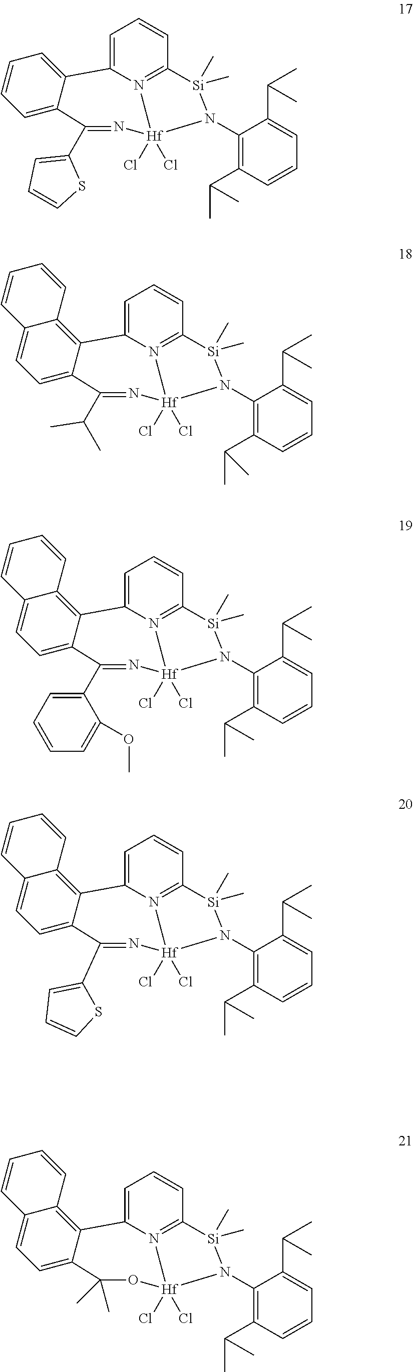

24. A catalyst system comprising an activator and the catalyst compound of claim 1.

25. The catalyst system of claim 24, further comprising a support material.

26. The catalyst system of claim 25, wherein the support material is selected from Al₂O₃, ZrO₂, SiO₂, SiO₂/Al₂O₃, SiO₂/TiO₂, silica clay, silicon oxide/clay, or mixtures thereof.

27. The catalyst system of claim 24, wherein the activator comprises an alkylalumoxane.

28. A process for the production of an ethylene alpha-olefin copolymer comprising: polymerizing ethylene and at least one C₃-C₂₀ alpha-olefin by contacting the ethylene and the at least one C₃-C₂₀ alpha-olefin with a catalyst system of claim 27 in at least one gas phase reactor, slurry phase reactor, or solution phase reactor at a reactor pressure of from 0.7 to 150 bar and a reactor temperature of from 20° C. to 150° C. to form an ethylene alpha-olefin copolymer.

29. The process of claim 28, wherein the ethylene alpha-olefin copolymer has a comonomer content of 6 wt % or greater, an Mw value of from 50,000 to 1,000,000 g/mol, and Mn value of from 50,000 to 200,000 g/mol, and a PDI of from 1 to 5.

30. The process of claim 29, wherein the ethylene alpha-olefin copolymer has a melting point of 122° C. or greater.

31. The process of claim 30, wherein the catalyst system further comprises diethyl zinc.
